(19) United States
(12) Patent Application Publication
(10) Pub. No.: US 2026/0250023 A1
(43) Pub. Date: Aug. 27, 2026

(54) DOCKING CONFIGURATIONS FOR AERIAL VEHICLES

(71) Applicant: Zipline International Inc., South San Francisco, CA (US)

(72) Inventors: Zoltan Laszlo, Pacifica, CA (US); Joseph Mardall, San Francisco, CA (US); Keenan Wyrobek, Half Moon Bay, CA (US); Gregoire Vandenbussche, San Francisco, CA (US); Daniel Sobel, Berkeley, CA (US); Joshua Liu, Newark, CA (US); Maria Patni, Lisle, IL (US); Danielle Fallon, San Francisco, CA (US); David Oke, San Francisco, CA (US); Amal Nanavati, Fremont, CA (US); Jamie Chung, Walnut Creek, CA (US); Mathias Schmidt, Oakland, CA (US); Kevin Nalecz, San Francisco, CA (US); Gage Coffin, Los Altos Hills, CA (US); Daphnie Friedman, Hanover, NH (US); Blake Hord, Carpinteria, CA (US); Coco Wong, San Francisco, CA (US); Andrew James Frantz, Ann Arbor, MI (US); Julie Messing, San Francisco, CA (US); Schuyler Cohen, Austin, TX (US); Ryan Wolcott, Ann Arbor, MI (US); Connor Boris, San Francisco, CA (US); Radhika Gurumurthy, Boston, MA (US); Mengyu Andres Lu, San Francisco, CA (US); Peter I. Capraro, San Francisco, CA (US); Michael Clifton, Flagstaff, AZ (US)

(21) Appl. No.: 19/161,347

(22) PCT Filed: Feb. 16, 2024
(86) PCT No.: PCT/US2024/016087

§ 371 Date: Sep. 2, 2025

Related U.S. Application Data
(60) Provisional application No. 63/449,552, filed on Mar. 2, 2023.
(60) Provisional application No. 63/536,747, filed on Sep. 6, 2023.
(60) Provisional application No. 63/538,187, filed on Sep. 13, 2023.
(60) Provisional application No. 63/618,295, filed on Jan. 6, 2024.

(51) Int. Cl. B64U 70/99; B60L 53/30; B60L 53/36; B64U 50/37; B64U 70/30; B64U 70/95; B64U 70/97; B64U 80/70

(52) U.S. Cl. CPC B64U 70/99; B60L 53/30; B60L 53/36; B64U 50/37; B64U 70/30; B64U 70/95; B64U 70/97; B64U 80/70

(57) ABSTRACT

Docking assemblies, catch barriers for aerial vehicles, and methods of deploying and collapsing the same are disclosed. In an example, a method for collapsing a docking assembly includes collapsing a catch barrier of the docking assembly; and lowering an upper post of the docking assembly by rotating the upper post about a hinge relative to a lower post of the docking assembly.

### CROSS-REFERENCE TO RELATED APPLICATIONS

This application claims the benefit of each of the following applications, the disclosures of which are incorporated by reference in their entireties: U.S. Provisional Patent Application No. 63/449,552, filed Mar. 2, 2023; U.S. Provisional Patent Application No. 63/536,747, filed Sep. 6, 2023; U.S. Provisional Patent Application No. 63/538,187, filed Sep. 13, 2023; and U.S. Provisional Patent Application No. 63/618,295, filed Jan. 6, 2024.

This application is related to International Patent Application No. _______ (Attorney Docket No. P308474. WO.01), filed on _______ and titled “Aerial Vehicle and Aerial Vehicle Systems,” and International Patent Application No. _______ (Attorney Docket No. P308478.WO.01), filed on ______ and titled “Autonomous Delivery Vehicle and System,” all of which are incorporated by reference in their entireties.

### FIELD

The described embodiments relate generally to docking and/or charging and storage systems for aerial vehicles.

### BACKGROUND

As aerial vehicles become more ubiquitous, e.g., drones, autonomous aerial vehicles, and the like, such vehicles will need to have storage and/or charging structures (e.g., docks). Conventional storage for aerial vehicles may include large aircraft hangers or the garages of hobbyists for smaller aircraft. As such, as the use of aerial vehicles expands, especially for use in deliveries, and the like, there is a need for storage and/or charging structures and methods to allow navigation of the aerial vehicles to such structures.

### SUMMARY

An example method for navigating an aerial vehicle to a dock includes receiving, by the aerial vehicle, first information from a first source and navigating towards the dock utilizing the first information. The method further includes receiving, by the aerial vehicle, second information from a second source and orienting the aerial vehicle relative to the dock utilizing the second information. In examples, the first information includes global positioning satellite (GPS) location information for the dock, wherein navigating towards the dock utilizing the first information includes navigating towards a location obtained from the GPS location information. In examples, the second information includes a fiducial located on the dock and including one or more illuminated panels encoding an identifier for the dock. In examples, the first information includes a first fiducial located on the dock and including one or more illuminated panels encoding an identifier for the dock, wherein navigating towards the dock includes identifying the dock from a plurality of docks using the identifier and the first fiducial and navigating towards the identified dock. In examples, the second information includes at least a second fiducial located on a mount structure below the dock, wherein orienting relative to the dock includes maneuvering the UAV relative to the dock based on a location of the second fiducial.

An example dock for receiving an aerial vehicle is disclosed herein. The dock includes a first fiducial on a first surface of the dock, where the first fiducial provides information to the aerial vehicle for identifying the dock from a plurality of docks. The dock further includes a second fiducial on a second surface of the dock, where the second fiducial provides information to the aerial vehicle for maneuvering relative to the dock. In examples, the first fiducial includes one or more illuminated panels, the illuminated panels encoding an identifier associated with the dock.

An example method of retaining an aerial vehicle in a dock includes orienting the aerial vehicle relative to a latch jaw located on a bottom surface of the dock, where the latch jaw includes first and second spring loaded arms. The method further includes navigating the aerial vehicle upward such that a fin of the aerial vehicle displaces the first and second spring-loaded arms of the latch jaw, where the fin of the aerial vehicle extends upward from the aerial vehicle. The method further includes securing the fin of the aerial vehicle by closing the first and second spring-loaded arms of the latch jaw around a portion of the fin of the aerial vehicle and moving the aerial vehicle to a retracted state in the dock, where the fin is in connection with contact pins in the dock when in at least the retracted state. In examples, orienting the aerial vehicle relative to the latch jaw includes using an angled surface of the dock to passively guide the aerial vehicle to the latch jaw.

An example dock for an aerial vehicle includes a body including an angled surface configured to passively align the aerial vehicle to a docking location. In examples, the angled surface forms a bottom surface of the body and the angled surface extends upwards towards a top surface of the body. In examples, the angled surface further extends upward towards a retention assembly, wherein the retention assembly retains the aerial vehicle when the vehicle is in the docking location. In examples, the body includes one or more identifiers positioned on the body to communicate a location of the dock to the aerial vehicle. In examples, the one or more identifiers include a first plurality of fiducials positioned on a top surface of the body and a second plurality of fiducials positioned on a mount structure below the bottom surface of the body, wherein the first plurality of fiducials provide information to the aerial vehicle for identifying the dock, wherein the second plurality of fiducials provide information to the aerial vehicle for maneuvering relative to the dock. In examples, each of the first plurality of fiducials include a plurality of light emitting diodes (LEDs), wherein the information identifying the dock is communicated to the aerial vehicle by one or more of color of the plurality of LEDs and an illumination pattern of the plurality of LEDs. In examples, the dock includes a charging assembly configured to provide power to the aerial vehicle when the aerial vehicle is coupled thereto, wherein the body at least partially encloses the charging assembly, and wherein the aerial vehicle is electrically connected to the charging assembly when in the docking location.

An example method of delivering payload to an aerial vehicle using a loading assembly includes navigating a payload receptacle of the aerial vehicle into a chute of a loading assembly. The method further includes moving the payload receptacle down the chute of the loading assembly and providing a visual cue that the payload receptacle has moved down the chute of the loading assembly and is ready for removal of the payload from the payload receptacle.

An example retention assembly for aerial vehicles includes a housing defining an opening for receiving a portion of an aerial vehicle and a clamp coupled to the housing and configured to clamp around a portion of the aerial vehicle. In examples, the clamp is located on a bottom surface of the housing, wherein the portion of the aerial vehicle is a docking component protruding from a top surface of the aerial vehicle. In examples, the clamp is configured to retain the aerial vehicle in the retention assembly in the absence of electrical power to the retention assembly. In examples, the clamp includes a first arm, a second arm, and a spring biasing the first arm toward the second arm, wherein the portion of the aerial vehicle overcomes a biasing force of the spring to separate the first arm and the second arm. In examples, the retention assembly includes an actuator and a third arm coupled to the first arm and the second arm, wherein actuation of the actuator moves the third arm to move the first arm and the second arm. In examples, the retention assembly includes a slot defined in the third arm, and a pin positioned within the slot and coupling the first arm, the second arm, and the third arm together, wherein the pin moves within the slot with movement of the third arm. In examples, the retention assembly includes a position sensor, wherein the position sensor detects that the clamp is in an open state or a closed state.

An example loading assembly for an aerial vehicle includes a dock to securely couple to the aerial vehicle and a portal coupled to a payload storage area, where the portal and the dock are arranged adjacent to the payload storage area, where the dock is positioned above the portal. In examples, the portal includes a chute that extends at an angle through a wall forming a portion of the payload storage area. In examples, a payload receptacle slides onto the chute to enter into the payload storage area. In examples, the portal includes a door for selectively enabling access to the payload storage area.

An example dock for an aerial vehicle includes a housing for coupling to the aerial vehicle and a thermal system thermally coupled to a battery of the aerial vehicle, wherein the thermal system is configured to regulate an environmental temperature around the battery when the aerial vehicle is coupled to the housing. In examples, the thermal system includes dock subsystem and a vehicle subsystem, the dock subsystem configured to regulate an environmental temperature within the housing, the vehicle subsystem configured to regulate the environmental temperature around the battery. In examples, the thermal system includes an air-to-air heat exchanger to facilitate heat transfer between the dock subsystem and the vehicle subsystem.

An example dock for an aerial vehicle includes a housing and a securing assembly coupled to the housing and configured to selectively secure the aerial vehicle thereto, where the securing assembly secured the aerial vehicle such that two or more propellers of the aerial vehicle do not contact the housing. In examples, the securing assembly is configured to support a weight of the aerial vehicle.

An example dock for an aerial vehicle includes a top shell and a bottom shell coupled to the top shell. In examples, the top shell includes a center portion having a first side and a second side, a first wing extending at a first angle away from the first side, and a second wing extending at a second angle away from the second side. In examples, the top shell and the bottom shell are integrally formed. In examples, the dock includes one or more bumpers to engage the aerial vehicle when docked.

An example dock for an aerial vehicle includes a top surface and a bottom surface including a securing assembly, where the bottom surface is shaped such that, when the aerial vehicle is secured in the securing assembly, rotors of the aerial vehicle are spaced apart from the bottom surface of the dock.

An example method for navigating an aerial vehicle to a dock includes identifying the dock from a location above the dock using at least first dock location information received from a first source and aligning the top surface of the aerial vehicle to a bottom surface of the dock using at least second dock location information.

An example method for collapsing a docking assembly includes collapsing a catch barrier of the docking assembly, and lowering an upper post of the docking assembly by rotating the upper post about a hinge relative to a lower post of the docking assembly. In an example, the method further includes removing fasteners that fasten the upper post to the lower post prior to lowering the upper post. In an example, the upper post is lowered by a winch. In an example, the method further includes adding tension to a winch line with the winch without lowering the upper post, and removing fasteners that fasten the upper post to the lower post prior to lowering the upper post. In an example, the upper post is lowered by a hydraulic lift. In an example, the catch barrier is collapsed by rotating a plurality of spokes relative to a central hub using a draw line.

An example method for deploying a docking assembly includes positioning the docking assembly at an installation location, raising an upper post of the docking assembly, and deploying a catch barrier of the docking assembly. In an example, the method further includes fastening the upper post to the lower post after raising the upper post. In an example, the upper post is raised by a winch. In an example, the upper post is raised by a hydraulic lift. In an example, the catch barrier is deployed by rotating a plurality of spokes relative to a central hub using a tension line.

An example docking assembly configured to be deployed directly on the ground includes a ballast, a lower post attached to the ballast, an upper post rotatably attached to the lower post by a hinge, a dock attached to the upper post, and a collapsible catch barrier attached to the upper post. In an example, the docking assembly further includes a winch line connected to the upper post, where the winch line is configured to raise and lower the upper post. In an example, the docking assembly further includes a linkage attached to the upper post, the linkage including a member configured to slide in a channel of the lower post, where the linkage is configured to raise and lower the upper post. In an example, the docking assembly is configured to be deployed in a parking space. In an example, the ballast is configured to allow a compact vehicle to park thereon. In an example, the hinge is attached to a cantilevered portion of the lower post.

An example catch barrier includes a central hub, a plurality of spokes rotatably coupled to the central hub, a tension line configured to rotate the plurality of spokes to a deployed configuration, and a draw line configured to rotate the plurality of spokes to a collapsed configuration. In an example, the catch barrier further includes a support arm, and a pulley attached to the support arm, where the tension line is attached to the support arm and the central hub, and the draw line is attached to one of the spokes and removably attached to the central hub. In an example, the spokes extend towards the support arm in the collapsed configuration. In an example, respective spokes are coupled to the central hub at varying heights. In an example, the catch barrier further includes a plurality of lock nuts configured to maintain the spokes at the varying heights. In an example, each of the spokes passes through an upper flange of the central hub, a respective lock nut, and a lower flange of the central hub.

An example docking assembly for an aerial vehicle having a primary vehicle and a secondary vehicle includes a dock to securely couple to the aerial vehicle, a catch barrier positioned below the dock, and a loading portal coupled to the catch barrier to receive the secondary vehicle when lowered from the primary vehicle. In examples, the loading portal is coupled below an opening in the catch barrier to receive the secondary vehicle through the opening. In examples, the loading portal supports the secondary vehicle in a position for loading and/or unloading below the catch barrier.

An example loading assembly for an aerial vehicle includes a hopper for receiving a portion of the aerial vehicle, and at least one rail for guiding the portion to a loading portal to deliver and/or receive a payload of the aerial vehicle. In examples, the portion is a secondary vehicle lowered from a primary vehicle of the aerial vehicle. In examples, the at least one rail comprises a pair of rails to receive feet of the secondary vehicle, the feet sliding on the pair of the rails to the loading portal. In examples, the hopper is defined by one or more tubes shaped to receive and align the secondary vehicle to the at least one rail as the secondary vehicle is lowered.

An example dock for an aerial vehicle includes a securing assembly and a housing shaped to accommodate the aerial vehicle when secured in the securing assembly. The housing may include engagement points encouraging the aerial vehicle into a defined orientation during docking. In examples, the aerial vehicle engages the engagement points to distribute a load away from the securing assembly. In examples, the housing comprises a bottom surface, the engagement points defined on the bottom surface.

An example docking assembly for an aerial vehicle includes a dock to securely couple to the aerial vehicle, the dock comprising a first set of fiducials for guiding the aerial vehicle to the dock. In examples, the docking assembly includes a second set of fiducials for final localization during docking and takeoff maneuvers of the aerial vehicle. In examples, the first set of fiducials are located on a top of the dock, and the second set of fiducials are located below the dock. In examples, the docking assembly includes a visual sensor for completing automated preflight checks of the aerial vehicle.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example aerial vehicle docking assembly including a loading assembly.

FIG. 2 is a perspective view of an example aerial vehicle dock.

FIG. 3A is a rear view of the aerial vehicle dock.

FIG. 3B is a front view of the aerial vehicle dock.

FIG. 4A is a left side view of the aerial vehicle dock.

FIG. 4B is a right side view of the aerial vehicle dock.

FIG. 5 is a top view of the aerial vehicle dock.

FIG. 6 is a bottom view of the aerial vehicle dock.

FIG. 7A is a perspective view of a lower portion of the aerial vehicle dock.

FIG. 7B is a left side view of the lower portion of the aerial vehicle dock.

FIG. 7C is a rear view of the lower portion of the aerial vehicle dock.

FIG. 7D is a front view of the lower portion of the aerial vehicle dock.

FIG. 8A is a front section view of the aerial vehicle dock.

FIG. 8B is a detailed view of a retention assembly of the aerial vehicle dock.

FIG. 9A shows a fin of an aerial vehicle moving toward the retention assembly.

FIG. 9B shows the fin of the aerial vehicle moving toward the retention assembly.

FIG. 9C shows the fin of the aerial vehicle displacing arms of a lockjaw of the retention assembly.

FIG. 9D shows the fin of the aerial vehicle retained by the lockjaw of the retention assembly.

FIG. 9E shows the fin of the aerial vehicle in a retracted position within the retention assembly.

FIG. 10 is a perspective view of an aerial vehicle docked at the aerial vehicle dock.

FIG. 11 is a top view of the aerial vehicle docked at the aerial vehicle dock.

FIG. 12 shows a perspective view of the aerial vehicle dock including a warming feature.

FIG. 13 shows a perspective view of an example aerial vehicle docking assembly.

FIG. 14A is a block diagram of an additional implementation of an aerial vehicle docking assembly.

FIG. 14B is a block diagram of an additional implementation of an aerial vehicle docking assembly.

FIG. 15A is a perspective view of an aerial vehicle dock secured to an arm of a support of the aerial vehicle docking assembly.

FIG. 15B is a left side view of the aerial vehicle dock secured to the arm of the support.

FIG. 16A is a side view of installation of the aerial vehicle dock on the arm of the support.

FIG. 16B is a side view of installation of the aerial vehicle dock on the arm of the support.

FIG. 16C is a side view of removal of the aerial vehicle dock from the arm of the support.

FIG. 16D is a side view of removal of the aerial vehicle dock from the arm of the support.

FIG. 17A is a perspective view of a portal of a loading assembly in the interior of a building.

FIG. 17B is a side view of the portal of the loading assembly.

FIG. 17C is a side view of the portal of the loading assembly.

FIG. 18A is a perspective view of an additional implementation of the loading assembly.

FIG. 18B is a perspective view of the additional implementation of the loading assembly.

FIG. 19A is a side view of the portal in an open position.

FIG. 19B is a perspective view of the portal in the open position.

FIG. 20 is a block diagram of an additional implementation of the docking assembly.

FIG. 21 illustrates an example method of docking an aerial vehicle at the aerial vehicle dock.

FIG. 22 illustrates an example method of docking an aerial vehicle at the aerial vehicle dock.

FIG. 23 illustrates an example method of utilizing the loading assembly to deliver payload from a secondary vehicle of the aerial vehicle.

FIG. 24 illustrates additional features of an example loading assembly.

FIG. 25 is a perspective view of a docking assembly.

FIG. 26A is a perspective view of the docking assembly in a deployed configuration.

FIG. 26B is a perspective view of the docking assembly with a catch barrier in a collapsed configuration.

FIG. 26C is a perspective view of the docking assembly in a collapsed configuration.

FIG. 27A is a side view of a docking assembly with a winch rotation device in a deployed configuration.

FIG. 27B is a side view of the docking assembly with the winch rotation device in a collapsed configuration.

FIG. 28A is a side view of a docking assembly with a hydraulic lift rotation device in a deployed configuration.

FIG. 28B is a side view of the docking assembly with the hydraulic lift rotation device in a collapsed configuration.

FIG. 29A is a perspective view of a hub-and spoke catch barrier in a deployed configuration.

FIG. 29B is a top-down view of the hub-and spoke catch barrier in the deployed configuration.

FIG. 29C is a top-down view of the hub-and spoke catch barrier during a collapse process.

FIG. 29D is a top-down view of the hub-and spoke catch barrier during a collapse process.

FIG. 29E is a top-down view of the hub-and spoke catch barrier in a collapsed configuration.

FIG. 29F is a side view of the hub-and spoke catch barrier in the collapsed configuration.

FIG. 30A is a perspective view of an umbrella-type catch barrier.

FIG. 30B is a perspective view of a tension-type catch barrier.

FIG. 30C is a perspective view of a net-type catch barrier.

FIG. 31 illustrates an example schematic of a cloud service in communication with an aerial vehicle dock, an aerial vehicle, and a control station.

FIG. 32A illustrates a bottom perspective view of an example of a dock.

FIG. 32B is a side perspective view of the dock of FIG. 32A.

FIG. 32C is a side perspective view of a bottom portion of the dock of FIG. 32A.

FIG. 33A is an elevation view of the dock of FIG. 32A with the top portion removed.

FIG. 33B is an enlarged view of the dock of FIG. 33A.

FIG. 34A is a top perspective view of an example of a dock including a fiducial.

FIG. 34B is a side elevation view of the dock of FIG. 34A.

FIGS. 35-36 are perspective views of an additional implementation of a loading assembly.

FIG. 37 is a cross-sectional view of the loading assembly in an open configuration.

FIG. 38 is a cross-sectional view of the loading assembly in a closed configuration.

FIG. 39 is a perspective view of an additional implementation of a loading assembly.

FIGS. 40-42 are perspective views of a docking assembly in first, second, and third configurations, respectively.

FIGS. 43A-43B are perspective and cross-sectional views of a hinge and cable routing layout of the docking assembly in the first configuration.

FIGS. 44A-44B are perspective and cross-sectional views of the hinge and cable routing layout of the docking assembly in the second configuration.

FIGS. 45A-45B are perspective and cross-sectional views of the hinge and cable routing layout of the docking assembly in the third configuration.

FIG. 46 is a cross-sectional view of a dual hinge pin.

FIG. 47 is a perspective view of a docking assembly in a folded configuration.

FIG. 48 is a schematic drawing of a thermal system for a dock.

FIG. 49 is a perspective view of the thermal system of FIG. 48.

FIG. 50 is a cross-sectional view of an additional implementation of a retention assembly.

### DETAILED DESCRIPTION

In various embodiments, docking assemblies and methods of docking aerial vehicles are described herein. While various embodiments can be used with substantially any type of aerial vehicle, in many embodiments, the docking assemblies are configured for use with autonomous or semi-autonomous aerial vehicles. In one example, the docking assemblies may be used for aerial vehicle systems that may include a main or first aerial vehicle and a secondary or second aerial vehicle that deploys from the first aerial vehicle to deliver a payload. In these embodiments, the docking assemblies described herein are configured to allow docking of the first aerial vehicles and/or loading of the second aerial vehicle (e.g., loading with a payload or package for delivery). Relatedly, embodiments described herein enable aerial vehicles to be docked, charged, and/or loaded at various locations, including those coupled to existing structures (e.g., buildings) and/or new structures.

The docking assembly described herein may generally utilize a top docking procedure to allow the aerial vehicle to be secured to the dock via a top portion of the aerial vehicle. For example, an aerial vehicle landing at the dock may approach the dock in order to “land” or be secured to the dock from below and the dock may engage with and retain an upper portion or top surface of the aerial vehicle. Such a top docking configuration allows access to an underside of the aerial vehicle, such as for a secondary vehicle and/or payload to descend from the aerial vehicle. Further, the dock, when located above the aerial vehicle, may provide some cover and/or protection of the aerial vehicle. For example, some components of the aerial vehicle (e.g., sensitive or easily damaged components) may be shielded from weather, debris, and the like by the dock. Additionally or alternatively, the top docking configuration further may be configured to not cover moving elements of the aerial vehicle (e.g., propellers), which may further help prevent damage to those elements during docking and undocking.

A top docking configuration further provides a more stable retention of an aerial vehicle as compared to other docking systems. In one example, a retention assembly is disclosed configured to securely receive and/or clamp around a top extending portion of an aerial vehicle. In this manner, the retention assembly may be configured to avoid damage or interference with certain sensitive components of the aerial vehicle (e.g., the propellers), as well as better assist the aerial vehicle in docking in a variety of conditions as compared to other docking mechanisms and structures.

Docking assemblies disclosed herein may further include various features allowing an aerial vehicle to land at and/or engage with the dock from a variety of orientations relative to the dock. For example, a bottom surface of the dock may include an angled surface configured to guide and/or passively align the aerial vehicle toward a retention assembly of the dock as the aerial vehicle thrusts upward with respect to the dock. For example, the aerial vehicle may include a top extending portion configured to make contact with the bottom surface of the dock. When the top extending portion makes contact with the angled surface, the angled surface may align the aerial vehicle both to form a desired angle with the dock (e.g., with the top extending portion being perpendicular to the dock) and to align the aerial vehicle with the retention assembly both radially and with respect to height. In some examples, the retention assembly may further include features configured to aid in alignment of the aerial vehicle during docking. Such alignment features (e.g., the angled surface and/or features of the retention assembly) may allow for aerial vehicles to land or engage at the dock with less precision than may otherwise be needed. For example, as long as an aerial vehicle is within a threshold radius and angle with respect to the retention assembly of the dock, the alignment features of the dock may guide the aerial vehicle towards the retention assembly for successful docking and controlled movement of the aerial vehicle. Conventional aerial vehicle docks typically require precision and control to enable accurate docking, which may be difficult in strong weather conditions and/or with fully autonomous vehicle operations.

In some examples, a docking assembly disclosed herein includes fiducials which may be used to guide aerial vehicles towards the docking assembly. In other examples, sources may provide the aerial vehicle with location information for a dock to facilitate navigation towards, and orienting with respect to, the dock. In various examples, first location information may be utilized by an aerial vehicle to locate and/or approach a top surface of the dock, while additional location information may be utilized by the aerial vehicle to orient with respect to the dock (e.g., to align with a bottom surface of the dock).

In various embodiments, loading assemblies for aerial vehicles are provided herein. Such loading assemblies may integrate various docking assemblies with a location (e.g., warehouse, restaurant, buildings, structures, or the like) receiving and/or dispatching payload via aerial vehicles. In various examples, such loading assemblies may allow for loading of payload into aerial vehicles from an interior of a building, allowing operators to remain indoors and reducing complexity of delivery via aerial vehicles. For example, loading assemblies disclosed herein may include a chute or other access passage coupled to a dock assembly (e.g., arranged below a dock assembly). The chute may allow a secondary vehicle descending from a docked aerial vehicle to enter a building via an opening in a wall or other access location (e.g., window, door, etc.) of the building, allowing the secondary vehicle to be both loaded and unloaded from the interior of the building. Such loading assemblies may include a small number of moving components, reducing maintenance costs for shippers or other entities using the loading assemblies. More particular, in some examples, the chute or passage may be angled downwards from the dock to the access location, such that the payload receiving aerial vehicle (e.g., second aerial vehicle) may transition from the first aerial vehicle to the loading location via the force of gravity, rather than active movement assemblies (e.g., motors, ramps, or the like). Such a passive configuration helps to reduce the need for moving parts, ensuring reliability as mentioned above.

In some examples, docking assemblies can be installed directly on the ground, without requiring site modification, which can increase deployment time for such assemblies. The docking assemblies can be installed in a standard parking stall area (or other similarly sized area), while allowing compact vehicles to park on the docking assembly in the parking stall. The docking assemblies can include thin ballasts on which vehicles can park. The docking assemblies can include upper posts on which catch barriers and docks are mounted, and which are rotatable relative to lower posts. This allows for the docking assemblies to be collapsed for shipping, maintenance, and the like. The docking assemblies can be collapsed using a winch assembly, a hydraulic lift assembly, or the like. The docking assemblies can be easily, quickly, and easily installed with little permitting or site modification, which provides reliable, cost-effective docking assemblies.

In some examples, catch barriers can be used to catch aerial vehicles, such as in cases of failed docking, payload loading or deployment issues, debris, or the like. The catch barriers can be collapsible, which allows for docking assemblies on which the catch barriers are mounted to be collapsible without the catch barriers interfering with the collapsing process. The catch barriers can include hub-and spoke-type catch barriers, umbrella-type catch barriers, tension-type catch barriers, net-type catch barriers, and the like. Providing collapsible docking assemblies and catch barriers allows for loading assemblies and the catch barriers to be easily maintained, transported, and the like.

Various embodiments of the present disclosure will be explained below in detail with reference to the accompanying drawings. Other embodiments may be utilized, and structural, logical and electrical changes may be made without departing from the scope of the present disclosure.

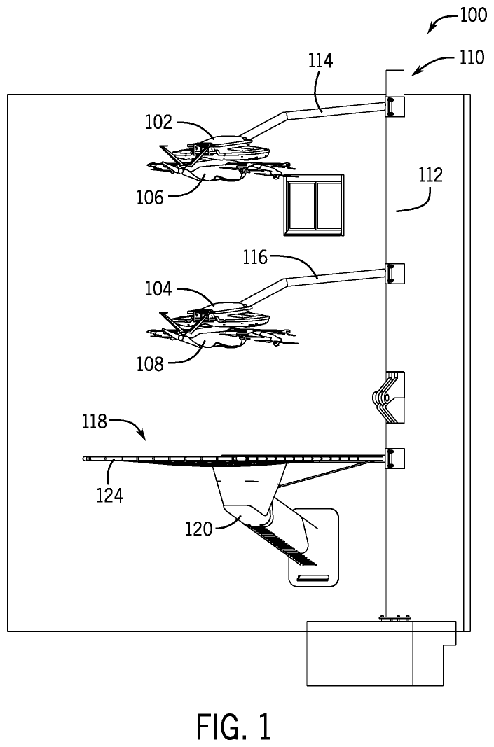

FIG. 1 illustrates an example docking assembly 100 for aerial vehicles 106, 108. The docking assembly 100 may include at least one dock 102, but may include more than one dock, e.g., docks 102 and 104, which mechanically retain the aerial vehicles 106 and 108, respectively, e.g., secure the aerial vehicles 106 and 108 in a docked configuration. In various examples, the docks 102 and 104 may further provide electrical connections (e.g., power and/or data) to the aerial vehicles 106 and 108 to, for example, charge batteries of the aerial vehicles 106 and 108 and/or provide mission information or other useful data to the aerial vehicles 106 and 108. For example, each dock may serve as a dedicated parking spot or housing location for aerial vehicles, with the dock providing thermal regulation and charging for the vehicle's battery, weather protection for the aerial vehicle when not in use, and data transfer capabilities (e.g., from the aerial vehicle to a server, the cloud, etc.). It should be noted that while in many instances the docks may be configured to provide multiple functions for the aerial vehicles, in other instances there may be specialized docks, e.g., a charging dock, thermal conditioning dock, etc.

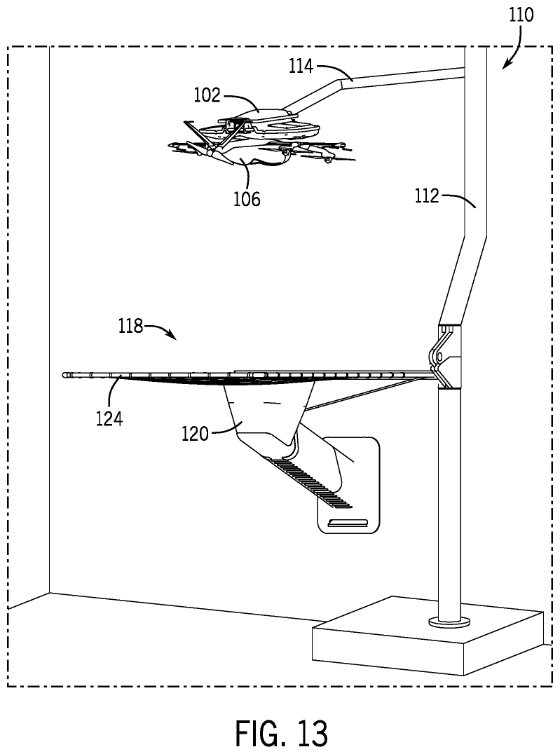

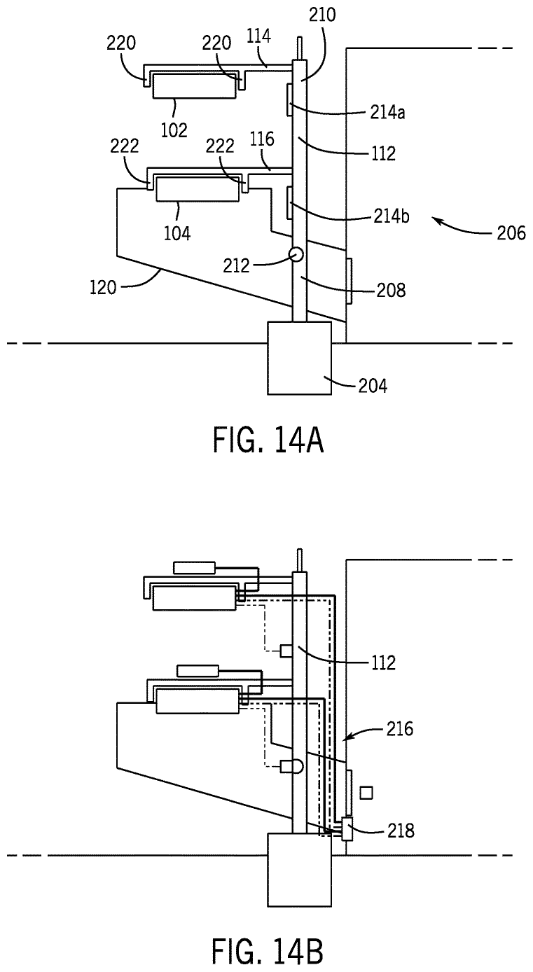

The docks 102 and 104 may generally be mounted on or otherwise held in place by a support 110. The support 110 may include a vertical tower 112 and arms 114 and 116. When held in place by the support 110, the docks 102 and 104 are generally positioned to receive aerial vehicles 106 and 108, e.g., raised above a bottom or support surface sufficiently high to allow clearance for the aerial vehicle to dock underneath. It should be noted that although FIG. 1 is discussed with respect to two docks 102, 104, in other instances fewer (e.g., a single dock) or more than two docks may be coupled to the tower 112 or other support structure that supports the docks 102 and 104 relative to the ground or other support surface and/or building. Examples of the tower 112 will be discussed in more detail below with respect to FIGS. 13 and 14A.

In various examples, the docks 102 and/or 104 mounted on the support 110 may be configured to charge aerial vehicles and/or may be configured to allow aerial vehicles to unload and/or receive payload via a loading assembly 118. For example, in FIG. 1, dock 102 may be a charging dock, such that the aerial vehicle 106 may receive electrical power (e.g., to charge batteries) via the dock 102. The dock 104 may be a loading dock, which may or may not provide charging capabilities to the aerial vehicle 108. However, the dock 104 is generally placed relative to the loading assembly 118 such that the aerial vehicle may utilize the loading assembly 118 to receive and/or deliver payload. For example, a secondary vehicle may descend from the aerial vehicle 108 and pass through a chute 120 (or passage, tube, portal, ramp) of the loading assembly 118 to deliver payload to, and/or receive payload from, the inside of the building adjacent to the docking assembly 100. In this manner, the secondary vehicle may be a cargo delivery system vehicle that carries and transports a shipper's payload to a delivery site. In various examples, docking assemblies may include different numbers of charging and/or loading docks, multiple towers, and the like.

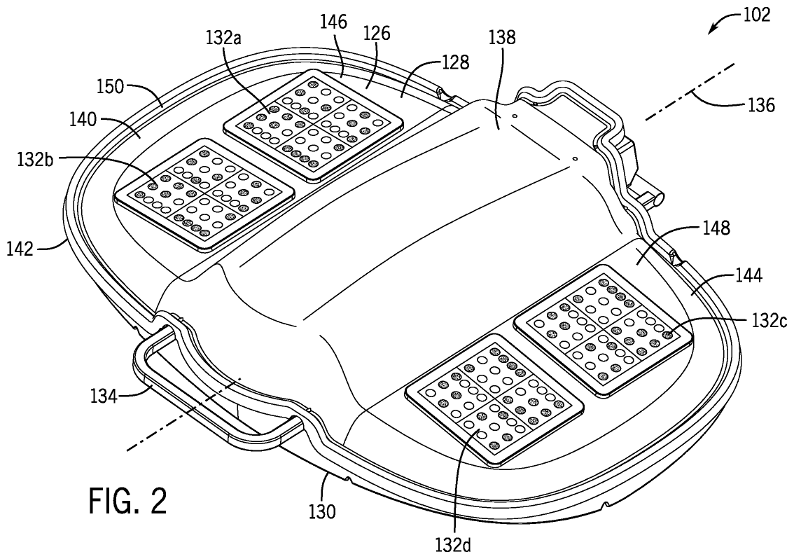

With reference to FIG. 2, the dock 102 generally includes a housing or body 126, which may enclose other components of the dock 102, such as a charging assembly, a retention assembly, or the like. The body 126 generally includes a top surface 128 and a bottom surface 130, which may each be formed of a single piece of material and may connect or engage with one another to enclose other components of the dock 102. Fiducials 132a-132d may be located on the top surface 128 of the dock 102 and may provide information for an aerial vehicle to locate and/or orient relative to the dock 102. The dock 102 may further include a frame 134 partially enclosed by the body 126. The frame 134 may generally provide structural support for the dock 102 and may, in some examples, be used to engage the dock 102 with the support structure 110 and/or to allow easier transport or assembly of the dock 102.

In various examples, the dock 102 may be generally designed to absorb and/or distribute impacts which may occur, for example, when aerial vehicles approach the dock 102. For example, the body 126 of the dock 102 may be formed from ABS plastic or similar materials that deform on impact. The thickness of the material, flexibility, as well as ribs or other features in the body 126 of the dock 102 may provide further protection from impacts from aerial vehicles.

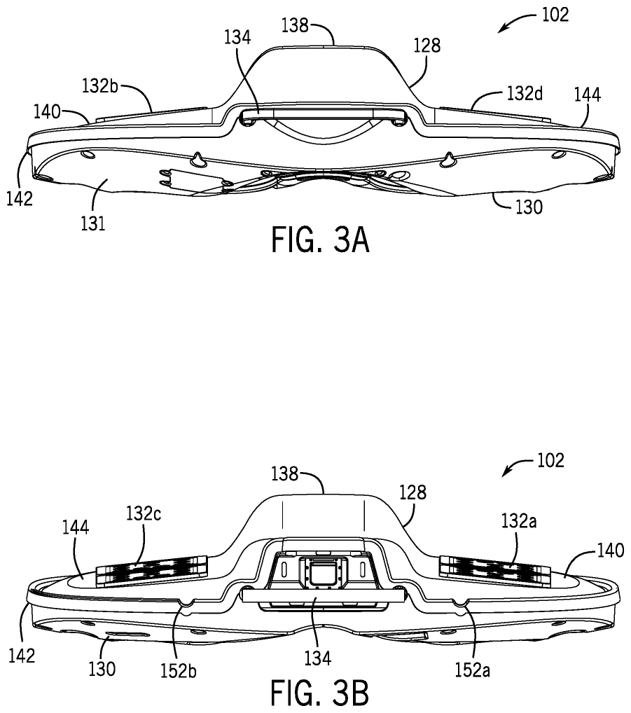

With continued reference to FIG. 2, the top surface 128 of the dock 102 may generally be symmetrical about a longitudinal axis 136 of the dock 102. The top surface 128 of the dock 102 generally includes a center portion 138 or hub, a first outer portion 140 or wing extending from the center portion 138 to a peripheral edge 142 of the dock 102, and a second outer portion 144 or wing extending from the center portion 138 to the peripheral edge 142. With reference to FIG. 3A, the center portion 138 may extend from the longitudinal axis 136 of the dock 102 in each direction and downward towards the first outer portion 140 and the second outer portion 144. The center portion 138 may be curved downward along the longitudinal axis, extending downward to a gutter 150 extending around the perimeter of the dock. In some embodiments, the center portion 138 or hub may be formed as a raised protrusion relative to the top surfaces of the outer portions 140, 144 or wings.

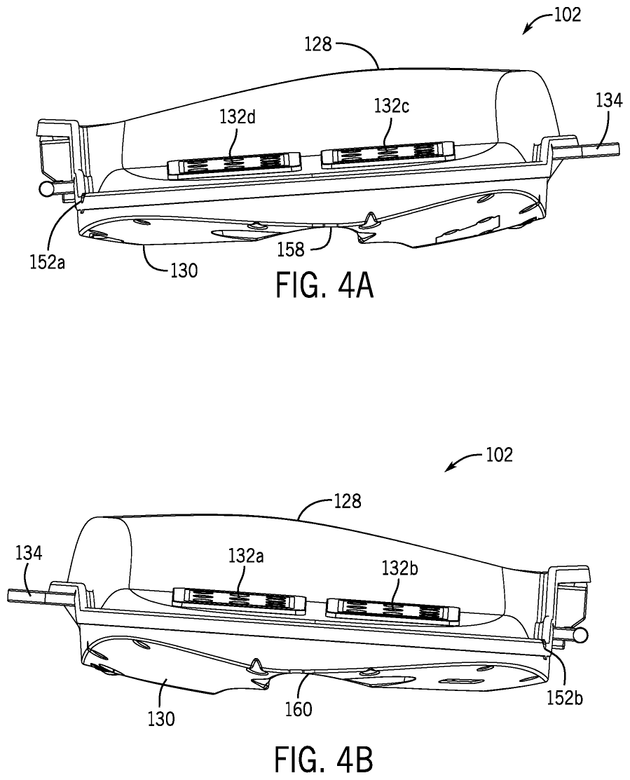

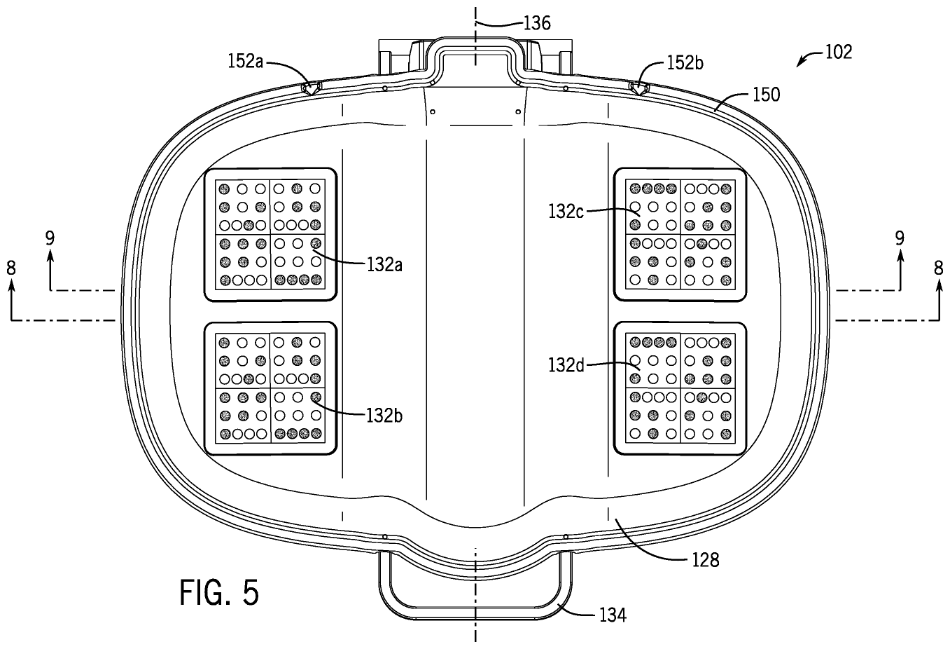

With reference to FIG. 2, the first outer portion 140 or wing generally includes a flat portion 146 or shoulder extending from the center portion 138. In some embodiments, the flat portion 146 may be relative planar but may be angled relative to the center portion 138, e.g., to encourage drainage. At the edge of the flat portion 146, the first outer portion may generally curve or transition downward to the gutter 150 or perimeter edge. Similarly, the second outer portion 144 or wing generally includes a flat portion 148 or shoulder extending from the center portion 136. The second outer portion 144 may extend outward from the flat portion 148, curving downward towards the gutter 150. As shown, for example, in FIG. 5, the gutter 150 may generally extend around the perimeter of the top surface 128 of the dock 102 and may be recessed as compared to other areas of the dock 102, e.g., may be defined as a recessed formation to capture fluids that may drain from the top surface. Generally, the top surface 128 of the dock may curve downward towards the gutter 150 such that water, debris, and the like flow from the top surface 128 of the dock 102 and into the gutter 150. The gutter 150 may further include notches 152a and 152b or in some instances, apertures, allowing fluid and/or debris to flow out of the gutter 150 and off of the dock 102. As shown in FIGS. 4A and 4B, the top surface 128 of the dock may be tilted along the longitudinal axis 136 such that the notches 152a and 152b are located at the lowest part of the top surface 128, such that liquid in the gutter 150 naturally (e.g., under the force of gravity) flows to the notches 152a and 152b and off of the dock 102. The notches 152a and 152b may also provide a location for formation of icicles in cold temperatures, and may be located such that icicles falling off of the dock 102 near the notches 152a and 152b do not damage an aerial vehicle 106 docked at the dock 102.

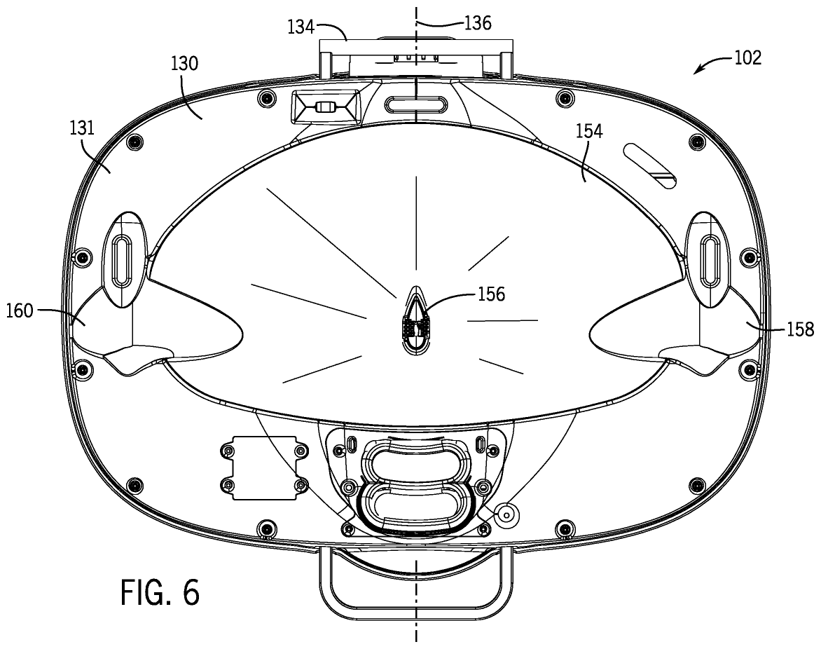

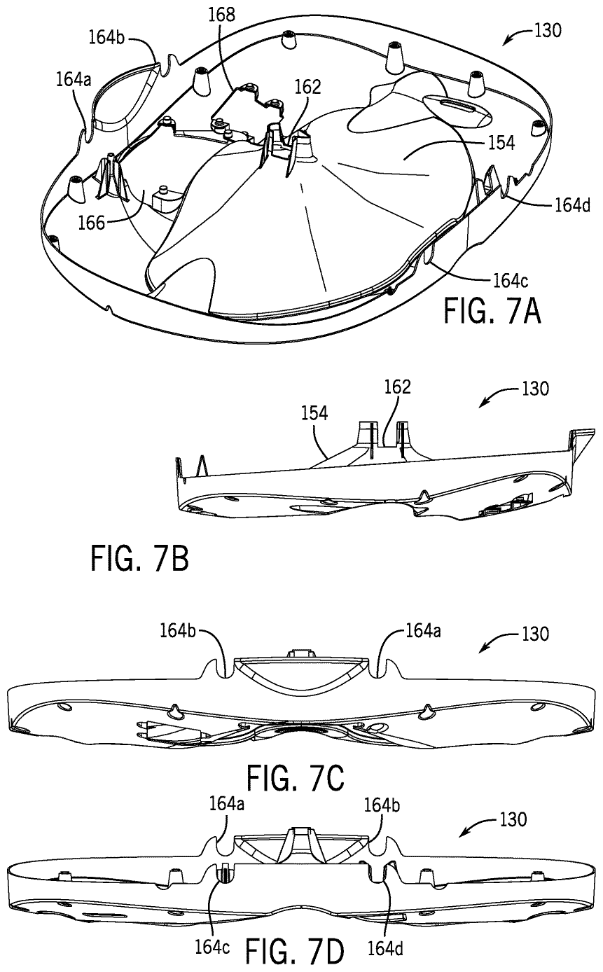

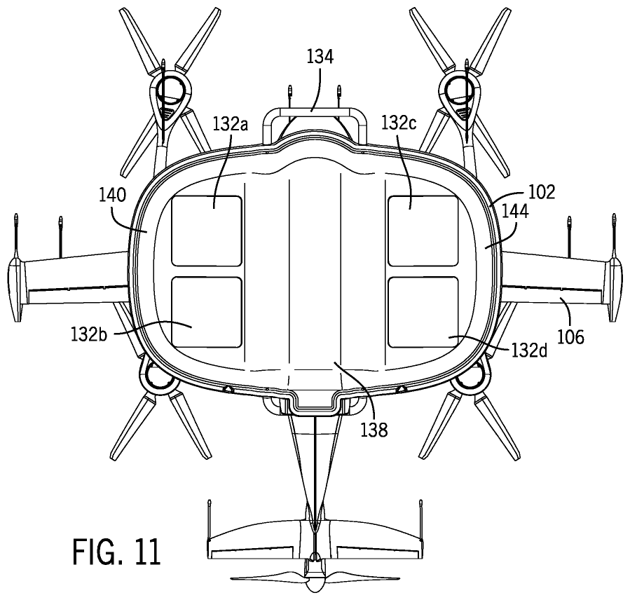

With reference to FIG. 6, the bottom surface 130 or docking surface of the dock 102 generally includes an angled surface 154 extending upward towards a retention assembly 156 of the dock 102. The angled surface 154 may be configured to act as a lead in or funnel to encourage the aerial vehicle towards a center of the dock 102. The bottom surface or docking surface 130 of the dock 102 may further include indentations 158 and 160 or cutouts configured to accommodate for various components of the aerial vehicle 106 when docked at the dock 102. For example, as shown in FIG. 11, when the aerial vehicle 106 is retained by the dock 102, rotors, wings, engines, or other sensitive components of the aerial vehicle 106 (or portions thereof) may be covered by the dock 102, e.g., the wings of the dock 102 may extend over the sensitive components to act as a roof or other cover for these portions of the aerial vehicle 106. The indentations 158 and 160 may be sized and shaped to accommodate such components of the aerial vehicle 106 while retaining the aerial vehicle 106 close enough to the dock 102 that the aerial vehicle 106 does not move relative to the dock 102, which could cause damage to the aerial vehicle 106 in case of, for example, high winds. For example, the indentations 158, 160 may be configured to increase a distance between the bottom surface 130 of the dock 102 and select features of the aerial vehicle 106. The indentations 158, 160 may be positioned based on the shape of the aerial vehicle 106, such as to accommodate the shape of the aerial vehicle 106 at a close distance to the dock 102. For example, the indentations 158, 160 may be positioned along or adjacent the perimeter or other portions of the dock 102 to accommodate components of the aerial vehicle 106 when docked. The indentations 158, 160 may be configured to accommodate a specific aerial vehicle 106, such that the dock 102 is tailored to the aerial vehicle 106. In other examples, the indentations 158, 160 may be configured to accommodate aerial vehicles with different configurations (e.g., such that the dock 102 can accommodate a wide variety of aerial vehicles). With reference to FIGS. 7A-7D, the dock 102 may include additional features, such as notches 164a-164d, which accommodate the frame 134 of the dock 102, and openings 166 and 168, which may expose other elements of the dock 102, such as supplemental lighting or the like.

The angled surface 154 or tapered surface may provide passive guidance for an aerial vehicle 106 during the process of docking at the underside of the dock 102. In other words, the angled surface 154 may function as a lead-in or guide surface for the aerial vehicle. The aerial vehicle 106 may include a fin 190 or other upwardly projecting portion configured to engage with the retention assembly 156 of the dock 102. Such a fin 190 may extend upward from the aerial vehicle, which is described in further detail in U.S. Provisional Patent Application No. 63/449,536, filed on Mar. 2, 2023 and titled “Aerial Vehicle and Aerial Vehicle Systems” and U.S. Provisional Patent Application Ser. No. 29/885,957, filed on Mar. 2, 2023 and titled “Aerial Vehicle,” both of which are incorporated by reference herein for all purposes. The fin 190 or other docking portion may, when making contact with any area of the angled surface 154, be guided towards the retention assembly 156 by the angled surface 154. For example, the angled surface 154 may act as an upwardly oriented funnel, guiding the fin 190 of the aerial vehicle 106 toward the retention assembly 156 as the aerial vehicle 106 thrusts upward towards the bottom surface 130 of the dock 102, aligning the thrust of the aerial vehicle 106 with the retention assembly 156. Such passive guidance generally provides for smooth and controlled motion for an aerial vehicle 106 approaching the dock 102.

Further, the angled surface 154 may passively guide and orient the aerial vehicle 106 relative to the dock 102 both when the aerial vehicle 106 is radially distanced from the retention assembly 156 (e.g., not aligned directly under the retention assembly 156 or otherwise misaligned) and when the aerial vehicle 106 does not approach the bottom surface 130 of the dock at an angle perpendicular to the dock 102. Accordingly, the dock 102 and the angled surface 154 corrects for error in the approach of the aerial vehicle 106 to the dock 102, resulting, in some examples, in a fewer number of attempts for the aerial vehicle 106 to successfully land at the dock 102 and in a lower number of failure modes during the docking process. In some embodiments, the angled surface 154 may have an increasingly steep angle of extension as compared to the edge surface 131 of the bottom surface 130 surrounding the angled surface 154.

As shown, for example, in FIG. 7A, the bottom surface 130 includes an opening 162 or locking aperture at the upward most location of the angled surface 154 which, when the dock 102 is assembled, exposes the retention assembly 156, allowing the aerial vehicle 106 to engage with the retention assembly 156. That is, the end of the lead-in or guide surface leads to the locking aperture or opening 162. The angled surface 154 is especially helpful in instances where the aerial vehicle 106 may experience environmental forces (e.g., wind) or navigation issues (e.g., imprecise alignment) as the passive structure compensates for misalignment issues, such as when the fin 190 may not be exactly aligned with the desired docking location. The passive guidance of the angled surface 154 along with the location of the locking aperture 162 helps to assist in ensuring that the vehicle can be locked into a desired position in almost any set of conditions.

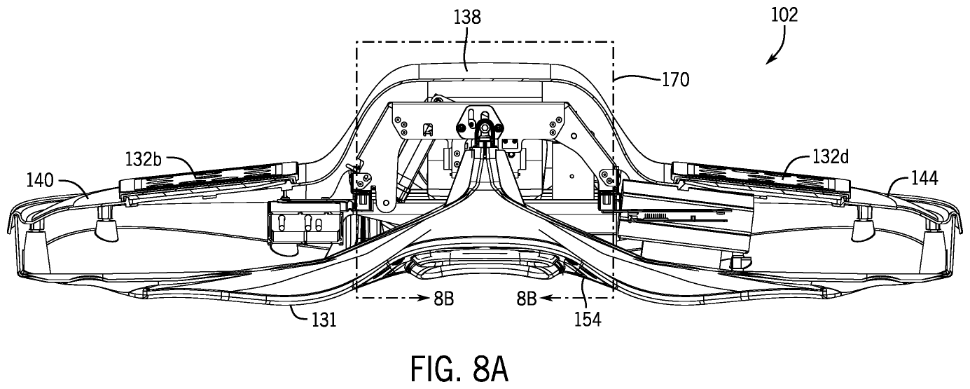

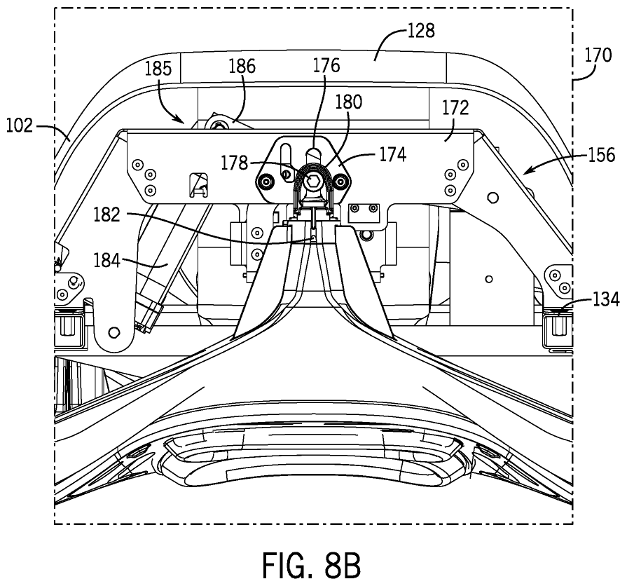

FIG. 8A shows a section view of the dock 102, along the section line 8-8 in FIG. 5. FIG. 8B shows a detailed view 170 of the retention assembly 156 of the dock 102 within the dock 102. As shown in FIG. 8A, the retention assembly 156 may be interior to (e.g., housed or located within the body 126 of) the dock 102, such as being positioned within a housing cavity defined by the outer shells of the dock 102. Accordingly, the retention assembly 156, and mechanical portions of the retention assembly 156, may be less prone to damage from weather, debris, wind, and the like. Further, docking of aerial vehicles may be more secure, as the interior docking process is less likely to be affected by outside forces, such as wind.

The retention assembly 156 may generally include a support 172 coupled to the frame 134 of the dock. The support 172 may generally be located above the opening 162 in the bottom surface 130 of the dock 102 such that the retention assembly 156 is exposed through the opening 162. The support 172 may generally be a single piece of material, bent to form at least a top surface, a front surface, and a rear surface. Alternatively, the support 172 may be formed of multiple components coupled together.

A bracket 174 (e.g., a plate, etc.) including a slot 176 may be fastened or otherwise coupled to the support 172, such as along or on the front face of the support 172. The slot 176 may be aligned with a corresponding opening in the support 172, allowing a pin 178 seated in the slot 176 to move, e.g., upward and downward, relative to the frame. A coupling 180 (e.g., a plate, bracket, etc.) may include an opening to receive the pin 178. The coupling 180 may be secured to a socket 182 of the retention assembly 156. The socket 182 may generally be shaped to receive a top portion of the fin 190 of the aerial vehicle 106 when the aerial vehicle 106 is retained by the dock 102. Though not shown in FIG. 8B, in various examples, a similar bracket may be fastened to the rear surface of the support 172, including a slot in the bracket and corresponding opening in the rear surface of the support 172. Accordingly, the pin 178 may extend through both the front and rear surfaces of the support 172 (e.g., and through both brackets on opposing sides of the support 172). A coupling corresponding to coupling 180 may include an opening to receive a portion of the pin 178 extending past the rear surface of the support 172, and may provide additional support to the socket 182 of the retention assembly 156.

With continued reference to FIG. 8B, the retention assembly 156 may further include a lift assembly 185 which may be in the form of a hydraulic assembly and may include, in some examples, a piston 184 and an arm 186 driven by the piston 184. For example, the arm 186 may be connected to the piston 184 and to the pin 178 such that when the piston 184 is actuated, the arm 186 moves in a first direction (e.g., upward towards the top surface 128 of the dock 102). Movement of the arm 186 in the first direction may move the pin 178 along the slot 176, such as causing the pin 178 and the socket 182 to move upward towards the top surface 128. In various examples, the piston 184 may be actuated responsive to detection of the fin 190 of the aerial vehicle 106. For example, the retention assembly 156 may include positioning sensors (e.g., hall sensors or other types of sensors) configured to detect when the fin 190 of the aerial vehicle 106 enters the retention assembly 156 and/or reaches some other position, such as being properly seated within the socket 182 of the retention assembly 156.

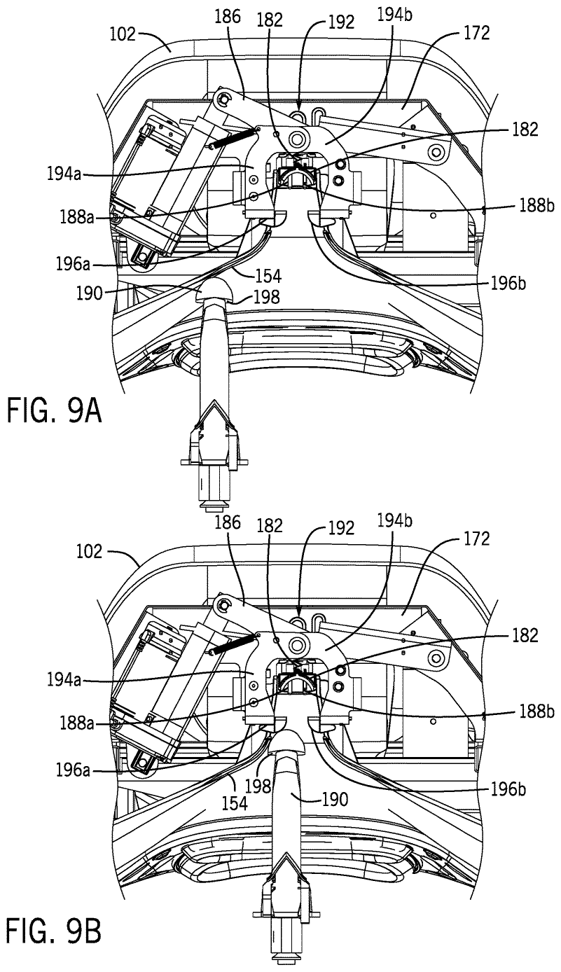

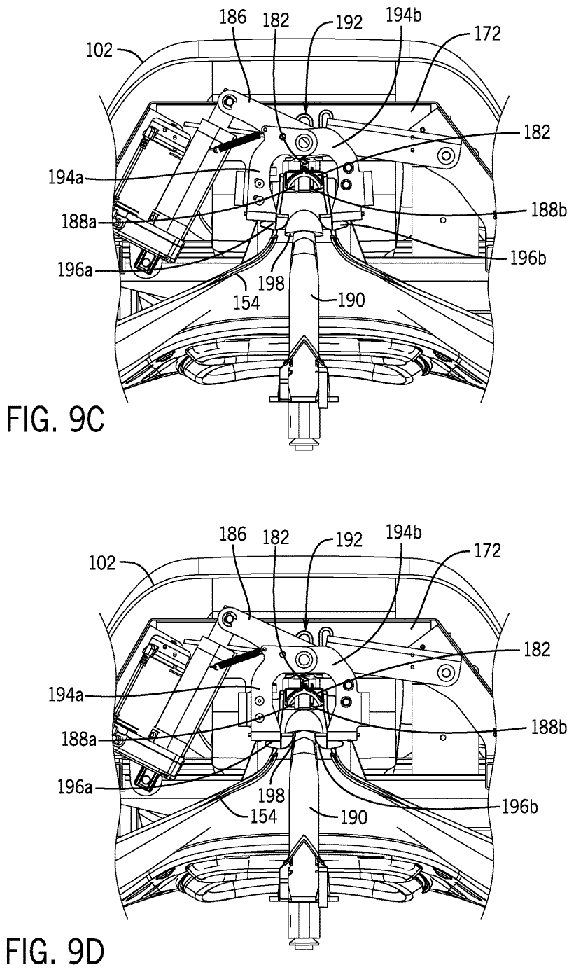

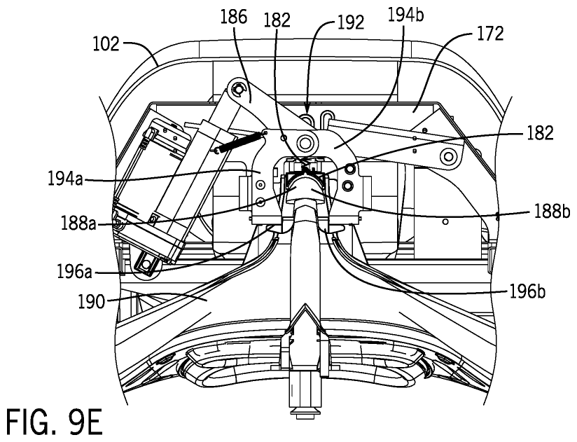

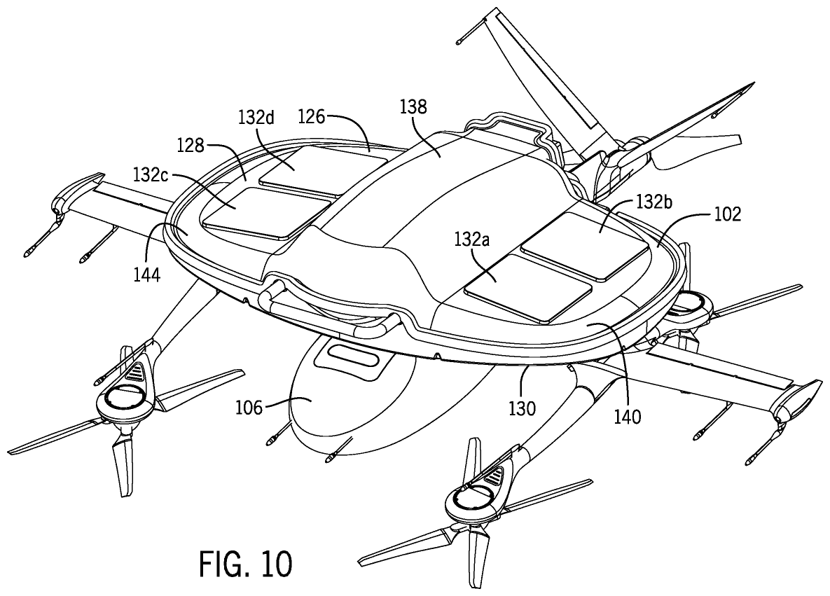

Generally, when the piston 184 is actuated, the fin 190 of the aerial vehicle 106 is pulled upward into the dock 102, e.g., into a retracted position, moving the aerial vehicle 106 into a final docked position with reference to the dock 102. The final docked position is shown, for example, in FIG. 10. As shown in FIG. 9A, the socket 182 of the retention assembly 156 may further include one or more connections (e.g., connections 188a and 188b). Such connections 188a and 188b may be electrical and/or communications connections configured to match with corresponding connection points in the fin 190 of the aerial vehicle 106 when the fin 190 of the aerial vehicle 106 is fully seated in the socket 182 as shown, for example, in FIG. 9E. In this manner, the fin 190 may provide a signal pathway when the aerial vehicle 106 is docked, such as for battery charging, flight log downloads, flight instruction upload, preflight checks, etc.

With reference to FIG. 9A, the retention assembly 156 may include a latch jaw 192 to secure (e.g., releasably secure) the fin 190. In some examples, the latch jaw 192 includes arms 194a and 194b. The arms 194a and 194b may be rotatably connected to the support 172 of the retention assembly 156. In various examples, the arms 194a and 194b may be spring loaded, such that the arms 194a and 194b are biased towards a neutral position (e.g., as shown in FIG. 9A) with respect to the support 172. The arms 194a and 194b may include lower portions 196a and 196b, respectively. The lower portions 196a, 196b may define engagement points for latching with the fin 190. In examples, the lower portions 196a, 196b include curved surfaces that facilitate latching of the fin 190 with the arms 194a, 194b. For example, the fin 190 may engage the curved surfaces to open the latch jaw 192 (e.g., for securement, for release, etc.). More particularly, because of the curved surfaces of the arms 194a and 194b (e.g., lower portions 196a and 196b), the aerial vehicle 106 may approach the latch jaw 192 at an angle or straight on while still actuating the arms 194a and 194b of the latch jaw 192. For example, as shown in FIG. 9A, the fin 190 of the aerial vehicle 106 may be guided towards the latch jaw 192 (e.g., at an angle) by the angled surface 154 (e.g., the fin 190 riding along the angled surface 154 to the latch jaw 192). As shown in FIG. 9B, the fin 190 may contact the curved surface of one arm (e.g., the lower portion 196a of arm 194a) of the latch jaw 192 before coming in contact with the other arm (e.g., arm 194b) of the latch jaw 192. As shown in FIGS. 9C-9E, the curved lower portions 196a and 196b allow the fin 190 to align as it comes into contact with the arms 194a and 194b, such that even when the fin 190 approaches the latch jaw 192 at an angle or offset from the center of the latch jaw 192, the lower portions 196a, 196b helps to align the fin 190 with respect to the latch jaw 192 for docking. The curved surfaces of the lower portions 196a, 196b may cause the latch jaw 192 to open. For example, insertion of the fin 190 within the latch jaw 192 may displace the lower portions 196a, 196b away from each other as the curved surfaces ride against or slide along the fin 190 (see FIG. 9C). Once the fin 190 is fully inserted, the lower portions 196a, 196b may seat against the fin 190 for securement. For example, the fin 190 may include an undercut, slot, groove, or indentation 198 (hereinafter “undercut” for sake of convenience without intent to limit) below a top portion. When the fin 190 is inserted fully in the latch jaw 192, the lower portions 196a, 196b may seat against the undercut 198 to hold the aerial vehicle 106. In examples, the lower portions 196a, 196b may ride against or slide along the top portion of the fin 190 until the lower portions 196a, 196b align with the undercut 198, whereupon the lower portions 196a, 196b move towards each other (e.g., automatically under spring bias) to latch against the fin 190.

The retention assembly 156 may be utilized to facilitate docking of the aerial vehicle 106 and retention of the aerial vehicle 106 by the dock 102. For example, FIG. 22 illustrates an example method 400 of docking the aerial vehicle 106 at the aerial vehicle dock 102. At block 402, the aerial vehicle 106 orients relative to the latch jaw 192 of the dock 102. The aerial vehicle 106 may generally orient relative to the dock 102 such that the fin 190 of the aerial vehicle is below the bottom surface 130 of the dock 102. Generally, the aerial vehicle 106 may be oriented relative to the bottom surface 130 such that the fin 190 is under or otherwise comes in contact with the angled surface 154 of the bottom surface 130. As the fin 190 engages the angled surface 154 while continuing to thrust upwards towards the bottom surface 130 of the dock 102, the shape of the angled surface 154 passively guides the fin 190 towards the retention assembly 156 as the aerial vehicle 106 moves upward relative to the dock 102. As shown in FIG. 9A, the fin 190 may initially come into contact with the curved portions 196a and/or 196b of the arms 194a and/or 194b of the latch jaw 192 when navigating toward the retention assembly 156.

With reference to FIG. 22, the aerial vehicle 106 navigates upward such that the fin 190 of the aerial vehicle 106 displaces the arms 194a and 194b of the latch jaw 192 at block 404, e.g., due to the force of the upward thrust as the aerial vehicle 106 is actuated and/or the force of the passive guidance. In various examples, the fin 190 may displace one of the arms 194a or 194b before displacing the other arm of the latch jaw 190. As shown in FIG. 9C, the fin 190 may displace the arm 194a while the arm 194b is still biased in the neutral orientation. As the aerial vehicle 106 continues to thrust upward, the fin 190 overcomes the biasing force and displaces both arms 194a and 194b to be engaged by the latch jaw 192. For example, as the aerial vehicle 106 continues to move upward relative to the dock 102, the upward force placed by the fin 190 on the arms 194a and 194b of the latch jaw 192 overcome the bias force keeping the arms 194a and 194b in a closed position, rotating the arms 194a and 194b to allow the fin 190 to move into the dock 102 towards the socket 182 of the retention assembly 156.

With reference to FIG. 22, at block 406, the fin 190 of the aerial vehicle 106 is secured with the latch jaw 192. For example, as shown in FIG. 9D, after a top portion of the fin 190 has moved past the arms 194a and 194b of the latch jaw 194, the spring force on the arms 194a and 194b may cause the arms 194a and 194b to move back to their neutral position, or close to their neutral position, securing the fin 190 in the lock jaw 192. In various examples, the aerial vehicle 106 may reach the position shown in FIG.

9D when the dock 102 does not have power. For example, the bias of the lock jaw 192 to hold or otherwise secure the fin 190 in the retention assembly 156 may be based solely on mechanical forces (e.g., spring forces), such that the aerial vehicle 106 may dock even in case of a power outage or other anomaly affecting the dock 102. For example, the action of the lock jaw 192 to both receive and engage the fin 190 (e.g., as described with reference to FIGS. 9A-9E) may occur without power to the dock 102 or the dock 102 malfunctioning in other ways. As a result, the lock jaw 192 may provide a passive or automatic securement of the fin 190 when inserted or seated into position. The position shown in FIG. 9D may further securely hold the aerial vehicle 106 in the dock 102. For example, the lock jaw 192 may retain the fin 190 of the aerial vehicle 106 (e.g., via engagement of the lower portions 196a, 196b with the undercut 198) without any additional electrical input or electrically actuated parts, e.g., even if the dock 102 loses a power connection, the dock 102 may still be configured to retain and secure aerial vehicle 102, which is not possible with conventional docking structures.

With reference to FIG. 22, the aerial vehicle 106 is moved to a retracted state at block 408. The retracted state is shown, for example, in FIG. 9E. The fin 190 is in connection with connections 188a and 188b in the dock 102 when in the retracted state. In various examples, the piston 184 of the retention assembly 156 may be activated to cause the aerial vehicle 106 to move into the retracted state. For example, the piston 184 may be actuated based on detection of the fin 190 of the aerial vehicle 106 moving into the lock jaw 192. Such detection may be accomplished, in some examples, using hall sensors placed near the arms 194a and 194b of the lock jaw 192, which may detect when, for example, the fin 190 of the aerial vehicle 106 pushes past the arms 194a and 194b. When the piston 184 is actuated, the arm 186 and the arms 194a and 194b move upward, moving the pin 178 upward in the slot 176. When the pin 178 moves upward, the coupling 180 and, in turn, the socket 182 and the lock jaw 192 of the retention assembly 156 move upward to move the aerial vehicle 106 into the retracted position.

The retention assembly 156 may generally operate in reverse to release an aerial vehicle 106 from the dock 102. For example, when ready to be released from the dock 102, the aerial vehicle 106 may communicate with the dock 102 (e.g., wirelessly or through connections 188a and/or 188b), actuating the piston 184 to release the fin 190 of the aerial vehicle 106 from the retracted position, and disconnecting the fin 190 of the aerial vehicle 106 from the connections 188a and 188b. For example, the piston 184 may be actuated to move in an opposite second direction (e.g., downward away from the top surface 128), moving the pin 178 downward in the slot 176. When the pin 178 moves downward, the coupling 180 and, in turn, the socket 182 and the lock jaw 192 move downward to move the aerial vehicle 106 to a releasing position (e.g., a position spaced further away from the dock 102). The aerial vehicle 106 may then be in the position shown in FIG. 9D, with the fin 190 of the aerial vehicle 106 being retained by the arms 194a and 194b of the lock jaw 192. As the aerial vehicle 106 initiates downward motion (e.g., via a downward thrust of the aerial vehicle 106), the fin 190 of the aerial vehicle 106 may overcome the bias force of the lock jaw 192, displacing the arms 194a and 194b to disengage the fin 190 from the lock jaw 192. For example, downward thrust of the aerial vehicle 106 may cause the fin 190 to displace the lower portions 196a, 196b away from each other (e.g., against spring bias), releasing the lower portions 196a, 196b from the undercut 198. Once the arms 194a, 194b disengage the fin 190, the fin 190 may be removed from the retention assembly 156, releasing the aerial vehicle 106 from the dock 102.

The dock 102 may, in various examples, include various components providing location and/or identification information about the dock 102 to aerial vehicles 106 navigating towards the dock 102. Such components may include static and/or dynamic fiducials, audio emitters, GPS emitters, and the like. In some examples, aerial vehicles may obtain information about the location of docks from other sources. For example, a centralized database or flight control system may provide aerial vehicles with GPS coordinates of various docks.

With reference to FIG. 2, fiducials 132a-132d may be provided on or protruding past the top surface 128 of the dock 102. The fiducials 132a-132d may be panels each including a plurality of light emitting diodes (LEDs). While four fiducials are shown integrated into the dock 102, other numbers of fiducials, such as one, two, three, or more fiducials, may be utilized in various examples. In some examples, such LED panels may provide information in several ways. For example, the panels may emit light in different colors, may turn on various combinations of LEDs in the panels, and/or may blink various LEDs at various frequencies. Such frequencies may generally be selected for compatibility with cameras used by aerial vehicles detecting the dock 102. For example, the frequency may be less than the frame rate of the camera. Additionally, output strength of the LEDs may be adjustable. For example, each LED may be adjusted to output at various intensities between 0% and 100% of full power.

In some examples, the fiducials 132a-132d may convey different parameters or information at different distances from the dock 102. For example, an aerial vehicle farther away from the dock 102 may be able to discern flashing patterns but may not be able to discern individual colors or patterns of LEDs (or other types of light sources) illuminated on any given panel. Such flashing patterns may, at a distance, allow an aerial vehicle to infer a rough location of the dock 102 based on how the flashing LEDs move in the frame of sensors of the aerial vehicle, such as cameras. As the aerial vehicle gets closer to the dock 102, the aerial vehicle may be able to observe colors or patterns of LEDs illuminated in any given panel. In some examples, such illumination may provide information regarding the orientation of the dock 102 to the aerial vehicle. For example, the fiducials 132a-132d may provide information used to determine the aerial vehicle's roll, pitch, or yaw offset from the dock 102. As GPS or other satellite based location systems generally does not provide orientation, such orientation information may be useful in addition to GPS location for the aerial vehicle to locate and orient relative to the dock 102.

In various examples, each individual panel of the fiducials 132a-132d may provide a different channel of information to the aerial vehicle. In some examples, each panel may be treated as a binary color shift keying and/or may use convolutional encoding and the like. In some examples, a bit sequence may be spread across all four panels to provide redundancy. For example, should one panel malfunction, the other three panels may still collectively convey and decode the entire message. The fiducials 132a-132d may further, in various examples, include passive features to convey information even where the LEDs are not functional. For example, the panels may each include a certain number of filled in circles, which pattern may be visible by an aerial vehicle approaching the dock 102, even without active LED illumination.

The lighted fiducials 132a-132d may be used to convey additional information in some examples. For example, the fiducials 132a-132d may be used to convey whether the dock 102 is free for docking or occupied by an aerial vehicle, whether the dock 102 has power or is in a standby power state, whether the dock 102 is connected to a network, and the like. In some examples, aerial vehicles may select a dock from a plurality of docks based on such information. For example, an aerial vehicle may be assigned to a group of docks instead of an individual dock. The aerial vehicle may select a dock of the group of docks based on which docks are free for docking.

In some examples, the dock 102 may include acoustic or radio frequency features (e.g., non-visual active features) to provide location and/or identification information about the dock 102 to aerial vehicles, such as aerial vehicle 106. For example, the dock 102 may include emitters located at known locations with respect to the overall geometry of the dock. Such emitters may emit a signal, such as an ultra-wide band radio signal or sound wave, which may be detected by receivers located on various aerial vehicles, which may be, for example be radios or microphones. In various examples, the emitters may emit signals at or around 22 kHz, which may be less likely to be heard by humans.

The signals emitted by various emitters on the dock may be modulated to allow each emitter to convey different information. Further, in locations with multiple docks, emitters on the different docks may be modulated to distinguish the docks from one another, e.g., by preventing correlation of the signals and/or interference between the signals being emitted by the different docks. For example, Gold codes may be used to modulate the signals such that each emitter on each dock has a different code and. accordingly, emits a different signal. The different signals may be distinguished by the aerial vehicles to locate a desired dock and to orient relative to the dock. In some examples, the aerial vehicles may further perform some calculations and/or otherwise account for conditions that may impact how acoustic sensors detect the signals from such emitters. For example, the aerial vehicles may account and/or compensate for air temperature, wind speed, and/or other factors which may affect the speed of sound. In various examples, four emitters may be placed on each dock, to provide location information in each dimension, as well as a shared source of time synchronization.

In some examples, additional acoustic fiducials may be provided at or near the bottom surface 130 or docking surface of the dock 102 to assist the vehicle 106 in orienting relative to the bottom surface 130. In some examples, such fiducials may be provided by additional emitters or passive fiducials located on the bottom surface 130 of the dock 102. In other examples, the vehicle 106 may track its location relative to the bottom surface 130 of the dock 102 by tracking a phase of signals emitted by the acoustic emitters. For example, a 180 degree phase flip could indicate a side of the dock 102 opposite from the acoustic emitters.

The dock 102 may include static fiducials, which may further assist the aerial vehicle 106 to orient relative to the dock 102. Such static fiducials may be detected using visual sensors (e.g., cameras) of the aerial vehicle 106. The static fiducials may, for example, be located on the bottom surface 130 of the dock 102 to assist the aerial vehicle 106 in aligning the fin 190 relative to the angled surface 154 of the dock 102. In some examples, static fiducials may be located on or attached to the vertical tower 112. In some examples, such fiducials may be lighted (using light in the visible and/or IR spectrum) such that the aerial vehicle 106 is able to locate the fiducials even in dark conditions. The static fiducials may further be located such that the fiducial are lighted by lighting elements of the aerial vehicle 106 when the aerial vehicle 106 moves towards the dock 102, such as wingtip lights of the aerial vehicle 106. Fiducials can be located on surfaces of the dock 102, e.g., attached to the top surface 128 (e.g., wings 140, 144 or center portion 138), bottom surface 130 (e.g., adjacent to or around the angled surface 154), perimeter edge, or the like. In some embodiments, the dock 102 may also include movable or couplable fiducials, such as those that can be coupled to the edge or other area of the dock 102 and be selectively repositioned or moved. As one example, a fiducial may be hung on the gutter 150 to drop down and be visible to the aerial vehicle 106 while it is aligning on the bottom surface 130 of the dock 102.

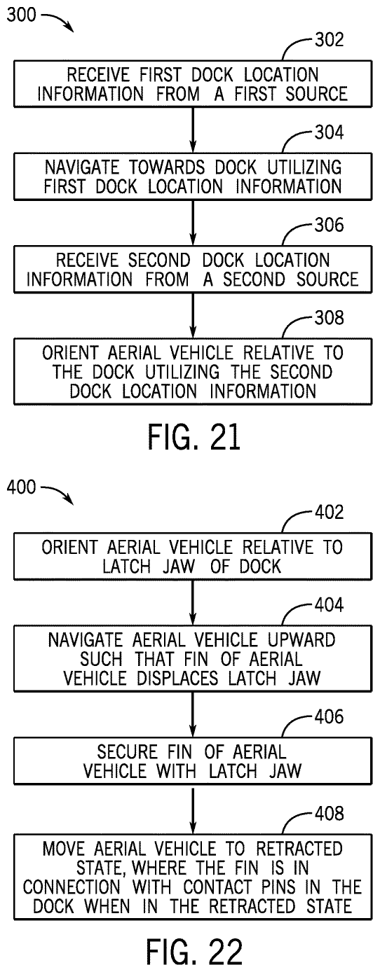

FIG. 21 illustrates an example method 300 of docking an aerial vehicle 106 at the aerial vehicle dock 102. At block 302, the aerial vehicle 106 receives first dock location information from a first source. The first dock location information may generally provide the aerial vehicle 106 with an initial location of the dock. For example, the first dock location information may be GPS coordinates of the dock or a group of docks for the aerial vehicle 106 to navigate towards. Such coordinates may, in some examples, be provided using wireless communication capabilities of the dock 102. In some examples, such GPS coordinates (or other satellite generated location information) may be provided to the aerial vehicle 106 by a centralized database, flight control system, or the like.

In some examples, the first dock location information may be provided by other emitters on or incorporated into the dock 102. For example, first dock location information may be provided by fiducials 132a-132d, by lighting one or more LEDs on the fiducials 132a-132d to provide information allowing the aerial vehicle 106 to identify the dock 102. For example, at a further distance, the LEDs on the fiducials 132a-132d may flash at a particular frequency identifying the dock 102. At closer range, LEDs of the fiducials 132a-132d may be lit in a particular pattern and/or in a particular color to identify the dock 102 and/or the orientation of the dock 102. In some examples, the first dock location information may be provided by audio emitters. For example, audio signals emitted by emitters located at the dock 102 may identify the dock 102 and/or orientation of the dock 102 with respect to the aerial vehicle 106.

In various examples, the type of fiducial used may be dependent on the environment of the dock 102, or other factors. For example, visual fiducials (e.g., LED fiducials) may be more useful in some circumstances, but may be limited in higher density areas to avoid light pollution and the like. Acoustic fiducials may be more difficult to implement, but may be used in such high density areas, as the acoustic signals utilized by the fiducials may be inaudible to humans.

The aerial vehicle 106 navigates towards the dock 102 utilizing the first dock location information at block 304. In some examples, such navigation may include the aerial vehicle 106 moving towards a general location of the dock 102 or a group of docks before identifying the particular dock 102 or obtaining a more precise location of the dock 102. For example, the aerial vehicle 106 may be provided with GPS coordinates (or other satellite navigation coordinates) of the dock 102, which may have a margin of error of 10 m or more. Accordingly, when provided with GPS coordinates, the aerial vehicle 106 may utilize a GPS receiver to compare the GPS coordinates of the aerial vehicle 106 to the GPS coordinates of the dock 102 to move towards the dock 102. Similarly, at a distance, the fiducials 132a-132d may guide the aerial vehicle 106 towards the dock 102. For example, the aerial vehicle 106 may perceive, through visual sensors such as one or more cameras, flashing LEDs of the fiducials 132a-132d. At a distance, the fiducials 132a-132d may appear as a single source of flashing light. The aerial vehicle 106 may navigate towards the flashing lights provided by the fiducials 132a-132d by tracking where, within a frame of visual sensors of the aerial vehicle 106 the flashing light appears as the aerial vehicle 106 moves towards the dock 102.

In some examples, the first dock location information may provide information to the aerial vehicle 106 to locate the particular dock 102 from a group of docks and/or for the aerial vehicle 106 to navigate to a more precise location of the dock 102. For example, the first dock location information may be provided by audio emitters on the dock, emitting one or more unique signals which enable the aerial vehicle 106 to identify the dock 102. The aerial vehicle 106 may generally use audio receivers or sensors to perceive such signals. In another example, the first dock location information may be provided by the fiducials 132a-132d when the aerial vehicle 106 is at a closer range to the dock 102, such as when the aerial vehicle 106 has navigated to a particular group of docks including the dock 102 or within a particular range of the dock 102. For example, the fiducials 132a-132d may illuminate certain LEDs on the panels in a pattern associated with the dock 102 and/or may illuminate the LEDs in a color associated with the dock 102. In such examples, the aerial vehicle 106 may move towards the dock 102 based on such information provided by the audio emitters and/or the fiducials 132a-132d.

At block 306, the aerial vehicle 106 receives second dock location information. In some examples, the second dock location information may be provided by a second source. For example, the first dock location information may be GPS coordinates provided to the aerial vehicle 106 by a centralized database or flight control system and the second dock location information may be provided by fiducials 132a-132d and/or audio emitters at the dock 102. In other examples, first dock location information may be provided by fiducials 132a-132d and/or audio emitters, while second dock location information may be provided by static visual fiducials on the bottom surface 130 of the dock 102.

In other examples, the second dock location information may be provided by the same source as the first dock location information. For example, first dock location information and second dock location information may both be provided by the fiducials 132a-132d. In such examples, the first dock location information may be provided by a first modality of the fiducials 132a-132d (e.g., by a blinking frequency of the fiducials 132a-132d), while the second dock location information may be provided by a second modality of the fiducials 132a-132d (e.g., by a pattern of LEDs illuminated at the fiducials 132a-132d).

The aerial vehicle 106 orients relative to the dock 102 utilizing the second dock location information at block 308. For example, the second dock location information may generally provide some information on orientation of the dock 102, allowing the aerial vehicle 106 to maneuver relative to the dock 102 in a position allowing docking. In some examples, the second dock location information may be provided by the fiducials 132a-132d, where the individual panels convey such orientation information to the aerial vehicle 106. Similarly, separate audio emitters on the dock 102 may emit at different unique frequencies, providing orientation information to the aerial vehicle 106. In some examples, the second dock location information may be provided by static fiducials located on the bottom surface 130 of the dock 102, and the aerial vehicle 106 may orient relative to the underside of the dock (e.g., aligning the fin 190 with the angled surface 154 of the underside of the dock 102) based on the expected alignment of the static fiducials.

In some examples, the aerial vehicle 106 may further receive third dock location information to complete docking and/or to further orient the aerial vehicle 106 relative to the dock 102. For example, where the first dock location information is GPS coordinates of the dock 102 and the second dock location information is orientation information provided by the fiducials 132a-132d and/or audio emitters, the aerial vehicle 106 may receive third dock location information from, for example, static fiducials located on the bottom surface 130 of the dock 102 to align relative to the bottom surface 130 of the dock 102. The aerial vehicle 106 may, similarly, utilize other sources of information, such as existing audio emitters, to identify and orient relative to the bottom surface 130 of the dock 102. For example, the aerial vehicle 106 may move relative to the dock 102 until audio signals emitted by the audio emitters are perceived by the aerial vehicle 106 at a given phase difference indicating that the aerial vehicle 106 is at the underside of the dock 102.

In some examples, the aerial vehicle 106 may align with the bottom surface 130 of the dock 102 using dead reckoning, or a similar procedure. For example, environmental information and/or information gathered by sensors of the aerial vehicle 106 (e.g., inertial measurement units of the aerial vehicle 106) may be utilized to orient the aerial vehicle 106 with respect to the dock 102.

Though the method 300 is described where the aerial vehicle 106 receives an assignment of a particular dock 102, the method 400 may be similarly utilized by an aerial vehicle 106 utilizing information emitted from and/or provided by a group of docks to select a particular dock for docking. For example, fiducials 132a-132d may be utilized to signal when a dock at a particular location is available for docking, and an aerial vehicle 106 may select an available dock from a grouping of docks based on such information. Similarly, although the above examples are described with respect to GPS, other types of location positioning information (e.g., other satellite based systems) can be used to provide the location coordinates that are used in addition to the fiducial or environmental information on the dock.

Generally, once an aerial vehicle 106 is aligned with a particular dock 102 utilizing the method 300, the aerial vehicle 106 may proceed to mechanically dock with the dock 102. For example, the method 400 described in FIG. 22 may be utilized to complete the docking procedure for a particular aerial vehicle 106.

In various examples, the dock 102 may include additional features for protecting the dock 102 and/or an aerial vehicle 106 retained by the dock 102 from environmental conditions. As described herein, the top surface 128 of the dock 102 may include a gutter 150 including notches 152a and 152b to allow water to flow off of the dock 102 in specific locations, protecting the aerial vehicle 106 retained by the dock 102. In some examples, the placement of the notches 152a and 152b may allow icicles to form in particular locations where, when the icicles break off from the dock 102, damage to the aerial vehicle 106 from the icicles is unlikely. For example, as shown in FIG. 11, the notches 152a and 152b may be located to direct flow of water away from sensitive areas of the aerial vehicle 106, such as the rotors, wings, and the like.

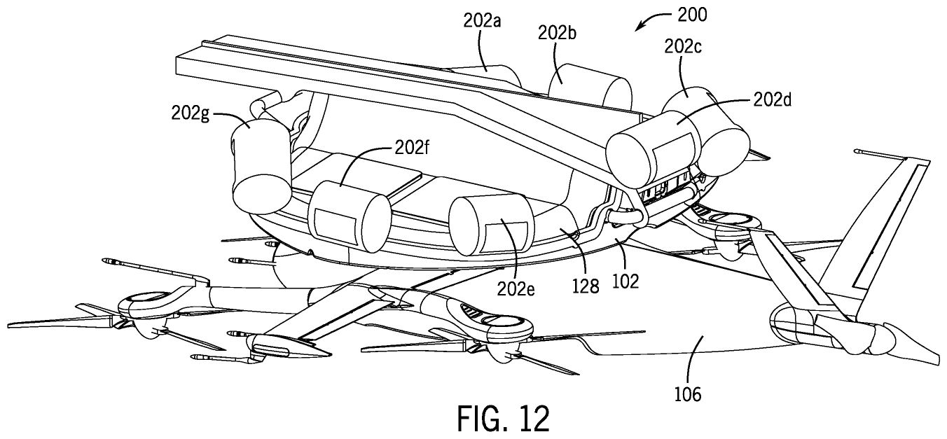

With reference to FIG. 12, in various examples, the dock 102 may further include a heating or thermal system 200 to prevent and/or mitigate build-up of ice and snow on the dock 102. Such a heating system 200 may further facilitate expected functionality of various electrical components of the dock 102 by helping to maintain a particular operating temperature range for the electrical components. Mitigation of build-up of ice and snow may further preserve the ability of aerial vehicles 106 to dock to the dock 102. For example, ice and snow build up may prevent an aerial vehicle 106 from clearly perceiving light patterns from the fiducials 132a-132d and/or may muffle signals produced by audio emitters. In various examples, the heating system 200 may further provide heat to the aerial vehicle 106 when docked, preventing build-up of ice and snow on the aerial vehicle 106, where such build-up may prevent the aerial vehicle 106 from properly functioning. For example, snow and ice build-up may increase weight of the aerial vehicle 106, affecting the aerodynamics of the aerial vehicle 106 in flight.

The heating system 200 shown in FIG. 12 includes heating elements 202a-202g, generally distributed around a perimeter of the dock 102 or distributed to heat selected areas, such as along the area of the top 128 or bottom 130 surfaces. The heating elements 202a-202g may provide radiant heat, mitigating snow and ice build-up on the dock 102 and/or the aerial vehicle 106 retained by the dock 102. The heating elements 202a-202g may be placed on the dock 102 such that the heating elements 202a-202g do not interfere with docking functionality of the dock 102. For example, the heating elements 202a-202g are generally placed such that the fiducials 132a-132d are still visible from above the dock 102. Similarly, the heating elements 202a-202g may be placed such that the heating elements 202a-202g do not obstruct the aerial vehicle 106 from aligning with the angled surface 154 of the bottom surface 130 of the dock 102. In some examples, the heating elements 202a-202g may be removable, such that the heating elements 202a-202g may be placed on the dock 102 in case of inclement weather, and may be removed from the dock 102 when not needed.

In various examples, other types of heating systems may be used to mitigate build-up of snow and ice on the dock 102. For example, radiant heating elements may be embedded in the top surface 128 of the dock 102. In other examples, blowers may be provided on the top surface 128 of the dock 102, which may both heat fiducials 132a-132d (e.g., to mitigate build-up of snow and ice), while also mitigating build-up of other debris on the fiducials 132a-132d. In some examples, the dock 102 may further include cooling elements, which may help to maintain operating temperature ranges of electronics in the dock 102 in high environmental temperatures.

With reference to FIG. 13, the dock 102 may be placed near a building (e.g., a retail location, warehouse, medical facility, or the like) using a support assembly 110 installed on or near the building. The support assembly 110 may generally include a vertical tower 112 and an arm 114. In some examples, such as shown in FIG. 1, the support assembly 110 may include multiple arms 114 and 116 placed along the height of the vertical tower 112, such that multiple docks 102, 104 may be supported by the same support structure 110. In locations, such as warehouses, receiving and/or dispatching high volumes of deliveries using aerial vehicles, such support structures 110 may allow multiple deliveries and/or loading of multiple aerial vehicles at one time. The location of the support structure 110 close to a building may further save space around the building, while allowing for delivery of payload to and/or loading of aerial vehicles, from an interior of the building. In various examples, different numbers of support structures 110 may be placed around a building, depending on the needs of various shippers.

The support structure 110 may further provide support to both charging docks and loading docks. With continued reference to FIG. 1, dock 102 may be a charging dock, while dock 104 may be configured as a loading dock (e.g., with the loading assembly 118 placed below the dock). In various examples, aerial vehicles may recharge at charging docks and, when fully charged, may proceed to a loading dock to be provided with payload for a delivery. Similarly, an incoming aerial vehicle may proceed to a loading dock to unload payload, and may then move to a charging dock to re-charge battery for the next delivery. In some examples, a shipper location may include multiple support structures 110, with some support structures including both loading docks and charging docks and other support structures including two or more charging docks, one loading dock, or other configurations based on the requirements of the shipper. Such customization may further enable scalability of delivery by aerial vehicle for individual shippers.

In addition to providing structural support for the dock 102, the support structure 110 may provide various electrical connections and/or communications connections for the dock 102. For example, as shown in FIG. 14B, the tower 112 may be hollow or include routing passages to accommodate wiring and/or cables 216 providing electrical power, network connections, heating elements, and the like to the dock 102 which may, in turn, provide such connections to the aerial vehicle docked at the dock 102. Such wiring and/or cables 216 may be powered by an electrical panel 218 located, for example on the adjacent building 206 and, accordingly, may utilize power and/or communications connections of the adjacent building 206. In some examples, the support structure 110 may further provide support for cameras providing a view of the underside of the aerial vehicle 106. Such cameras may be utilized for preflight checks, such as ensuring that any payload doors or other features are in the correct position before disengaging the aerial vehicle 106 from the dock 102.

With reference to FIG. 14A, the vertical tower 112 of the support structure 110 may be supported by an in-ground foundation 204, such as a concrete foundation. The foundation 204 may be engineered to accommodate the weight of the support structure 110, docks 102 and/or 104 supported by the support structure 110, and/or aerial vehicles which may dock at the docks 102 and/or 104. The vertical tower 112 may generally be bolted or otherwise secured to the foundation 204. In some examples, instead of being secured to the in-ground foundation 204, the support structure 110 may be secured to an adjacent building 206, e.g., extend vertically parallel to a building or wall. In some examples, the support structure 110 may be secured to a base plate or other component installed on the ground or other structure, such as the roof of the adjacent building 206. In some examples, the support structure 110 may utilize existing building foundations and/or may be supported by ballast (e.g., water, sand, stone or the like) structures on the support structure 110.

Generally, the vertical tower 112 of the support structure 110 may include a lower portion 208 and an upper portion 210 adjoined by a hinge 212. Accordingly, the upper portion 208 may be movable with respect to the lower portion about the hinge 212. For example, the upper portion 208 may pivot about the hinge 212 towards the ground, such that arms 114 and/or 116 may be easily accessible from the ground. In various examples, the upper portion 208 may pivot about the hinge 212 using hydraulics, a motor, or other methods which allow one person to actuate the support structure 110. A motor or other structure may be removable, such that a technician or other personnel may utilize the motor when servicing the support structure 110 and the motor may be removed when not being utilized to service the support structure 110. Accordingly, the docks 102 and 104 may be easily placed on or removed from the arms 114 and 116 to allow for maintenance, swapping out, and/or other replacement of the docks 102 and/or 104 from the ground. Further, the hinging of the vertical tower 112 may facilitate maintenance and/or placement of other components on the support structure 110, such as in-operational aerial vehicles, fiducials, heaters, cameras, and the like.

In some examples, the vertical tower 112 may further include separate docking fiducials 214a and 214b, which may be detected by aerial vehicles docking at docks 102 and 104, respectively. Such docking fiducials 214a and 214b may be, in various examples, static fiducials, fiducials including LED panels (e.g., similar to fiducials 132a-132d), audio emitters, and the like. Such fiducials may provide additional information to aerial vehicles docking at the docks 102 and 104 and may assist the aerial vehicles in locating and/or maneuvering or orienting with respect to the docks 102 and 104. In some examples, the docking fiducials 214a and 214b may also be configured to provide information to aerial vehicles signaling whether a dock is currently installed on a specific support arm of the support structure 110. For example, the fiducials may include LEDs which emit in a first color when a dock is installed on the support arm and emit in a second color when no dock is installed on the support arm.

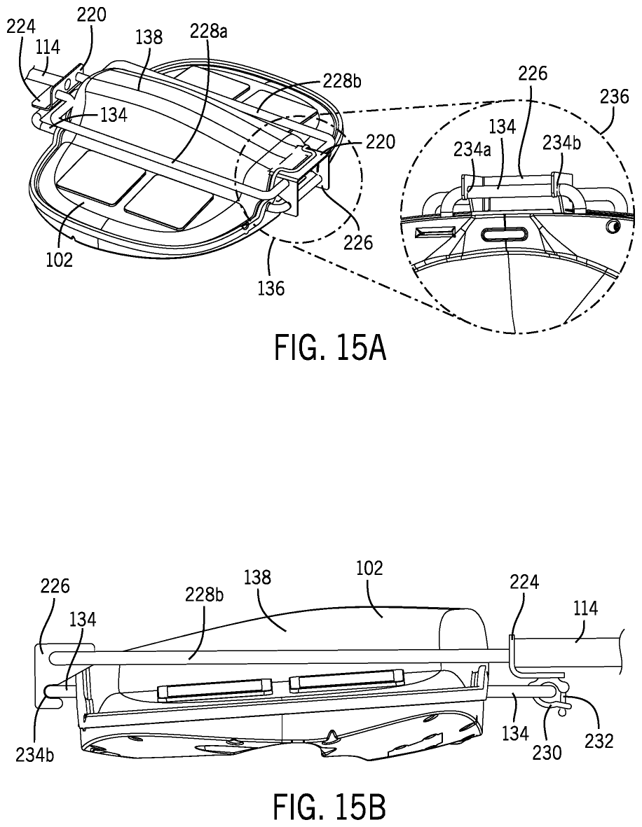

With continued reference to FIG. 14A and with reference to FIG. 15A, the support arms 114 and 116 may include dock mount mechanisms 220 and 222, respectively, which provide connections for securing aerial vehicles to the support structure 110. For example, such dock mount mechanisms 220 and 222 may be configured to engage with and/or retain a frame 134 of the dock 102 (e.g., as shown in FIG. 15A). With reference to FIGS. 15A and 15B, the dock mount mechanism 220 may generally include a bracket 224 configured to engage with a first side of the frame 134, a bracket 226 configured to engage with and secure a second side of the frame 134, and support members 228a and 228b connecting the brackets 224 and 226.

With reference to FIG. 15B, the bracket 224 may be coupled to a distal end of the support arm 114. The bracket 224 may include a clip 230 configured to receive the frame 134. The clip 230 may be secured using a fastener 232 which, when tightened, may secure the frame 134 in the clip 230. The bracket 224 may be further affixed to support members 228a and 228b. With reference to FIG. 15A, the support members 228a and 228b may be spaced such that when the dock 102 is secured to the dock mount mechanism 220, the support members 228a and 228b extend on either side of the center portion 138 of the dock 102, without blocking any light which may be emitted by fiducials 132a-132d. The support members 228a and 228b may be affixed at a second end to the bracket 226. The bracket 226 may be configured to receive a second end of the frame 134 of the dock 102. For example, as shown in detailed view 236 in FIG. 15A, the bracket 226 may include notches 234a and 234b sized to receive the frame 134 and shaped such that the frame 134 securely rests in the bracket 226 when installed in the dock mount mechanism. In various examples, the bracket 224 and/or bracket 226 may include additional features, such as locating features to tightly control lateral position of the dock 102 relative to the support arm 114. For example, the support members 228a, 228b may extend around the center portion 138 of the dock 102, such as parallel to the center portion 138. In some examples, the support members 228a, 228b may abut opposing sides of the center portion 138, such as to define the lateral position of the dock 102.

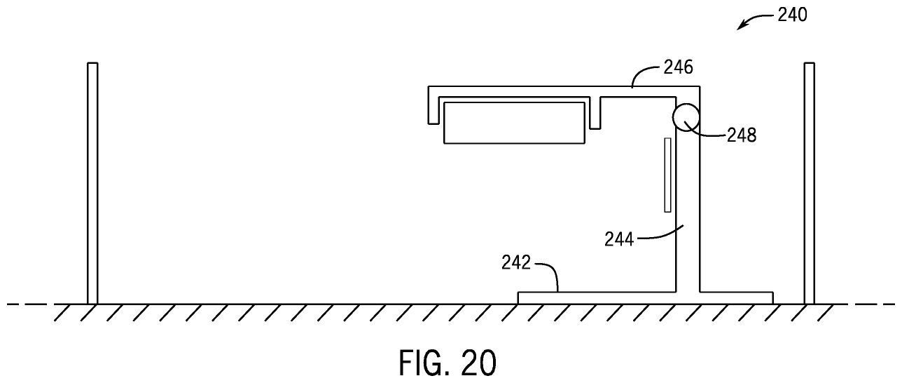

With reference to FIG. 20 in various examples, a support structure 240 may be installed directly on the ground, separate from an adjacent building and/or on the roof of a building or other raised surface. For example, the support structure 240 includes a base plate 242 which may be attached (e.g., riveted or bolted) to the ground and/or the roof of a building. The support structure 240 may also, in some examples, be supported by ballast structures. The support structure 240 may further be configured to hold only one dock and accordingly, the support structure may include a tower 244 and a support arm 246, with a hinge 248 connecting the tower 244 and the support arm 246 directly. In various examples, the support structure 240 may be used in areas with more available land space and/or roof space on buildings, and multiple support structures 240 may be provided in such an area.

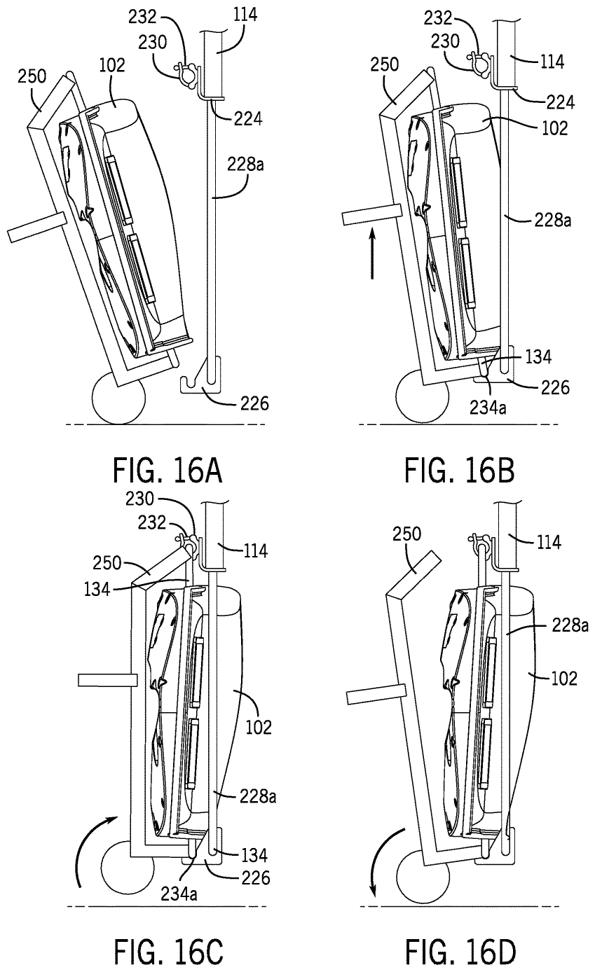

With reference to FIGS. 16A-16D, the dock 102 may be installed on and/or removed from the support structure 110 from the ground. Accordingly, docks may be easily switched out in case of malfunction, maintenance, and the like. In various examples, the dock 102 may be installed and/or removed from the support structure 110 by one person utilizing a motor, hydraulics, or the like to actuate motion of the support structure 110. For example, the support arm 114 may be in the position shown in FIGS. 16A-16D when the hinge 212 is used to rotate the upper portion 210 of the tower 112 towards the ground relative to the lower portion 208 of the tower 112. As shown in FIG. 16A, a cart or dolly 250 may be utilized to move the dock 102 into place relative to the support arm 114. For example, as shown in FIG. 16A, the dock 102 may be moved adjacent to the support arm 114. The cart 150 may then be tilted or lifted as shown in FIG. 16B such that a first end of the frame 134 is placed in the notches 234a and 234b of the bracket 226.

As shown in FIG. 16C, the cart 250 may then be tilted upward, moving the dock 102 to a vertical position and placing the second end of the frame 134 into the clip 230 of the dock mount mechanism 220. When the frame 134 is placed in the clip 230, the fastener 232 may be tightened to retain the frame 134 in the clip 230. In some examples, the clip 230 may not include the fastener 232 and may utilize alternate structures to retain the frame 134 in the clip 230. Such structures may be tightened, actuated, or otherwise secured to the frame 134 in a similar manner. As shown in FIG. 16D, once the dock 102 is secure in the dock mount mechanism 220, the cart 250 may be removed. The upper portion 210 of the tower 112 may then be rotated about the hinge 212 relative to the lower portion 208 until the support arm 114 and/or the dock 102 is substantially parallel to the ground, as shown in FIG. 13.

The dock 102 may be removed from the support structure 110 in a similar manner. For example, the positions shown in FIGS. 16A-16D may be reversed. For example, a cart 250 may be moved next to the support arm 114 to receive the dock 102 when removed from the support structure 110. The frame 134 of the dock 102 may be released from the clip 230 by loosening the fastener 232. The dock 102 may then be lifted off of the support arm 114 and onto the cart 250 by lifting the frame 130 out of the bracket 226. Accordingly, docks may be placed on the support structure 110 and removed from the support structure 110 from the ground.

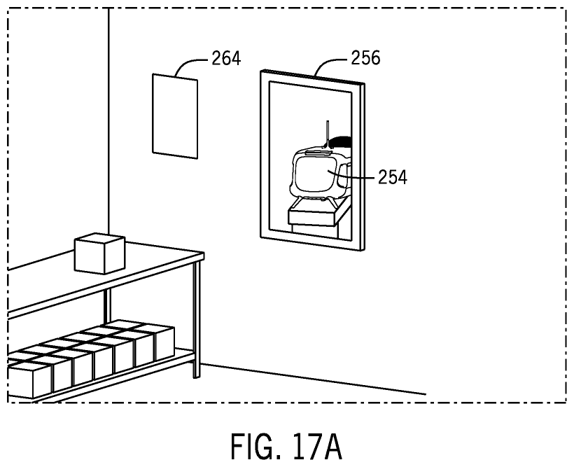

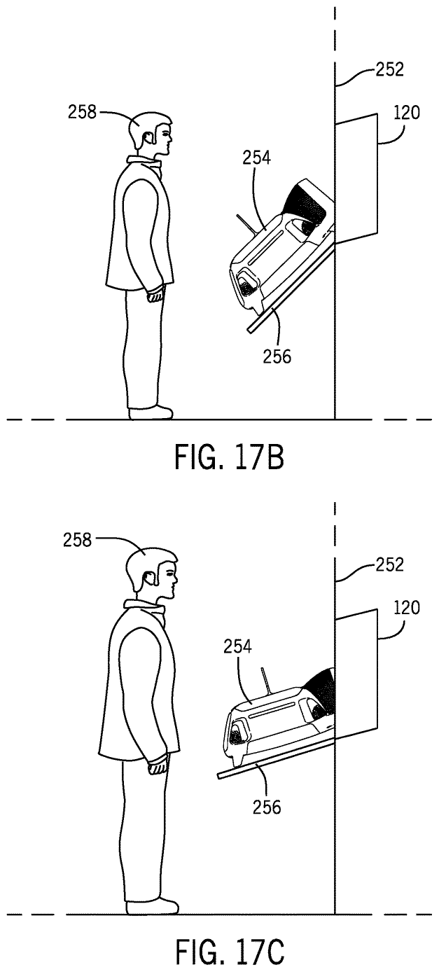

With reference to FIG. 1, in various examples, the support structure 110 may further include a loading assembly 118. In examples where the support structure 110 supports multiple aerial vehicles, the support structure 110 may include multiple loading assemblies serving one or more docks. Support structures may, in various examples, support a single aerial vehicle. The loading assembly 118 may generally include the chute 120 or tube or portal and a net 124 or barrier placed around an opening to the chute 120. The chute 120 may be referred to herein, in various examples, as a tunnel or chute and is configured to allow passage of a payload receptacle therethrough. The net 124 may generally provide increased safety of the loading assembly 118. The chute 120 and net 124 may be positioned below the aerial vehicles. In examples, the chute 120 and net 124 may be spaced from the dock(s) and aerial vehicle(s), such as to allow clearance for the aerial vehicles to navigate to the docks. In various examples, such as shown in FIGS. 17B and 17C, the chute 120 may extend through a wall 252 of a building, such that a secondary vehicle traversing down the chute 120 may deliver payload directly to the interior of the building. Such interior delivery allows users to load and unload aerial vehicles inside existing workspaces, making the adoption of delivery by aerial vehicles more accessible for existing shippers in existing shipping locations.

Generally, the aerial vehicle 106 utilizing the dock 102 may include a primary vehicle and a secondary vehicle 254. The secondary vehicle 254 may be coupled to the primary vehicle, e.g., by a tether, cable, or the like, but may have separate drive abilities, allowing the secondary vehicle 254 to steer itself without or to supplement the primary aerial vehicle. The secondary vehicle may be stored within the aerial vehicle 108 during flight and lowered for package loading and delivery. Examples of the secondary aerial vehicle 254 may be found in U.S. Provisional Patent Application No. 63/449,547, filed on Mar. 2, 2023 and titled “Aerial Delivery Vehicle System” and U.S. Provisional Patent Application Ser. No. 29/885,958, filed on Mar. 2, 2023 and titled “Delivery Vehicle,” both of which are incorporated by reference herein for all purposes.

When the aerial vehicle 106 is retained by the dock 102, the secondary vehicle 254 may descend from the primary vehicle and may deliver payload utilizing the loading assembly 118. For example, the secondary vehicle 254 or other payload receptacle (e.g., a passage container) may navigate to an opening of the chute 120 while, in some examples, remaining connected to the primary vehicle (e.g., by a tether). The chute 120 may, in some examples, guide the payload receptacle from a first environment to a second environment (e.g., such as to allow the payload receptacle to be loaded/unloaded) and may be angled to allow passive or mostly passive flow into a loading area. For example, the chute 120 or guide portal may extend through, for example, a wall 254 of the adjacent building, such that the secondary vehicle 254 may enter the adjacent building and payload may be removed from the secondary vehicle 254 inside of the adjacent building. Similarly, payload may be placed in a secondary vehicle 254, and the secondary vehicle 254 may ascend up the chute (e.g., tube) 120, returning to the docked primary vehicle. For example, where the secondary vehicle 254 is attached to the primary vehicle via a tether, the tether may retract such that the secondary vehicle 254 ascends back to the docked primary vehicle.

The chute 120 may generally include some sort of target, such as a fiducial, that the secondary vehicle 254 may navigate towards when descending towards the chute 120. In various examples, the chute 120 may be at least partially open, and may include mesh, slats, or other ventilation to provide a transition between the outside environment and the interior of the chute 120. The chute 120 may be angled relative to the wall 252 of the building such that the secondary vehicle 254 may descend down the chute 120 passively, e.g., the weight of the secondary vehicle 254 may cause the secondary vehicle to descend down the chute 120. In some examples, the chute 120 may include rails or other features configured to engage with feet or similar features on the bottom of the secondary vehicle 254 to guide the secondary vehicle 254 down the chute 120. In various examples, the chute 120 may include additional features, such as drainage holes, heaters, and/or other elements to reduce and/or eliminate buildup of rain, snow, and/or debris inside or on the chute 120.

The end of the chute 120 may be provided with a door 256 which, when opened, provides access to the secondary vehicle 254. As shown, for example, in FIG. 17A, The door 256 may be configured with an opening such that, when closed, an operator inside of the building can see that a secondary vehicle 254 is present in the chute and is ready to be processed (e.g., payload is ready to be unloaded and/or new payload may be added to the secondary vehicle 254). When the door 256 is opened, the secondary vehicle 254 may slide out of the chute 120 and onto the door 256. As shown in FIGS. 17B and 17C, the door 256 may be placed at a height and/or angle to improve ergonomics for operators (e.g., operator 258) accessing the secondary vehicle 254 through the door 256. For example, the door 256 may be configured to open at an angle relative to the wall 252 such that the secondary vehicle 254 may be accessed roughly at waist height of an operator 258, reducing bending over and/or reaching up to access the secondary vehicle 254.

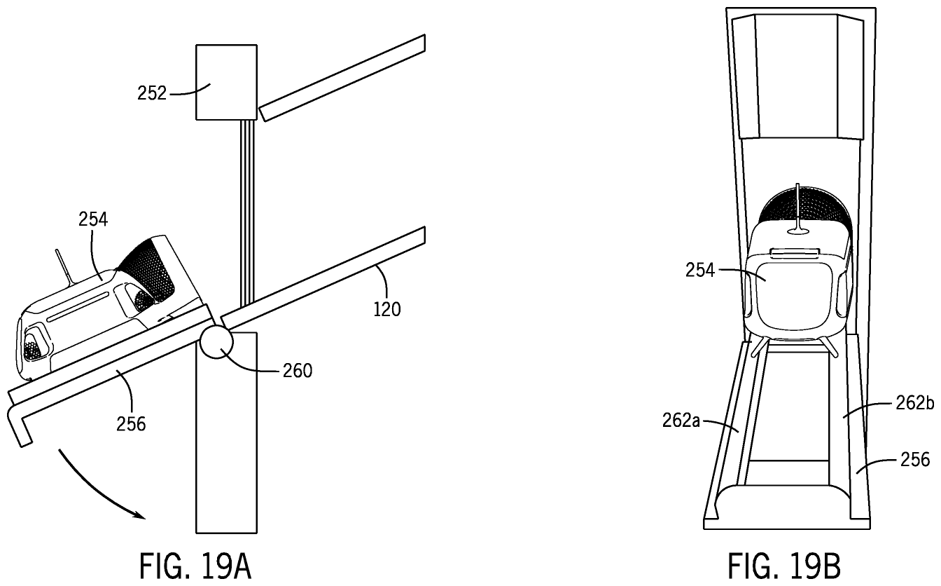

With reference to FIGS. 19A and 19B, the door 256 may be connected to the chute 120 via a hinge 260 located near the interior surface of the wall 252. As described herein, the door 256 may open about the hinge 260. As shown in FIG. 19B, the door 256 may further include guide rails 262a and 262b, which may engage with feet or other features of the secondary vehicle 254 to guide the secondary vehicle downward and out of the chute. In some examples, the door 256 may remain in an open position unless closed (e.g., to accommodate a large number of deliveries). In other examples, the door may be biased closed (e.g., spring loaded), such that the door has to be manually opened to access the secondary vehicle 254. In some examples, the door 256 may create a seal when closed and may be locked or otherwise secured when closed and/or not in use.

In some examples, the chute 120 may be separated from an interior of the building by multiple doors, an airlock, or other features separating the interior of the building from the outdoor environment. For example, the chute 120 may extend to a first door or set of doors for entering an airlock. After entering the first door or set of doors, the secondary vehicle 254 may enter a second door or set of doors to enter the interior of the building. Such an airlock may provide additional protection of the interior of the building from weather, debris, bugs, and/or other elements from the environment from entering the interior of the building. The airlock may further help to stabilize temperatures at the interior of the building. In some examples, where the secondary vehicle 254 is connected to a primary vehicle via a tether, cable, or the like, doors may include openings to accommodate the tether and to reduce damage to the tether. For example, airlock doors may include a small opening sealed with a rubber gasket to allow the tether to pass through the doors while still providing a seal from the outdoor environment and reducing damage to the tether.

The loading assembly 118 may, in various examples, include additional elements, such as a control panel 264. The control panel 264 or loading panel may be utilized by an operator to, for example, receive information about the secondary vehicle 254 (e.g., estimated arrival time of a particular secondary vehicle 254 for loading or unloading), communicate with a docked primary vehicle (e.g., when a secondary vehicle 254 has been processed and is ready to be retracted back to the primary vehicle), and the like.

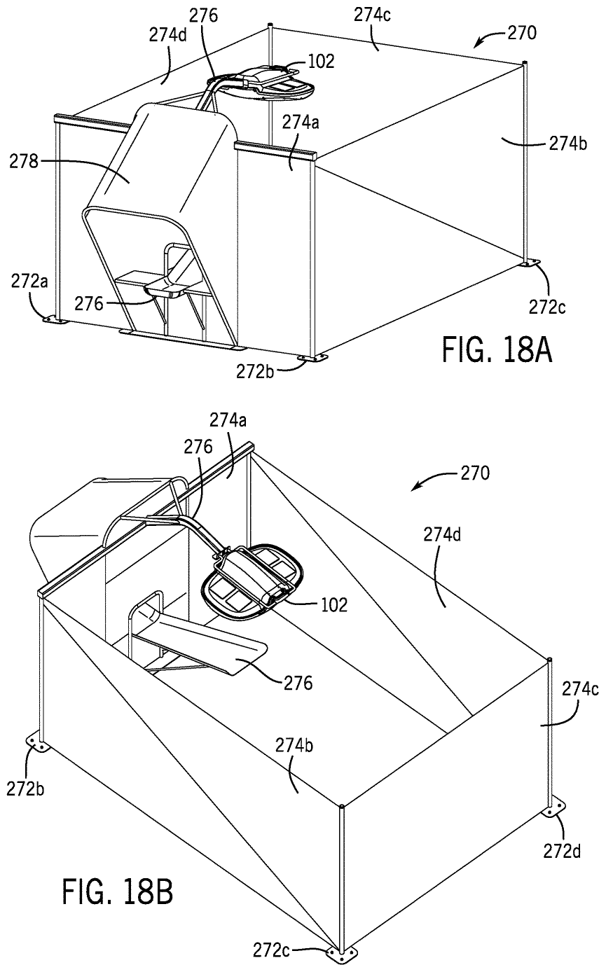

Other implementations of loading assemblies are contemplated. For example, the loading assembly 270 shown in FIGS. 18A and 18B may be installed quickly in, for example, a parking lot or other flat area. Accordingly, the loading assembly 270 may provide a solution for quickly adding additional and/or new docks to a shipping site and/or may be used where creating an opening in a building (e.g., for the chute 120 to enter into an interior of the building) is impractical or otherwise undesired. The loading assembly 270 may further be provided as a temporary docking and loading solution. For example, though the loading assembly 270 may be, in some examples, secured to the ground using plates 272a-272d, the loading assembly 270 may, in some examples, be held in place using ballast, such as sand, concrete and/or water filled structures, which may allow the loading assembly 270 to be installed and removed without any permanent changes to the site.

With continued reference to FIGS. 18A and 18B, the loading assembly may include walls 274a-274d, which may enclose an area including a dock 102. A support 276 may be coupled to a wall 274a to support the dock 102 within the area enclosed by the walls 274a-274d. The walls 274a-274d may generally provide a transitional area for an aerial vehicle utilizing the dock 102. For example, the walls 274a-274d may be used to cut airflow (e.g., wind). Each of the walls 274a-274d may, in various examples, include a thicker mesh (e.g., more restrictive of airflow) on a bottom portion of the wall, and a thinner mesh (e.g., less restrictive of airflow) on a top portion of the wall, providing such a transitional area for an aerial vehicle landing at the dock 102. In other examples, a mesh providing more restrictive airflow may be provided on a top portion of the wall and a mesh providing less restrictive airflow may be provided on a bottom portion of the wall.

The loading assembly 270 further includes a chute 276 extending from the area enclosed by walls 274a-274d to outside of the loading assembly 270 through an opening in the wall 274a. Accordingly, a user may retrieve payload delivered by a secondary vehicle without entering the area where the aerial vehicle is landing on the dock 102. As with the loading assembly 118, when an aerial vehicle utilizes the dock 102, a secondary vehicle 254 may descend from a primary vehicle and travel down the chute 276 to deliver payload and/or prepare to receive payload. In some examples, all or part of the wall 274a may be formed of Plexiglas or another transparent material, allowing an operator outside of the walls 274a-274d to see when an aerial vehicle has landed at the dock 102 and when a secondary vehicle 254 descends down the chute 276. The loading assembly 270 may further include an awning 278 or other structure extending from the wall 274a to shield an operator, a secondary vehicle 254, and/or payload from elements, such as rain, sunshine, wind, and the like.

Additional examples of loading assemblies may similarly provide for interior loading and unloading of aerial vehicles. For example, loading assemblies may be placed relative to a building such that a secondary vehicle enters through a roof or ceiling instead of a wall of the building.

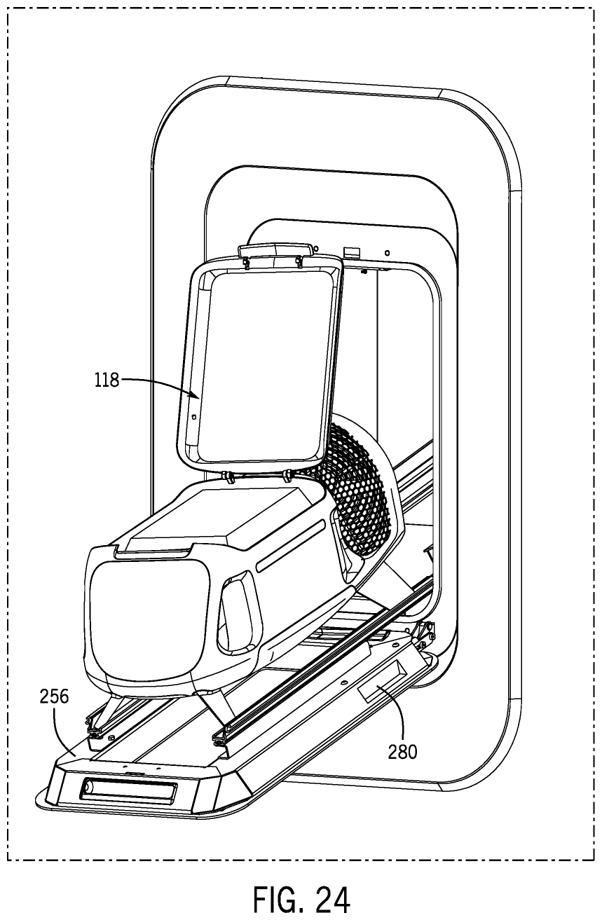

As shown in FIG. 24, in various examples, the loading assembly 118 may include additional features to enhance and/or simplify workflow for workers loading and unloading aerial vehicles. For example, the door 256 may include a mirror 280 positioned such that, when the secondary vehicle 254 is in place on the door 256, barcodes, QR codes, or other visual indicators may be scanned using downward facing cameras of the secondary vehicle 254. For example, the mirror 280 may be angled to redirect the field of view of the downward facing cameras to the side of the secondary vehicle 254. Accordingly, payload may be easily scanned from the side of the secondary vehicle 254 before being loaded into, or after being unloaded from, the secondary vehicle 254. Such scanning may be utilized to verify the payload being placed in the secondary vehicle 254, to track location of payload, to provide delivery details directly to the secondary vehicle 254, and the like.

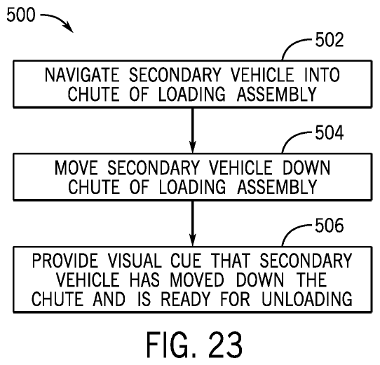

FIG. 23 illustrates an example method 500 of utilizing the loading assembly 118 to deliver payload from a secondary vehicle 254 of the aerial vehicle 106. At block 502, the secondary vehicle 254 navigates into the chute 120 of the loading assembly 118. The secondary vehicle 254 may autonomously navigate to the chute 120 of the loading assembly and may utilize visual sensors, fiducials on or near the chute 120, and/or other features to locate an initial opening in the chute 120. The secondary vehicle 254 moves down the chute 120 of the loading assembly 118 at block 504. In various examples, the secondary vehicle 254 may move down the chute passively. That is, the angle of the chute 120 may be such that the secondary vehicle 254 slides down the chute 120 due to its own weight without additional propulsion or mechanical elements. In some examples, the chute 120 may include guiderails on the interior of the chute 120. Such guiderails may generally guide the secondary vehicle 254 along a path down the chute 120.

At block 506, a visual cue is provided, where the visual cue indicates that the secondary vehicle 254 has moved down the chute and is ready for unloading. The visual cue may be, for example, the secondary vehicle 254 being visible through an opening in a door 256 to the chute. In other examples, a visual cue may be provided by another element of the loading assembly 118, such as the control panel 264. Once the secondary vehicle 254 is unloaded and/or loaded, the secondary vehicle 254 may ascend back up the chute and return to the primary vehicle, which may, in some examples, be docked at the dock 102.

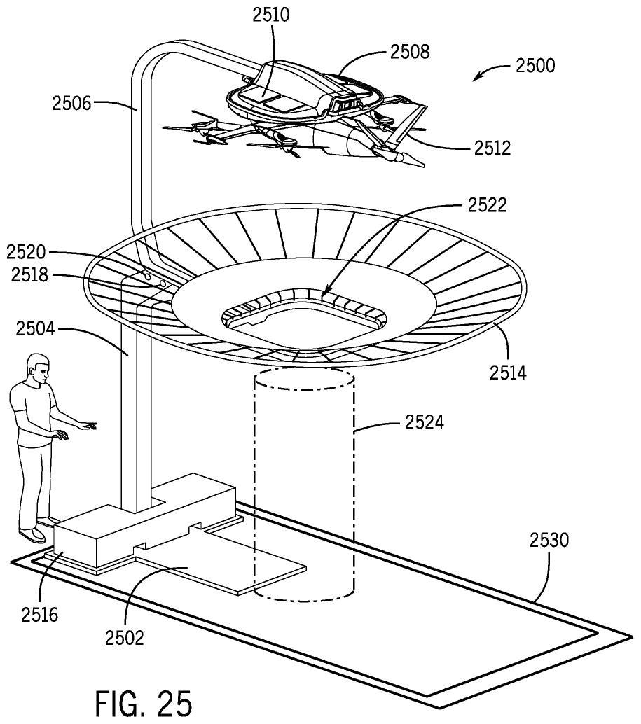

FIG. 25 illustrates a docking assembly 2500 that can be installed directly on the ground or other support surface. The docking assembly 2500 can be a portable assembly that can be quickly, easily, and cheaply installed in a desired location, without requiring modification to the installation location. As a result, the docking assembly 2500 can be installed with minimal construction and permitting. The docking assembly 2500 can be adaptable for a variety of installation locations, and can be moveable. The docking assembly 2500 can be installed separate from adjacent buildings and/or on a roof of a building or other raised structure. The docking assembly 2500 can include a compact footprint (e.g., an area of a base plate 2502), such as a footprint that is sized to fit in a standard parking space 2530.

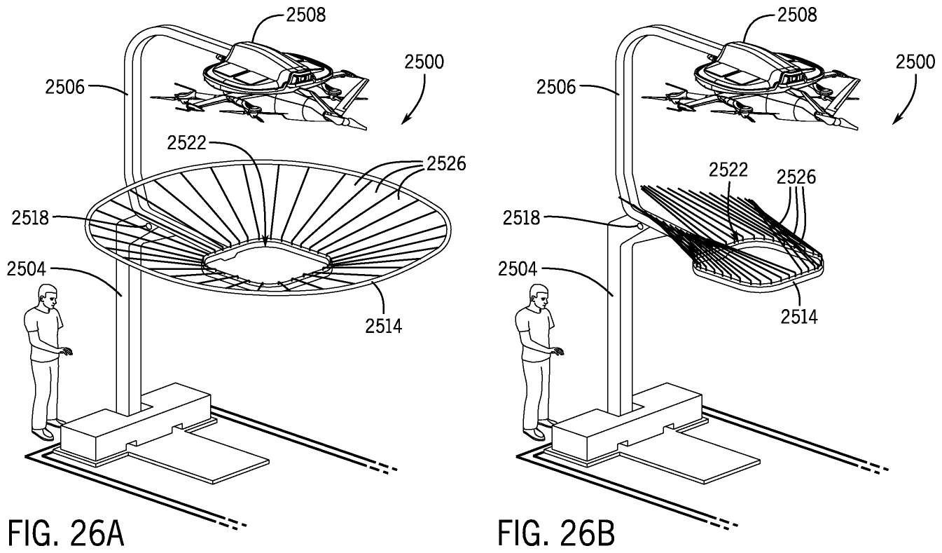

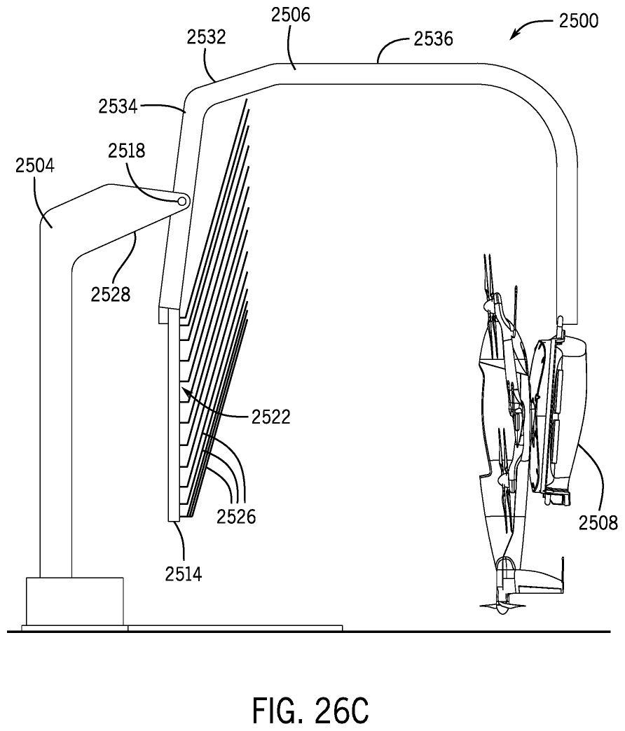

The docking assembly 2500 can include a base plate 2502, a lower post 2504, and an upper post 2506. A dock 2508 can be secured to the upper post 2506 through mount arms 2510. The dock 2508 can be used for docking, loading, and/or charging aerial vehicles 2512. A catch barrier 2514 can be attached to the upper post 2506. The upper post 2506 can be attached to the lower post 2504 through a hinged assembly such that the upper post 2506, including the dock 2508 and the catch barrier 2514, can rotate about a hinge 2516 and relative to the lower post 2504 between a vertical position, illustrated in FIG. 25, and a horizontal position, illustrated in FIG. 26C and discussed below.

The base plate 2502 or anchor maintains the docking assembly 2500 in an upright position. The base plate 2502 can be mounted on the ground. In some examples, the base plate 2502 can be attached to the ground, such as by riveting, bolting, adhering, or the like. In some examples, the base plate 2502 can rest on the ground and the weight and size of the base plate 2502 can be sufficient to maintain the docking assembly 2500 in the upright position. The base plate 2502 can increase a footprint of the docking assembly 2500 and can be weighted in order to prevent tipping of the docking assembly 2500.

The base plate 2502 can be configured to allow for pedestrian and vehicle traffic around the docking assembly 2500 and over the base plate 2502. For example, the base plate 2502 can be sufficiently thin that a car (e.g., a compact car or the like) can park on the base plate 2502. The base plate 2502 can include a trench plate (e.g., a steel road or trench plate), a ramped surface, or the like. As such, the docking assembly 2500 can be installed in the parking space 2530, while allowing for vehicles to park in the parking space 2530, on the base plate 2502.

The docking assembly 2500 can further include a ballast 2516 on the base plate 2502. The ballast 2516 can add further weight to the base plate 2502 in order to maintain the docking assembly 2500 in an upright position and prevent tipping of the docking assembly 2500. The ballast 2516 can be formed from steel, concrete, or the like. In some examples, the ballast 2516 can be a frame that can be filled with a material, such as sand, gravel, concrete, water, or the like when the docking assembly 2500 is installed in a location. This reduces the shipping weight of the docking assembly including the ballast 2516, while still providing improved tipping prevention. The configuration of the base plate 2502 and the ballast 2516 can depend on the location in which the docking assembly 2500 is to be installed. For example, more weight may be required in areas with windy conditions as opposed to areas with relatively low wind conditions.

The lower post 2504 is attached to the base plate 2502. As illustrated in FIG. 25, in some examples, the lower post 2504 can extend through the ballast 2516. The lower post 2504 of the docking assembly 2500 provides clearance between the catch barrier 2514 and the base plate 2502. For example, the lower post 2504 can be sized to provide vertical clearance between the catch barrier 2514 and the base plate 2502 such that pedestrians can move under the catch barrier, cars can park under the catch barrier 2514 on the base plate 2502, and the like.

The upper post 2506 is attached to the lower post 2504. The upper post 2506 can be rotatably attached to the lower post 2504 through a hinge 2518. This allows for the upper post 2506 to be rotated relative to the lower post 2504, around the hinge 2518. The upper post 2506 can be rotated from the vertical position, illustrated in FIG. 25 to a horizontal position, illustrated in FIG. 26C and discussed below. This allows for maintenance to be performed more easily on the components of the upper post 2506, such as the dock 2508 and the catch barrier 2514. Moreover, the docking assembly 2500 can be shipped in a small package with the upper post 2506 in the horizontal position, and the upper post 2506 can be rotated to the vertical position during the installation of the docking assembly 2500. This reduces shipping costs and aids in packaging the docking assembly within road shipping size constraints, while still allowing for rapid installation in desired locations. Removable fasteners 2520 can be attached through the upper post 2506 and the lower post 2504 in order to retain the upper post 2506 in the vertical position, illustrated in FIG. 25. The removable fasteners 2520 can be removed when the upper post 2506 is rotated to a horizontal position, illustrated in FIG. 26C and discussed below. The removable fasteners 2520 can include bolts, locking pins, clamps, latches, or the like.

The upper post 2506 can be sized to provide vertical clearance between the catch barrier 2514 and the dock 2508 such that aerial vehicles 2512 can fly between the catch barrier 2514 and the dock 2508 and land on the dock 2508. As illustrated in FIG. 25, the upper post 2506 can be generally U-shaped, with the dock 2508 and the catch barrier 2514 mounted on opposite ends of the upper post 2506 and the hinge located on a bottom side of the upper post 2506 proximal to the catch barrier 2514.

The dock 2508 can be mounted on the upper post 2506 and may be configured to charge aerial vehicles 2512 and/or to allow aerial vehicles 2512 to receive payload via the loading portal 2514. The dock 2508 mechanically retains aerial vehicles 2512, such as by securing the aerial vehicles 2512 in a docked configuration. The dock 2508 may provide electrical connections (e.g., power and/or data) to the aerial vehicles 2512 to, for example, charge batteries of the aerial vehicles 2512 and/or provide mission information or other useful data to the aerial vehicles 2512. In some examples, flight data can be uploaded from the aerial vehicles 2512 to the dock 2508 while the aerial vehicles 2512 are docked at the dock 2508, and data can also be uploaded to the aerial vehicles 2512 from the dock 2508 while the aerial vehicles 2512 are docked. Payloads can be transferred to and from the aerial vehicles 2512 by, for example, a secondary vehicle descending from an aerial vehicle 2512 and passing through an opening 2518 in the catch barrier 2514 to a loading portal 2524 to deliver payload to, and/or receive payload from, a package loading dock adjacent to the docking assembly 2500.

The catch barrier 2514 (e.g., net or catch) is further mounted on the upper post 2506. The catch barrier 2514 may be configured to catch the aerial vehicles 2512, such as in cases of docking failures or the like. In some examples, the docking assembly 2500 can be used as a charging bay, and the catch barrier 2514 can be a continuous material to provide coverage for the area below the docking assembly 2500. In some examples, the docking assembly 2500 can be used as a loading bay, and an opening 2522 can be provided in the catch barrier 2514. Specifically, the catch barrier 2514 can include the opening 2522 that can be configured to receive secondary vehicles from the aerial vehicles 2512. The opening 2522 can be small enough that the aerial vehicles 2512 do not fit through the opening 2522. The catch barrier 2514 can be collapsible, which aids in rotating the upper post 2506 from the vertical position to the horizontal position, and provides for easier maintenance and shipping of the dock assembly 2500. The catch barrier 2514 can be sized to prevent the aerial vehicles 2512 from falling on pedestrians, vehicles, and the like under the catch barrier 2514. The catch barrier 2514 can be sized based on the size of the aerial vehicles 2512 to be docked on the docking assembly 2500, weather conditions expected at an installation site for the docking assembly 2500, and margins of error for docking the aerial vehicles 2512. In some examples, the catch barrier 2514 can be included to block downdrafts from the aerial vehicles 2512 that occur as the aerial vehicles 2512 dock and launch from the docking assembly 2500. Specifically, the catch barrier 2514 can be formed from a fabric material that can be configured to protect people, objects, and the like below the catch barrier 2514 from strong winds generated by the propellers of the aerial vehicles 2512. In various examples, the catch barrier 2514 can be formed from fabrics, nets, cables, spokes, tubes, wires, and the like.

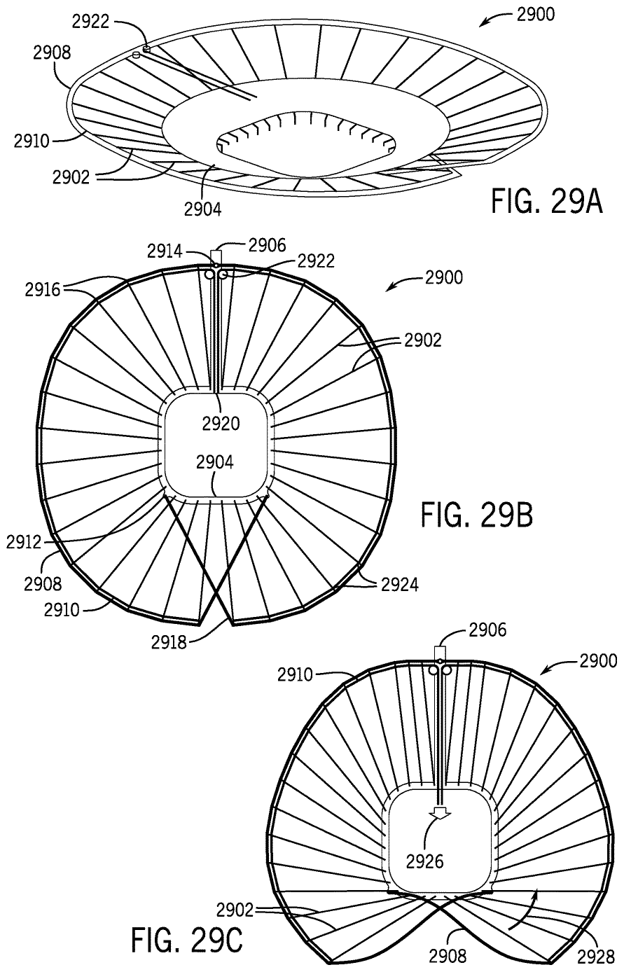

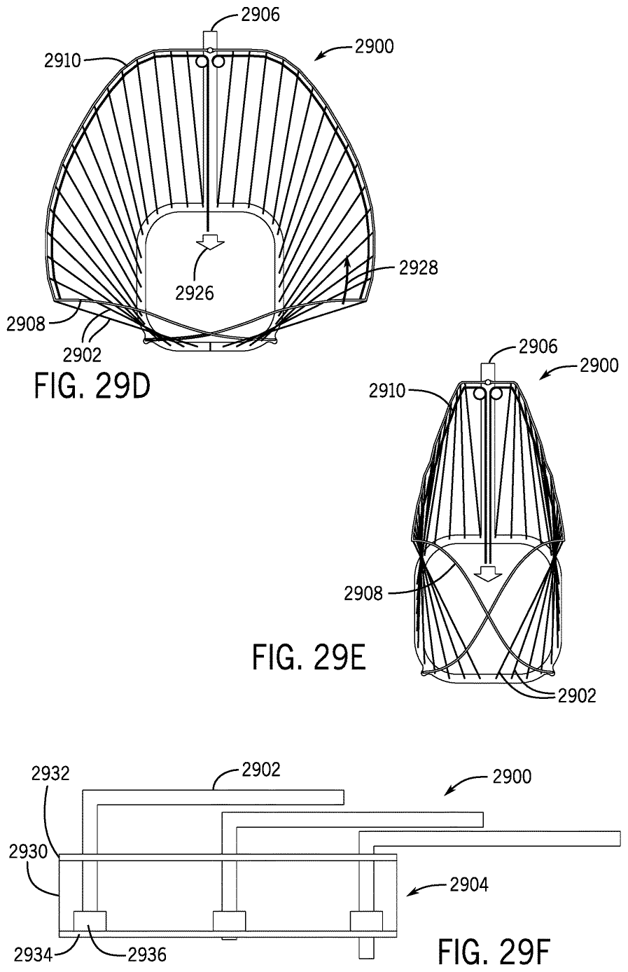

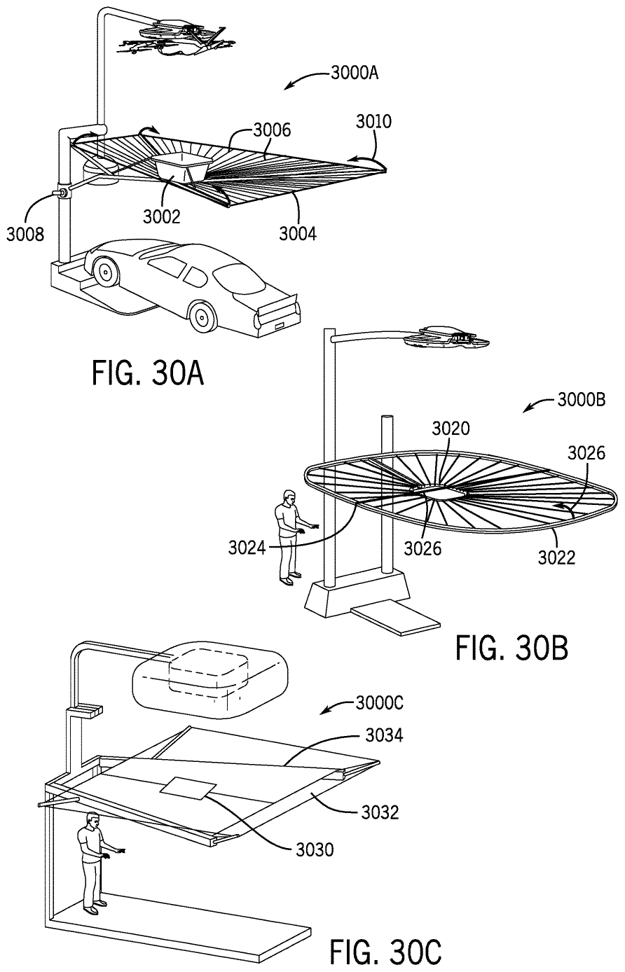

The catch barrier 2514 can be relatively oval-shaped, rectangular, or the like, but generally be configured to expand at least as large as an area of the aerial vehicle and dock. A major dimension of the catch barrier 2514 (e.g., a length of a long side of a rectangle or a greatest diameter of an oval) can be in a range from about 2 m to about 10 m, in a range from about 2 m to about 6 m, or about 4 m. A minor dimension of the catch barriers (e.g., a length of a short side of a rectangle or a least diameter of an oval) can be in a range from about 2 meter to about 10 meters, in a range from about 2 m to about 4 m, about 3.5 m, or about 3 m. Additional details and configurations of the catch barrier 2514 are discussed below with respect to FIGS. 29A-30C.

FIGS. 26A-26C illustrate a method of rotating an upper post 2506 of a docking assembly 2500 from a vertical position (illustrated in FIG. 26A) to a horizontal position (illustrated in FIG. 26C). Rotating the upper post 2506 to the horizontal position can be referred to as lowering the upper post 2506, and can be used to aid in performing maintenance on components (e.g., the dock 2508, the catch barrier 2514, and the like) of the docking assembly 2500, shipping the docking assembly 2500, moving the docking assembly 2500, or the like.

FIG. 26A illustrates the docking assembly 2500 with the upper post 2506 in a vertical position. This may be the same as or similar to the docking assembly and position illustrated and discussed with respect to FIG. 25. Specifically, the dock 2508 is positioned horizontally, the upper post 2506 is positioned vertically, the catch barrier 2514 is positioned horizontally, and the catch barrier 2514 is in a fanned out or extended position.

In FIG. 26B, the catch barrier 2514 is collapsed. The catch barrier 2514 can be collapsed to provide room for the upper post 2506 to be rotated from the vertical position of FIG. 26A to the horizontal position of FIG. 26C. The catch barrier 2514 can include a plurality of spokes 2526 arranged around the opening 2522, which can be rotated towards the upper post 2506 in order to collapse the catch barrier 2514. The spokes 2526 can be vertically offset from one another so that the spokes 2526 rotate freely during the collapsing of the catch barrier 2514. As illustrated in FIG. 26B, the catch barrier 2514 can be collapsed such that the spokes 2526 face the same general direction. Collapsing the catch barrier 2514 decreases the area of the catch barrier 2514, and allows the upper post 2506 to be rotated around the hinge 2518 relative to the lower post 2504 without the catch barrier 2514 hitting the ground or other nearby objects. Additional details and configurations of the catch barrier 2514 are discussed below with respect to FIGS. 29A-30C.

In FIG. 26C, the upper post 2506 is rotated around the hinge 2518 to a horizontal position. The hinge 2518 can be disposed on a cantilevered portion 2528 of the lower post 2504 and the upper post 2506 can include an angled portion 2532 between a lower horizontal portion 2534 and a vertical portion 2536 (defined in the initial or vertical position of FIG. 26A) such that the upper post 2506 is rotated without hitting nearby objects. For example, even when the docking assembly 2500 is installed next to a building, the upper post 2506 can be rotated without contacting the building. After the upper post 2506 is rotated, the dock 2508 is positioned vertically, the upper post 2506 is positioned horizontally, the catch barrier 2514 is positioned vertically, and the catch barrier 2514 is in a collapsed or retracted position. As illustrated in FIGS. 26A-26C, the upper post 2506 can be rotated with an aerial vehicle 2512 mounted on the dock 2508; however, the upper post 2506 can also be rotated without the aerial vehicle 2512.

Once the upper post 2506 is rotated to the horizontal position of FIG. 26C, dock 2506, the aerial vehicle 2512, and the catch barrier 2514 are easily accessible and serviceable. The aerial vehicle 2512 can be removed from or attached to the dock 2506; the dock 2506 can be removed from or attached to the upper post 2506 through the mount arms 2510; and the catch barrier 2514 can be removed from or attached to the upper post 2506 by a person standing on the ground. The docking assembly 2500 can be shipped, moved, and positioned while the upper post 2506 is in the horizontal position illustrated in FIG. 26C. This allows for the docking assembly 2500 to be shipped in a small package, which reduces shipping costs. In cases of severe weather or the like, the upper post 2506 can be transitioned to the horizontal position of FIG. 26C, which can be used to protect the docking assembly 2500.

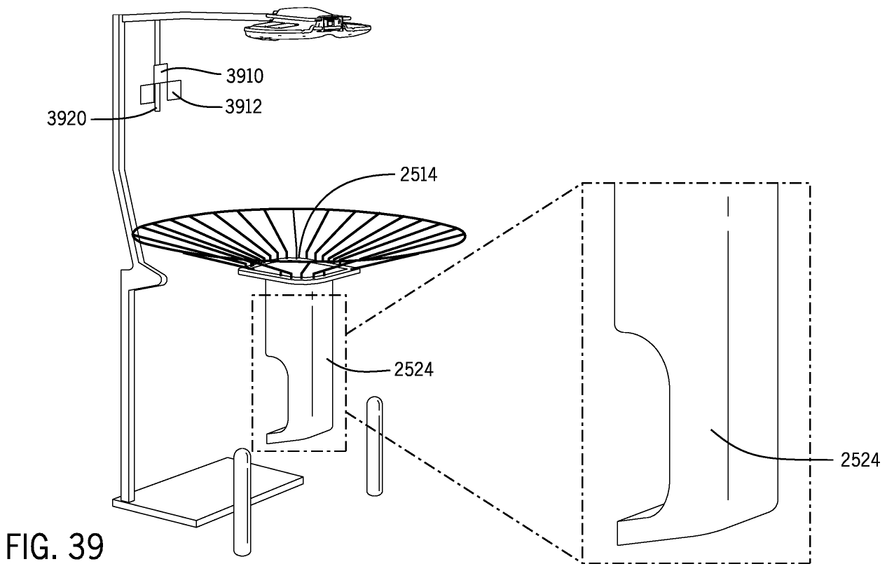

The docking assembly 2500 can be installed using a reverse process to the process of FIGS. 26A-26C. For example, the docking assembly 2500 can be shipped without the aerial vehicle 2512, the dock 2508, or the catch barrier 2514. The docking assembly 2500 can be moved to a desired position. The dock 2508 and the catch barrier 2514 can be mounted on the docking assembly 2500 (e.g., in the configuration of FIG. 26C). The upper post 2506 can be rotated into the vertical position of FIG. 26B. The catch barrier 2514 can be fanned or deployed into the configuration of FIG. 26A. A loading portal 2524 can be attached to the catch barrier 2514 (e.g., see FIG. 39). Thus, the docking assembly 2500 can be quickly and easily installed at a desired location. The docking assembly 2500 can be installed by a single person with limited equipment and limited installation site modification, which reduces installation costs.

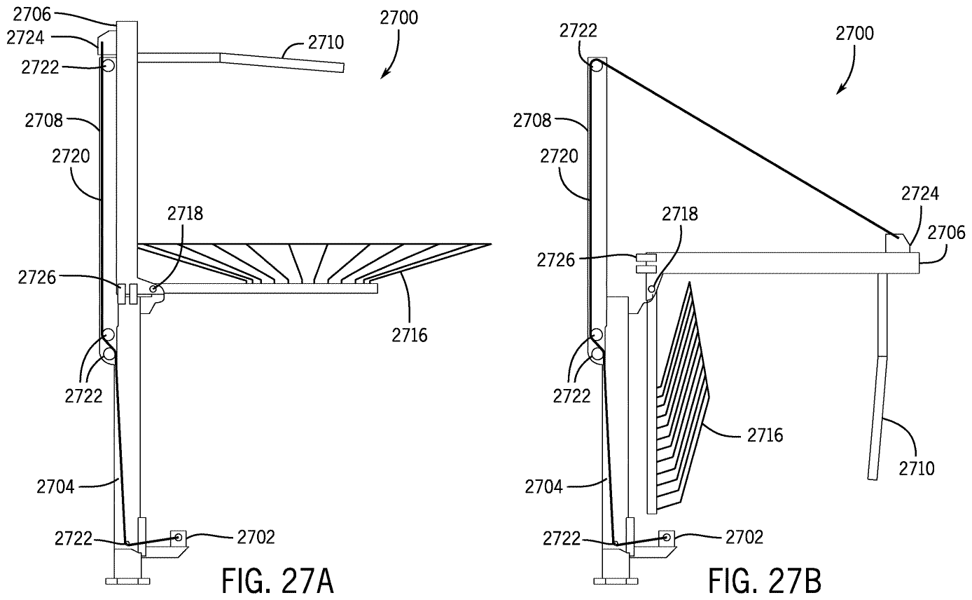

FIGS. 27A and 27B illustrate a docking assembly 2700 with an upper post 2706 rotatable relative to a lower post 2704 via a winch 2702. FIG. 27A illustrates the upper post 2706 in a vertical position (also referred to as a deployed or installed position) and FIG. 27B illustrates the upper post 2706 in a horizontal position (also referred to as a collapsed, folded, maintenance, or shipping position).

The docking assembly 2700 can be similar to the docking assembly 2500, discussed above with respect to FIGS. 25-26C. For example, the docking assembly 2700 includes a lower post 2704, an upper post 2706, a catch barrier 2716 for catching aerial vehicles and the like, and mount arms 2710 for supporting a dock. The upper post 2706 can rotate about a hinge 2718 relative to the lower post 2704. Fasteners 2726 (e.g., bolts, locking pins, clamps, latches, or the like) maintain the upper post 2706 in the vertical position, and can be removed when rotating the upper post 2706 to the horizontal position. Components of the docking assembly 2700 having the same part names as components of the docking assembly 2500 may be the same as or similar to one another.

The upper post 2706 is rotated using the winch 2702. The docking assembly 2700 includes a winch support 2708, a winch line 2720, pulleys 2722, and a winch line receiver 2724. The winch support 2708 can be attached to the lower post 2704. The pulleys 2722 can be attached to the lower post 2704 and the winch support 2708, such as three pulleys 2722 being attached to the winch support 2708 and one pulley 2722 being attached to the lower post 2704. Additional or fewer pulleys 2722 can be included, depending on the path of the winch line 2720. The winch line receiver 2724 can be attached to the upper post 2706. One end of the winch line 2720 can be attached to the winch line receiver 2724, and the other end of the winch line 2720 can be removably attached to the winch 2702.

The winch 2702 can be removably mounted on the docking assembly 2700, on a vehicle, or the like. Specifically, the winch 2702 can be removable, while the winch line 2720 can remain attached to the docking assembly 2700. When it is desired to rotate the upper post 2706, the winch 2702 can be attached to the winch line 2720. The winch 2702 can be quickly installed on-site when needed. Thus, one winch 2702 can be used for multiple docking assemblies 2700, and the winch 2702 does not take up space in the docking assembly 2700. The winch 2702 can be powered by a 12V battery or the like.

In operation, the winch 2702 is connected to the winch line 2720. The winch 2702 is operated to provide tension on the winch line 2720. The fasteners 2726 are unfastened, such that the upper post 2706 can rotate relative to the lower post 2704. The catch barrier 2716 can be collapsed at any time before the upper post 2706 is rotated around the hinge 2718. The winch 2702 then unspools the winch line 2720 from the winch 2702 to lower the upper post 2706 to the horizontal position illustrated in FIG. 27B. As illustrated in FIG. 27B, the winch line 2720 can be spooled through an upper pulley 2722 disposed near a top of the winch support 2708. The upper post 2706 can thereby be rotated by the winch 2702 from the vertical position illustrated in FIG. 27A to the horizontal position illustrated in FIG. 27B. This can aid in performing shipping, moving, maintaining, and the like on the docking assembly 2700.

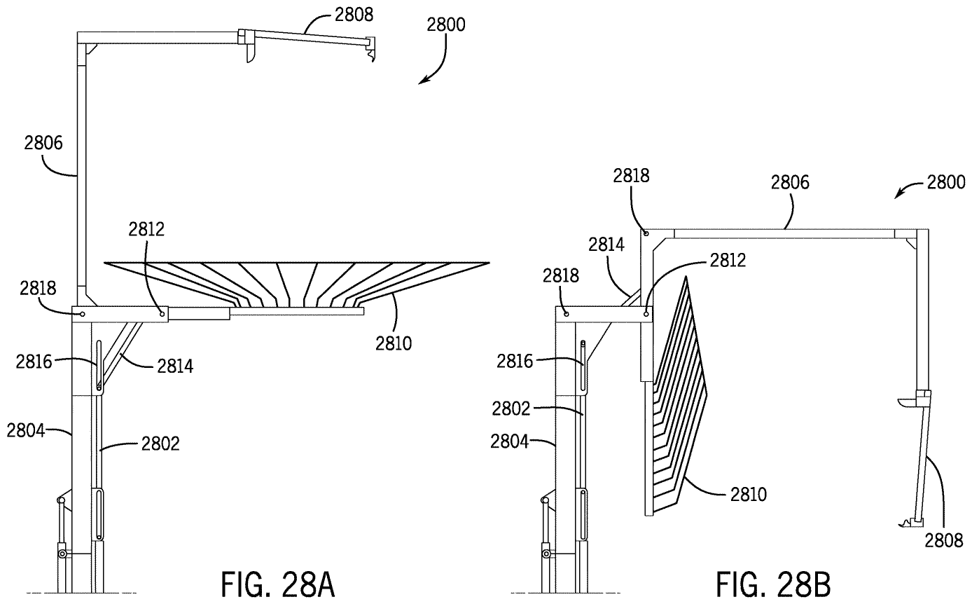

FIGS. 28A and 28B illustrate a docking assembly 2800 with an upper post 2806 rotatable relative to a lower post 2804 via a hydraulic lift 2802. FIG. 28A illustrates the upper post 2806 in a vertical position (also referred to as a deployed or installed position) and FIG. 28B illustrates the upper post 2806 in a horizontal position (also referred to as a collapsed, folded, maintenance, or shipping position).

The docking assembly 2800 can be similar to the docking assembly 2500, discussed above with respect to FIGS. 25-26C. For example, the docking assembly 2800 includes a lower post 2804, an upper post 2806, a catch barrier 2810 for catching aerial vehicles and the like, and mount arms 2808 for supporting a dock. The upper post 2806 can rotate about a hinge 2812 relative to the lower post 2804. Fasteners 2818 (e.g., bolts, locking pins, clamps, latches, or the like) maintain the upper post 2806 in the vertical position, and can be removed when rotating the upper post 2806 to the horizontal position. Components of the docking assembly 2800 having the same part names as components of the docking assembly 2500 may be the same as or similar to one another.

The upper post 2806 is rotated using the hydraulic lift 2802. The docking assembly 2800 includes a linkage 2814 that is attached at one end to the hydraulic lift 2802 and at the other end to the upper post 2806. The lower post 2804 includes a channel 2816 along which the connection between the linkage 2814 and the hydraulic lift 2802 can move. Although the channel 2816 is illustrated as a straight, vertical channel, any channel path can be used depending on the desired rotation of the upper post 2806 (e.g., the channel 2816 can have a curved path, and angled path, or the like).

The hydraulic lift 2802 can be installed under the linkage 2814 at ground level. The hydraulic lift 2802 can be removably mounted on the docking assembly 2800. Specifically, the hydraulic lift 2802 can be removable, while the linkage 2814 can remain attached to the docking assembly 2800. When it is desired to rotate the upper post 2806, the hydraulic lift 2802 can be extended to contact a lower end of the linkage 2814. Specifically, the hydraulic lift 2802 can be extended to move the lower end of the linkage 2814 (e.g., the end of the linkage 2814 disposed in the channel 2816) linkage upwards. The hydraulic lift 2802 can be operated by a portable hydraulic power unit, a 12V battery, or the like. The docking assembly 2800 including the hydraulic lift 2802 can have reduced steel requirements relative to the docking assembly 2700 including the winch 2702 (e.g., the docking assembly 2800 does not have equivalent components to the winch support 2708). The hydraulic lift 2802 operates in tension and compression. However, the hydraulic lift 2802 may be larger, heavier, and more expensive relative to the winch 2702.

In operation, the hydraulic lift 2802 is extended to the lower end of the linkage 2814. The fasteners 2818 are unfastened, such that the upper post 2806 can rotate relative to the lower post 2804. The catch barrier 2810 can be collapsed at any time before the upper post 2806 is rotated around the hinge 2812. The hydraulic lift 2802 is extended to push the lower end of the linkage 2814 upwards, lowering the upper post 2806 to the horizontal position illustrated in FIG. 28B. As illustrated in FIG. 28B, the linkage 2814 can be attached to the upper post 2806 between the hinge 2812 and the fasteners 2818, on an opposite side of the hinge 2812 from the catch barrier 2810. However, other positioning of the hinge 2818 and linkage 2814 can be used depending on the desired path for lowering the upper post 2806. The upper post 2806 can thereby be rotated by the hydraulic lift 2802 from the vertical position illustrated in FIG. 28A to the horizontal position illustrated in FIG. 28B. This can aid in performing shipping, moving, maintaining, and the like on the docking assembly 2800.

FIGS. 29A-29F illustrate a spoke-and-hub catch barrier 2900. FIGS. 29A and 29B illustrate the catch barrier 2900 in a deployed or fanned out configuration, with FIG. 29A illustrating a perspective view and FIG. 29B illustrating a top-down view. FIGS. 29C-29E illustrate a method of collapsing the catch barrier 2900. FIGS. 29E and 29F illustrate the catch barrier 2900 in a collapsed or unfanned configuration, with FIG. 29E illustrating a top-down view and FIG. 29F illustrating a partial side view.

The catch barrier 2900 includes a central hub 2904 with a plurality of spokes 2902 attached to and extending outwards from the central hub 2904. The catch barrier 2900 can be attached to an upper post, such as the upper posts discussed with respect to FIGS. 25-28B, through a support arm 2906. First ends of the spokes 2902 are attached to the central hub 2904, and opposite second ends of the spokes 2902 can include line guides, such as tension line guides 2916 and draw line guides 2924. Tension lines 2908 can extend through respective tension line guides 2916 in each of the spokes 2902, and draw lines 2910 can extend through respective draw line guides 2924 in each of the spokes 2902. Although FIGS. 29A-29F illustrate the tension lines 2908 and the tension line guides 2916 being disposed outside of the draw lines 2910 and the draw line guides 2924, positions of the tension lines 2908 and draw lines 2910 can be reversed. The tension line guides 2916 and the draw line guides 2924 can be attached to the spokes 2902 and can swivel relative to the spokes 2902 to allow for greater ranges of motion, or can be holes provided through the spokes 2902.

The tension lines 2908 can be provided to supply tension to the catch barrier 2900 and maintain the catch barrier 2900 in the deployed configuration of FIGS. 29A and 29B. The tension lines 2908 can be formed of a relatively rigid, but flexible material that maintains its shape in the deployed configuration. The tension lines 2908 can be permanently attached to the support arm 2906 through first tension line anchors 2914, and removably attached to the central hub 2904 through second tension line anchors 2912. In some examples, the tension lines 2908 can be removably attached to the support arm 2906, and be permanently attached to the central hub 2904. In the example of FIGS. 29A-29F, two tension lines 2908 are provided; however, a greater or lesser number of tension lines 2908 can be provided.

The draw lines 2910 can be provided to collapse the catch barrier 2900 into the collapsed configuration of FIG. 29E. The draw lines 2910 can be formed of a flexible material, such as rope, cable, or the like. The draw lines 2910 can be attached to the two of the spokes 2902, such as the spokes 2902 disposed opposite the support arm 2906. The draw lines 2910 can extend through pulleys 2922 attached to the support arm 2906. The draw lines 2910 can also be removably attached to the central hub 2904 proximal the support arm 2906. In the example of FIGS. 29A-29F, two draw lines 2910 are provided; however, a greater or lesser number of draw lines 2910 can be provided. When the draw lines 2910 are attached to the central hub 2904, the draw lines 2910 can supply some tension to the catch barrier 2900 to maintain the catch barrier 2900 in the deployed configuration.

In FIGS. 29C-29E, the draw lines 2910 are pulled in the direction 2926 (illustrated in FIGS. 29C and 29D) to collapse the catch barrier 2900. The direction 2926 can be opposite the support arm 2906. Pulling the draw lines 1910 in the direction 2926 causes the spokes 2902 to rotate ends of the spokes 2902 opposite the central hub 2904 move generally in the direction 2928 (illustrated in FIGS. 29C and 29D) towards the support arm 2906. As illustrated in FIGS. 29C and 29D, the spokes 2902 opposite the support arm 2906 can rotate initially, and the respective spokes 2902 can rotate in a cascade towards the support arm 2906. As illustrated in FIG. 29E, when the catch barrier 2900 is collapsed, the spokes 2902 extend generally towards the support arm 2906. Although not separately illustrated, the tension lines 2908 can form spirals as the draw lines 2910 are pulled and the ends of the spokes 2902 become closer to one another. In some examples, a spacing between the spokes 2902 along the tension lines 2908 can be fixed (e.g., positions of the tension line guides 2916 are fixed relative to the tension lines 2908); however, in some examples, the tension lines 2908 can slide relative to the spokes 2902 (e.g., positions of the tension line guides 2916 are variable relative to the tension lines 2908).

The spokes 2902 can be relatively L-shaped (e.g., L-shaped with an angle of 90 degrees, or greater or lesser than 90 degrees between the sides of the L-shape). The spokes 2902 can be formed from metal, such as bent metal pipes as an example. As illustrated in FIG. 29F, the central hub 2904 can include an upper flange 2932, a lower flange 2934, and a body portion 2930 between the upper flange 2932 and the lower flange 2934. In some examples, the body portion 2930 can be formed of a metal, and the upper flange 2932 and the lower flange 2934 can be formed of plastics or the like. Each of the spokes can extend through the upper flange 2932 and the lower flange 2934 of the central hub 2904. The spokes 2902 can extend through lock washers 2936, which can be used to maintain positions of the spokes 2902 relative to the central hub 2904. More specifically, the lock washers 2936 can control the height of each spoke 2902 relative to the central hub 2904. As illustrated in FIG. 29F, each spoke 2902 can be positioned at a different height relative to neighboring spokes 2902. This allows the spokes 2902 to rotate relative to one another without running into one another. In some examples, each of the spokes 2902 can have the same dimensions (e.g., lengths of the long side and short side of the L-shaped spokes), such that the spokes 2902 extend different distances through the lock washers 2936 and lower flange 2934. In some examples, each of the spokes 2902 can be positioned at the same height.

FIGS. 30A-30C illustrate various alternative configurations of catch barriers 3000 that can be used in docking assemblies, such as the docking assemblies discussed above with respect to FIGS. 25-28B. Specifically, FIG. 30A illustrates an umbrella-type catch barrier 3000A; FIG. 30B illustrates a tension-type catch barrier 3000B; and FIG. 30C illustrates a net-type catch barrier 3000C.

FIG. 30A illustrates the umbrella-type catch barrier 3000A. The catch barrier 3000A can include a loading portal 3002, which can be used to receive a secondary vehicle from an aerial vehicle. The catch barrier 3000A includes a catch material 3004 surrounding the loading portal 3002 (e.g., with the loading portal 3002 disposed centrally in the catch material 3004), which can be used to catch an aerial vehicle in the result of a docking failure or the like. The loading portal 3002 can be sized such that the secondary vehicle can pass through the loading portal 3002, but the aerial vehicle cannot pass through the loading portal 3002. The catch barrier 3000A includes collapsible ribs 3006 that support the catch material 3004. The catch barrier 3000A can include cables attached to a winch 3008 and the ribs 3006 for collapsing the ribs 3006. The winch 3008 can be used to collapse the ribs 3006 and the catch material 3004 in the direction 3010 towards the loading portal 3002 such that an upper post of a docking assembly including the catch barrier 3000A can be rotated without interference from the catch barrier 3000A.

FIG. 30B illustrates the tension-type catch barrier 3000B. The catch barrier 3000B can include a loading portal 3020, which can be used to receive a secondary vehicle from an aerial vehicle. The catch barrier 3000B includes a catch material 3022 surrounding the loading portal 3020 (e.g., with the loading portal 3020 disposed centrally in the catch material 3022), which can be used to catch an aerial vehicle in the result of a docking failure or the like. The loading portal 3020 can be sized such that the secondary vehicle can pass through the loading portal 3020, but the aerial vehicle cannot pass through the loading portal 3020. The catch barrier 3000B includes hinges 3024 that allow the catch barrier 3000B to be collapsed by folding the catch barrier 3000B in half along a line 3026 perpendicular to vertical and horizontal portions of an upper post of a docking assembly on which the catch barrier 3000B is mounted. The catch barrier 3000B can include cables attached to the catch material 3022 opposite the upper post that can be used to collapse the catch barrier 3000B in a direction 3026 towards the upper post. This allows for the upper post of the docking assembly including the catch barrier 3000B to be rotated without interference from the catch barrier 3000B.

FIG. 30C illustrates the net-type catch barrier 3000C. The catch barrier 3000C can include a loading portal 3030, which can be used to receive a secondary vehicle from an aerial vehicle. The catch barrier 3000C includes platform 3034 surrounding the loading portal 3030 (e.g., with the loading portal 3030 disposed centrally in the platform 3034) and a catch material 3032 surrounding the platform 3034. The platform 3034 can be used to perform maintenance on a dock of a docking assembly on which the catch barrier 3000C is mounted. The platform 3034 and the catch material 3032 can be used to catch an aerial vehicle in the result of a docking failure or the like. The loading portal 3030 can be sized such that the secondary vehicle can pass through the loading portal 3030, but the aerial vehicle cannot pass through the loading portal 3030. The catch material 3032 can be a fabric material, a net, or the like.

The catch barriers 2900 and 3000A-3000C illustrated in FIGS. 29A-30C can be provided and sized to prevent aerial vehicles and components thereof from falling on pedestrians, vehicles, and the like under the catch barriers. The catch barriers can be sized based on the size of aerial vehicles to be docked on docking assemblies on which the catch barriers are mounted, weather conditions expected at an installation site for the docking assemblies, and margins of error for docking the aerial vehicles, and the like. The catch barriers can be relatively oval-shaped, rectangular, or the like. Major dimensions of the catch barriers (e.g., lengths of long sides of rectangular barriers or greatest diameters of oval barriers) can be in a range from about 2 m to about 10 m, in a range from about 2 m to about 6 m, or about 4 m. Minor dimensions of the catch barriers (e.g., lengths of a short sides of rectangular barriers or least diameters of oval barriers) can be in a range from about 2 meter to about 10 meters, in a range from about 2 m to about 4 m, about 3.5 m, or about 3 m.

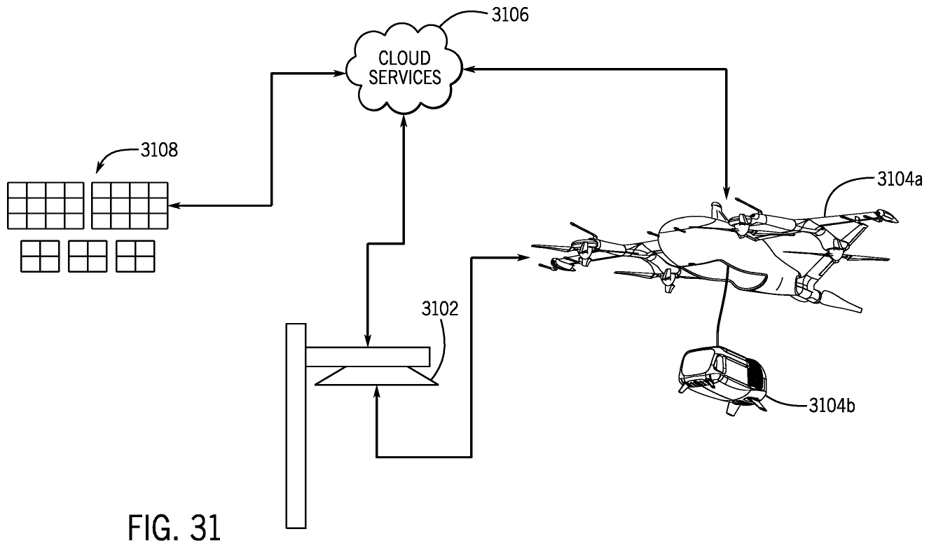

FIG. 31 illustrates an example schematic of a cloud service 3106 in communication with an aerial vehicle dock 3102, an aerial vehicle 3104a, and a control station or service 3108. As shown in FIG. 31, a cloud service 3106 may be communicatively connected to the dock 3102, an aerial vehicle 3104a, a secondary aerial vehicle 3104b, and a control service 3108. For example, the cloud service 3106 may store information about the dock 3102, the aerial vehicle 3104a, the secondary aerial vehicle 3104b, other aerial vehicles within a fleet, and/or other docks. The control service 3108 may be utilized to provide information and/or instructions to docks and/or aerial vehicles, display information about docks and/or aerial vehicles to authorized users, and the like.

In some examples, the aerial vehicle 3104a and/or the secondary aerial vehicle 3104b may automatically upload various data to the cloud services 3106 when docking at the dock 3102. For example, systems of the aerial vehicle 3104a may track various system and flight data for the aerial vehicle 3104a. Upon docking at the dock 3102, the aerial vehicle 3104a may upload such information to the control service 3108. At the control service 3108, the information may be further processed, aggregated, viewed by personnel controlling and/or monitoring the aerial vehicle 3104a, and the like. Similarly, the dock 3102 and/or the secondary vehicle 3104b may upload information (e.g., data) to the cloud service 3106 at various points in time. For example, the dock 3102 may provide information regarding charging status of aerial vehicles at the dock, identity of vehicles at the dock, and the like to the cloud service 3106. In some examples, the secondary vehicle 3104b may provide, among other information, payload status, delivery information, and the like to the cloud service 3106. The control service 3108 may be utilized to view and/or process such information and data.

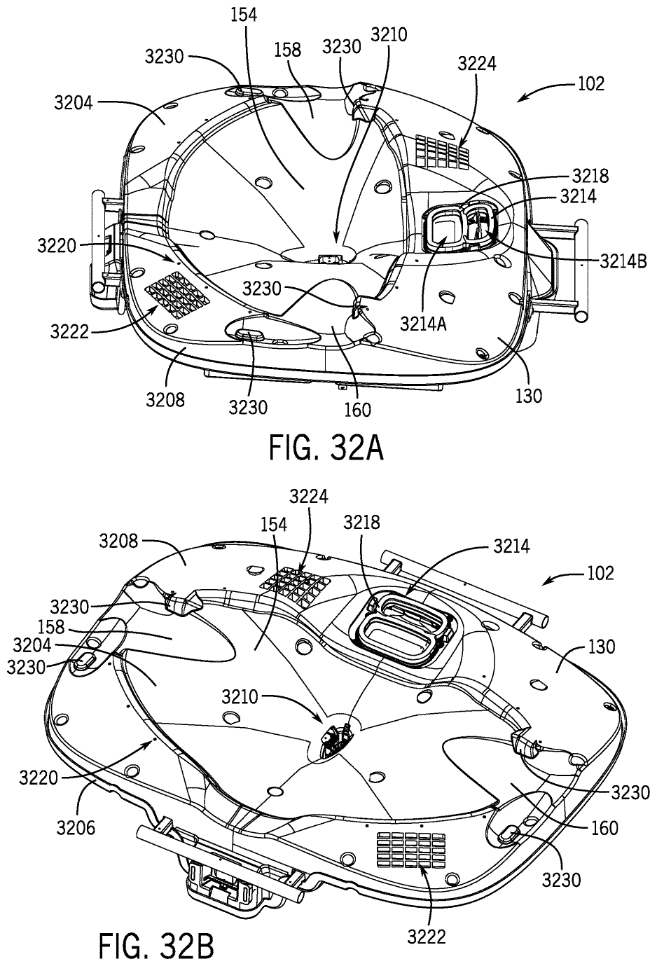

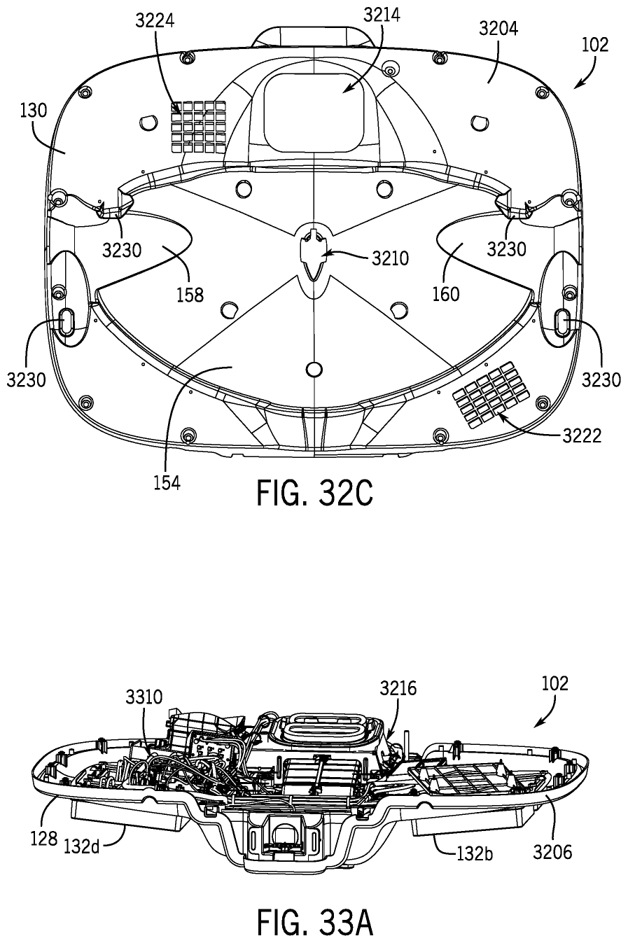

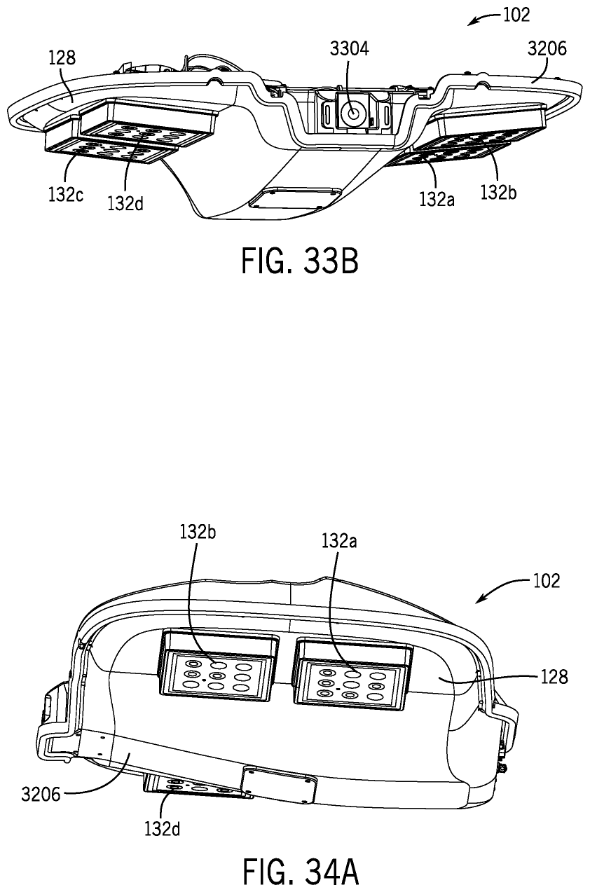

FIGS. 32A-34B illustrate various views of examples of the dock 102. In these examples the dock 102 may be substantially similar to the dock 102 illustrated in FIG. 2, but with the distinctions identified below. With reference to FIGS. 32A and 32B a bottom portion 3204, e.g., a bottom shell, of the dock 102 is disclosed. The bottom portion 3204 may be coupled to a top portion 3206 (e.g., two housing shells) to define an enclosure for receiving various components of the dock 102. For example, the dock 102 may include a housing 3208 formed of two molded shells or halves (e.g., bottom portion 3204, top portion 3206). The surfaces of each respective shell or half may be integral. For example, the bottom surface 130 of bottom portion 3204 may be molded as a single integral surface, and the top surface 128 of top portion 3206 may be molded as a single integral surface. In the example shown in FIGS. 32A and 32B, the bottom portion 3204 may include the angled surface 154 that may include various contoured shapes to encourage and direct the vehicle 106 into a latching mechanism of the dock 102, e.g., into an entry or coupling aperture 3210 within the bottom surface 130. Additionally, a vent or port 3214 for fluidly coupling to an air circulation system of the dock 102, e.g., HVAC. For example, the dock 102 may include a thermal system 3216 (see FIGS. 33A and 48-49) for circulating air to the aerial vehicle 106 when docked in the dock 102. In one example, the vent 3214 may include an inlet 3214A and outlet 3214B and may include a sealing member 3218, such as a rubber gasket surrounded around the perimeter of the inlet and the outlet to define a seal against the paths for the inlet and the outlet of the HVAC or other fluid system (e.g., other thermal systems). For example, in some instances a heat exchange system may be used to help generate a desired temperature for air within or around the dock, such as to condition the battery of the aerial vehicle to a desired temperature for charging and/or flight.

FIG. 32C illustrates an example of the bottom portion 3204 of the dock 102 removed from the top portion 3206. As shown, the bottom portion 3204 may be configured as a single integrally formed component, such as through an injection molding process. This may allow an easier manufacturing and assembly process, as well as allow for accurate precision for generating the curved topography for selecting the guide surfaces for guiding the aerial vehicle 106 to the locking area of the dock 102. In some examples, the material may be moldable, while also being sufficiently strong to be able to support a wide width of material and UV stable, as well as waterproof and fire rated. In one example the material may be a polycarbonate material. The top portion 3206 may be formed in a similar manner and with similar materials.

The coupling aperture 3210 may have electrical contacts coupled thereto to enable an electrical connection the aerial vehicle 106 during or after docking. In some examples, the neck or funnel portion of the bottom surface may be configured to allow physical alignment of the aerial vehicle 106 that will lead to easy electrical alignment.

Additionally, the bottom portion 3204 may include one or more through holes defined therein that may be used for fasteners, a thermal pass-through, and/or drain ports as needed. For example, the bottom portion 3204 may include multiple weep holes 3220 to drain fluid and avoid fluid buildup within the dock 102. The bottom portion 3204 may include an intake port 3222 and an exhaust port 3224, such as for an HVAC system for circulating air within the dock 102. In examples, the intake port 3222 and/or the exhaust port 3224 may include a filter or screen to limit ingress of water, debris, insects, or animals.

In some examples the bottom portion 3204 may include a guide surface or angled surface 154 that includes various bumpers or engagement points 3230 to help encourage the aerial vehicle 106 into the correct orientation during docking. For example the engagement points 3230 may act to resist certain directional movement of the aerial vehicle 106 in certain directions to help ensure movement in a desired direction. By including selected bumpers or engagement points 3230, a substantial portion of the bottom surface may be configured to not engage or directly contact the aerial vehicle 106 as it is docking, which helps to avoid damage and interface with the docking process. For example, the bottom portion 3204 may be shaped to avoid engagement with propellers of the aerial vehicle 106, such as the perimeter of the bottom portion 3204 shaped to accommodate the propellers when docked. The engagement points 3230 may be positioned to distribute retaining or docking forces. For example, wind or other loads on the aerial vehicle 106 may cause a lateral, rotational, or another undesired loading of the latch (e.g., latch jaw 192). To reduce such loading, the engagement points 3230 may distribute the undesired loading away from the latch (e.g., to the bottom portion 3204), such as by limiting movement of the aerial vehicle 106 relative to the bottom portion 3204 when latched.

FIGS. 33A and 33B illustrate various views of the dock 102 illustrating the internal components 3310. As shown in FIG. 33A, various components 3310 of the dock 102 may be in electrical communication via one or more wired connections and may be secured within the enclosure, e.g., to the top or bottom portions 3206, 3204 of the dock 102, as needed. FIG. 33B illustrates an enlarged view of the dock 102 illustrate an example of a visual sensor 3304, e.g., camera, that may be coupled to the dock 102 and configured to capture images of the aerial vehicle 106 and/or environment to better direct the vehicle 106 to the dock 102 for docking. The visual sensor 3304 may be coupled to the housing (e.g., to the top or bottom portion 3206, 324) in a manner to allow a field of view that extends outside of and is not substantially obscured by the housing of the dock 102 itself.

In one example, the dock 102 may include connections for various electronic components, e.g., a power source, such as an AC power source, and/or a communications element, such as an Ethernet port. In some examples, the dock 102 may also include one more heating elements that may act to generate heat to help warm various electronic components, e.g., motors, during cold weather. In some examples, the dock 102 may include a separate accessory, such as a heating accessory, that may couple to the outer enclosure or housing of the dock 102 to couple the heating elements thereto.

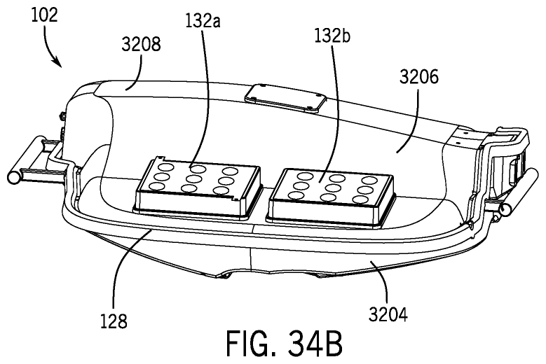

FIGS. 34A and 34B illustrate various views of the top portion 3206 of an example of the dock 102. In this example, the fiducials 132a, 132b, 132c, 132d may be coupled to the top portion 3206 of the dock 102, e.g., top shell, and configured to extend past the top surface 128. More specifically, the fiducials 132a, 132b, 132c, 132d may be raised above the top surface 128 of the top portion 3206 of the dock 102. The fiducials 132a, 132b, 132c, 132d are configured to provide a visual pattern, either statically (e.g., via set colors or patterns) and/or dynamic, e.g., via LEDs or other electronically activated components. In this example, the fiducials may be raised higher from the top surface 128 of the dock 102 to allow them to be more easily visible to sensors on the aerial vehicle from above the dock 102. In one example, the fiducials may include a riser that helps to increase the height, e.g., acts as a spacer to increase the elevation of the fiducial relative to the top surface 128 of the dock 102.

In one example, see, e.g., FIG. 34B, the fiducials may include a static pattern, such as a series of dots with differently “filled in” in colored components to represent a different pattern per fiducial. Additionally the fiducials may be configured to be illuminated in whole, e.g., the entire panel may be illuminated in the same color to generate an illuminated version of the static pattern. In other examples, the pattern may be illuminated by differently colored LEDs to generate a colored pattern. In yet other examples, each of the fiducials may be illuminated in the same color or may be illuminated in different colors. By combining static and illuminated patterns, the dock 102 can generate a unique or distinctive identifier to assist the aerial vehicle during docking.

Additionally, in some examples a heating element, such as a film, may be included on top of or otherwise coupled to the fiducials. The heating element will help to ensure that snow or ice does not accumulate on the top surface of the fiducials which could obscure information generated by the fiducials.

In various examples the fiducials may include an active element that may generate light. For example, LEDs may be arranged on the side of the fiducial and configured to generate light that may be directed via a light guide or other light pathway to the top surface 128 of the fiducial. In some embodiments, the dock 102 may include an ambient light sensor that may help to determine an emitting light (e.g., brightness or hue) that may be configured to be most likely detectable by the aerial vehicle 106. For example, the ambient light sensor may allow a variable brightness adjustment for ambient light conditions to facilitate visibility with camera exposure settings of the aerial vehicle 106 while also minimizing light pollution at night. The LEDs may be different hues (e.g., emit different light wavelengths) to further enhance the detectability.

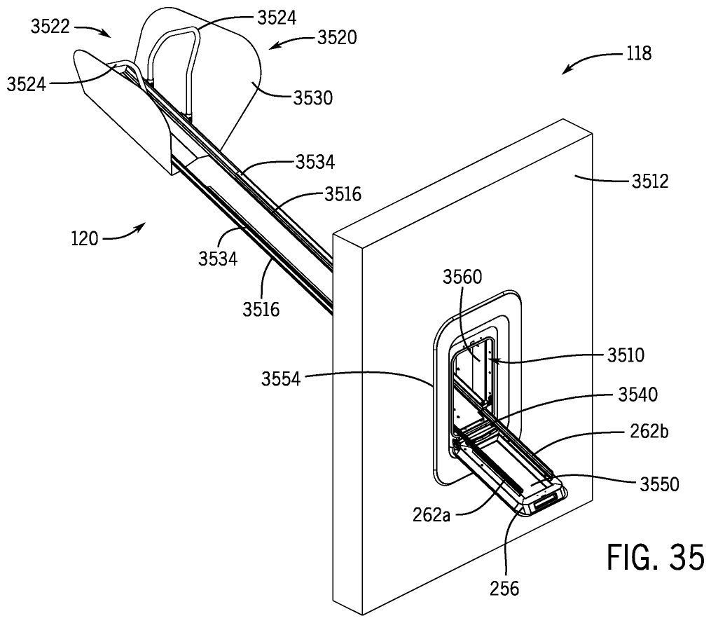

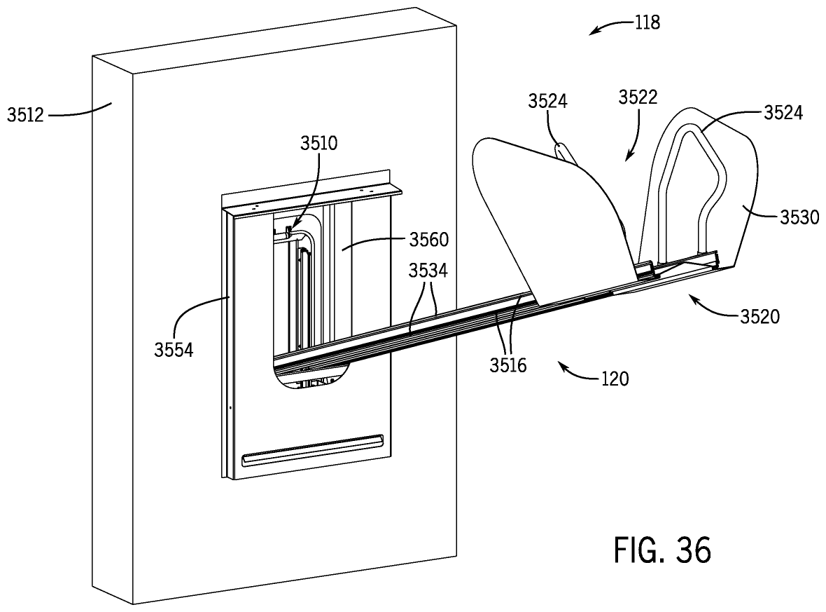

FIGS. 35-36 are perspective views of an additional implementation of the loading assembly 118. The loading assembly 118 may allow the secondary vehicle 254 to enter a building via an opening 3510 in a wall 3512 (e.g., a wall pass-through) or other access location (e.g., window, door, etc.), such as to allow the secondary vehicle 254 to be both loaded and unloaded from the interior of the building, as described herein. For example, the loading assembly 118 may include chute 120 that directs the secondary vehicle 254 to the opening 3510. The chute 120 may be angled downwards towards the opening 3510, such that the secondary vehicle 254 moves towards the opening 3510 (e.g., passively under gravity) as the secondary vehicle 254 is lowered from the aerial vehicle 108. Although a passive ramp is described, the chute 120 may include active features or mechanisms to move the secondary vehicle 254 to the opening 3510.

The chute 120 may be defined by one or more rails (e.g., a pair of rails) 3516. The rails 3516 may engage with feet or other features of the secondary vehicle 254 to guide the secondary vehicle 254 downward. For example, feet of the secondary vehicle 254 may slide along the rails 3516 to the opening 3510. The rails 3516 may align with the guide rails 262a, 262b of the door 256, such that the secondary vehicle 254 slides out of the chute 120 and onto the door 256 for loading/unloading.

The chute 120 may include a capturing end 3520. The capturing end 3520 may include a hopper 3522 to receive the secondary vehicle 254 when lowered from the aerial vehicle 108. The hopper 3522 may include features to align the secondary vehicle 254 with the rails 3516 (e.g., alignment features). The alignment features may be passive such that alignment of the secondary vehicle 254 with the rails 3516 occurs naturally or automatically as the secondary vehicle 254 is lowered into the hopper 3522. For example, the hopper 3522 may be defined by a pair of tubes 3524, such as a tube 3524 coupled to each rail 3516. The hopper 3522 (e.g., the tubes 3524) may be shaped or otherwise configured to direct and align the secondary vehicle 254 to the chute 120 as the secondary vehicle 254 is lowered. For example, the tubes 3524 may be bent to a shape that directs and aligns the secondary vehicle's feet to the rails 3516. The tubes 3524 (e.g., the bent shape of the tubes 3524) may be forgiving to a wide range of misalignments of the secondary vehicle 254 with the rails 3516. For example, the secondary vehicle 254 may be lowered offset and/or angled from the rails 3516, with the tubes 3524 (e.g., the bent shape of the tubes 3524) correcting the misalignment as the secondary vehicle 254 is lowered onto the rails 3516. Although tubes 3524 are shown and described, the passive alignment features may be defined by other elements or configurations. For example, the passive alignment features may be defined by angled plates or other non-tube geometry. In some examples, the capturing end 3520 may include features to actively align the secondary vehicle 254 to the rails 3516. For example, the capturing end 3520 may include visual sensors, fiducials, and/or other features to help the secondary vehicle 254 actively align to the rails 3516.

The capturing end 3520 may include a windshield or windscreen 3530 at the capturing end 3520. The windscreen 3530 may extend around the landing area, such as around the hopper 3522. The windscreen 3530 may protect the secondary vehicle 254. For example, the windscreen 3530 may shield the secondary vehicle 254 from the environment, such as to reduce wind loads at the capturing end 3520 (e.g., to allow an accurate measurement of the secondary vehicle's weight once lifted from the rails 3516, such as to validate that the overall vehicle weight, including the payload, is within performance and regulatory limits). The windscreen 3530 may extend around one side of the landing area, two sides of the landing area, three sides of the landing area, or all four sides of the landing area, depending on application and needs.

At least a portion of the chute 120 may be exposed to the environment, such as to limit issues associated with an enclosed chute (e.g., weight, critter control, etc.). In such examples, the rails 3516 may be cantilevered from the opening 3510. The rails 3516 may include caps 3534 that retain the feet of the secondary vehicle 254 on the rails 3516 between the capturing end 3520 and the opening 3510. The caps 3534 may be positioned or shaped to limit the secondary vehicle 254 falling off the rails 3516 between the capturing end 3520 and the opening 3510, while still allowing the feet to slide freely along the rails 3516.

The door 256 may be selectively opened or closed, such as via one or more hinges 3540. In examples, the loading assembly 118 may include a gasket 3544 to seal the door 256 to the opening 3510 when closed. The gasket 3544 may extend around the entire opening 3510. The hinge(s) 3540 may be positioned outside of the gasket 3544, such that clean contact is made around the entire seal. In examples, the door 256 may include a window 3550. The window 3550 may facilitate visual indication of the secondary vehicle 254 at the portal, such as allowing a user to see that the secondary vehicle 254 is present for loading/unloading. In examples, a bezel 3554 may extend around the opening 3510, such as to conceal the cutout through the wall 3512. The door 256 may seal against the bezel 3554 or a frame 3560 positioned within the opening 3510, as detailed below.

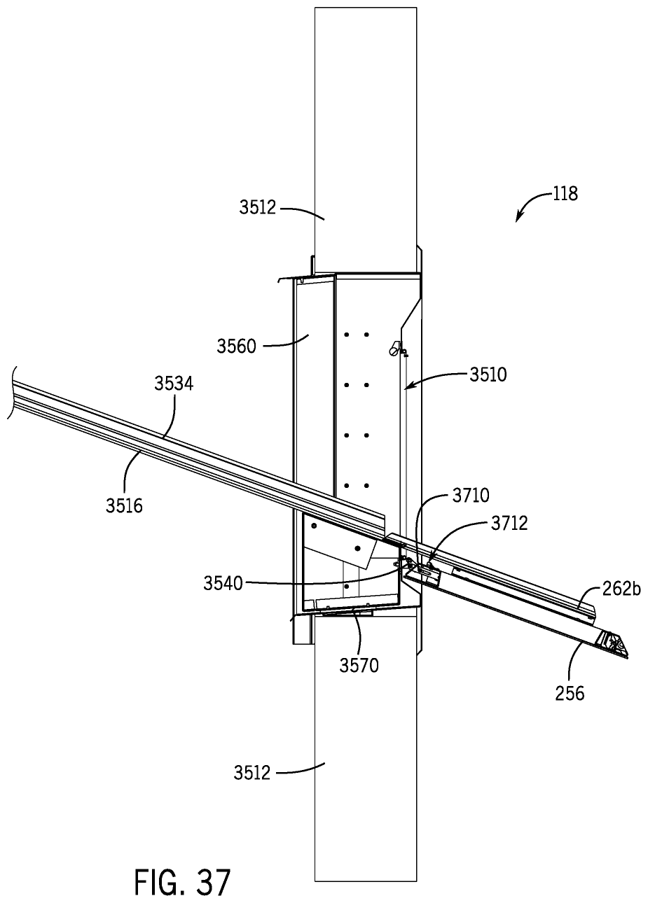

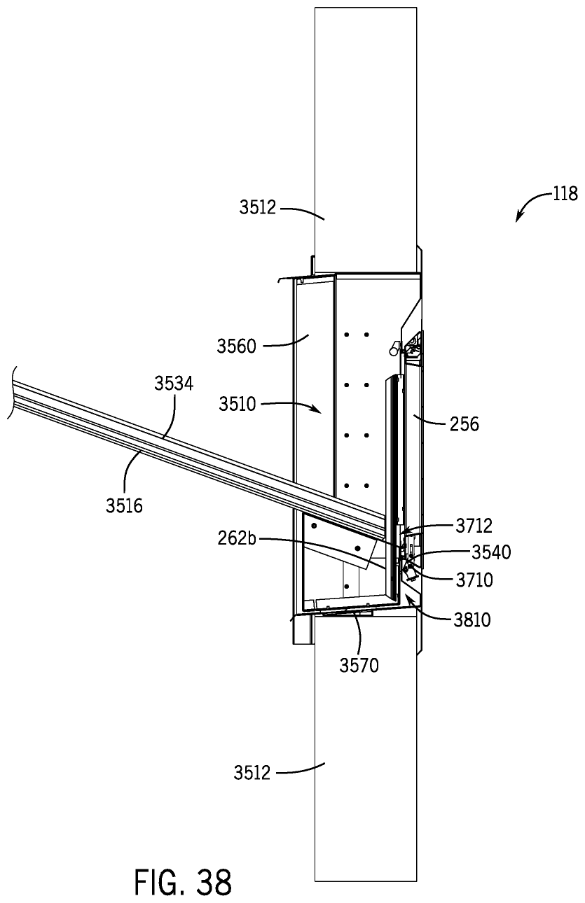

FIGS. 37-38 are cross-sectional views of the loading assembly 118 in open and closed configurations, respectively. Referring to FIG. 37, the open configuration is defined by the door 256 opened, such as when the door 256 is rotated or otherwise moved away from the opening 3510 via the hinges 3540. The hinges 3540 may provide a hard stop in the open configuration, such as to hold the weight of the door 256 and secondary vehicle 254 (and payload) and maintain alignment of the guide rails 262a, 262b with the rails 3516. The hard stop may be set by a pin 3710 traveling in a slot 3712 of the hinge 3540. For example, the pin 3710 may slide within the slot 3712 as the door opens and closes. At the open configuration, the pin 3710 may engage an end of the slot 3712 to provide a door stop. In examples, the loading assembly 118 (e.g., the door, hinges 3540, etc.) may include an integrated spring counteracting the weight of the door 256, such as to assist in lifting the door 256, providing a soft opening features, etc.

With continued reference to FIG. 37, the frame 3560 fits within the opening 3510 and is secured in place. The frame 3560 may then be sealed to the wall 3512. The frame 3560 may support the rails 3516 and door 256. For example, the rails 3516 may be coupled to cantilever from the frame 3560, and the door may be attached to the frame 3560 via the hinges 3540. In examples, the rails 3516 may be hinged, such as along their lengths and/or at the frame 3560 or other connection. As a result, the rails 3516 may fold or otherwise move, such as to accommodate maintenance of the loading assembly 118 and/or a docking assembly (e.g., as a docking assembly is moved to a maintenance position). In examples, the frame 3560 may accommodate different wall thicknesses. For example, the frame 3560 may include multiple pieces that overlap to adjust its depth, width, or other dimension. In some examples, the frame 3560 may include a gutter 3720. The gutter 3720 may extend through the opening 3510 and is sloped to drain fluid out of the opening 3510 (e.g., to the exterior side of the wall 3512).

Referring to FIG. 38, the closed configuration is defined by the door 256 closed, such as when the door is rotated or otherwise moved towards the opening 3510 via the hinges 3540. The loading assembly 118 (e.g., the frame 3560) may include or define one or more pockets 3810. The pockets 3810 may align with the guide rails 262a, 262b, such that the guide rails 262a, 262b store in the pockets 3810 when the door 256 is closed. For example, movement of the door 256 to its closed position may rotate the guide rails 262a, 262b into the pockets 3810. When closed, the door 256 may lock in position. For example, the loading assembly 118 may include a latch securing the door 256 in the closed position. The latch may engage (e.g., automatically) when the door 256 is closed, and require actuation of a release (e.g., a button) to open. The latch may be actuated (secured and released) manually (e.g., via a button and lock/key) and/or via automation (e.g., via control panel 264). For example, the control panel 264 may be used to control the opening of the door 256, such as who can open the portal, whether the portal can be opened, who can load the secondary vehicle 254, when the secondary vehicle 254 can be lowered from the aerial vehicle 108, etc.

FIG. 39 is a perspective view of an implementation of the loading portal 2524 (or a booth loading station). The loading portal 2524 may allow loading of the secondary vehicle 254 away from a building. For example, the loading portal 2524 may permit outdoor loading, such as to avoid a wall pass through or other site construction. The loading portal 2524 may be attached to the catch barrier 2514, such as to hang from the catch barrier 2514 (e.g., at different heights and/or angles). Additionally, or alternatively, the loading portal 2524 may rest on the ground. In such examples, the secondary vehicle 254 may be lowered into the loading portal 2524. The loading portal 2524 may support the secondary vehicle 254 in a position for loading and/or unloading by a user below the catch barrier. In some examples, the loading portal 2524 may be implemented in all orientations (e.g., facing left, right, forward, backward, or at an intermediate angle), such as to redirect or rotate the secondary vehicle 254 (e.g., without using the propulsion system of the secondary vehicle 254). In examples, the loading portal 2524 may have a dedicated area for the secondary vehicle 254 to reorient itself using its propulsion system.

With continued reference to FIG. 39, a panel 3910 may be provided, such as mounted to the upper post or mast of a docking assembly. The panel 3910 may include one or more fiducials 3912 (e.g., a set or cluster of fiducials 3912) to help orient the aerial vehicle 106 or 108 during docking, such as in a manner as described herein. For example, the fiducials 3912 may be used by the aerial vehicle 106 or 108 for final localization during docking and takeoff maneuvers. The aerial vehicle 106 or 108 may transition from the fiducials on top of the dock 102 to the fiducials 3912 on the panel 3910 when the aerial vehicle 106, 108 drops below the dock 102 (e.g., when the dock's fiducials are no longer visible or are partially obscured to the aerial vehicle 106, 108).

In some examples, the panel 3910 includes a visual sensor 3920 (e.g., a camera, a camera system, a front facing camera, an upward facing camera, etc.), although the visual sensor 3920 may be located separate from the panel 3910. The visual sensor 3920 may be used to look for or otherwise detect defects in the dock 102 and/or the aerial vehicle 106 or 108, such as during preflight and/or flight near the dock 102 (e.g., as the aerial vehicle 106, 108 is docking, during deployment of the aerial vehicle 106, 108, etc.).

For example, before flight, the system may ensure a docked aerial vehicle is cleared for release (e.g., an “airworthiness release”), such as by completing automated preflight checks of the aerial vehicle. For instance, an airworthiness release may indicate the aerial vehicle has up to date weight and balance, has no open discrepancies, and is in an airworthy condition. The preflight checks may also ensure the aerial vehicle is configured correctly, all systems are nominal, the aerial vehicle has sufficient charge for the planned route, the planned route is clear of flight restrictions and prohibited weather conditions, etc. In examples, the system may complete airspace checks and initiate a visual check of the aerial vehicle via the visual sensor 3920, such as to ensure no unsafe condition exists and the aerial vehicle is in a condition for safe flight. If an unsafe condition is identified (e.g., an unclear flight area, aerial vehicle defects, etc.), such as via the visual sensor 3920, the aerial vehicle may not be authorized to takeoff until the issue is rectified. In examples, certain preflight checks may trigger a manual review, including reviewing a camera feed of the aerial vehicle to ensure the vehicle is free of damage, debris, and loitering animals; to ensure the safe zone around the dock is free of persons or animals; and to perform a final check that the airspace is clear of air traffic.

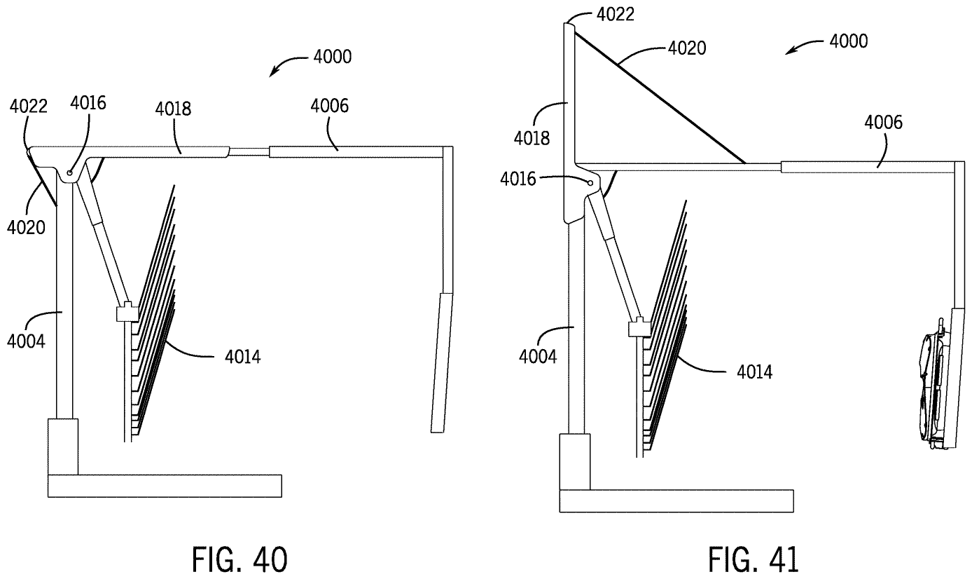

FIGS. 40-42 are perspective views of a docking assembly 4000 in first, second, and third configurations, respectively. The docking assembly 4000 may be similar to any of the docking assembly 2500, the docking assembly 2700, or the docking assembly 2800, discussed above. For example, the docking assembly 4000 includes a lower post 4004, an upper post 4006 rotatable relative to the lower post 4004 about a hinge 4016, and a catch barrier 4014, among other similar features. Similar components may be the same as or similar to those described above.

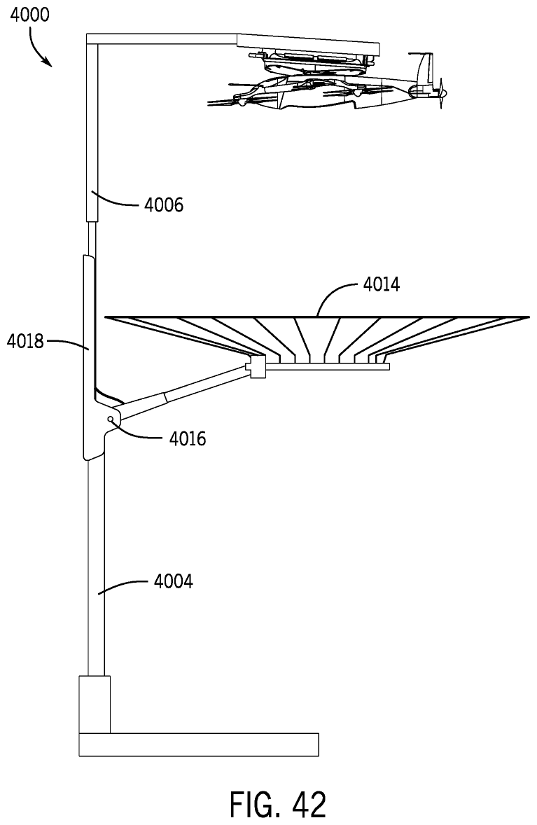

The docking assembly 4000 may include pulley arm 4018. The pulley arm 4018 may rotate relative to the lower post 4004 about the hinge 4016. The pulley arm 4018 may include one or more pulley 4022 that route a winch line 4020 from the lower post 4004 to the upper post 4006. In this manner, the pulley arm 4018 may function as the winch support 2708, described above. For example, the pulley arm 4018 and pulley 4022 may allow the upper post 4006 to be rotated between horizontal (see FIGS. 40-41) and vertical (see FIG. 42) positions, such as to aid in performing shipping or moving of, or maintenance on, the docking assembly 4000, as described herein.

Referring to FIG. 40, the first configuration may be a folded configuration of the docking assembly 4000, such as for deployment or shipping of the docking assembly 4000. In the first configuration, the upper post 4006 and pulley arm 4018 may extend horizontally, or substantially horizontally, such as to reduce a total height of the docking assembly 4000 for shipping or deployment.

Referring to FIG. 41, the second configuration may be an intermediate configuration of the docking assembly 4000, such as for maintenance or to prepare to lift the upper post 4006 into position. In the second configuration, the pulley arm 4018 may be rotated to a vertical position. For example, the pulley arm 4018 may be rotated about the hinge 4016 via the winch. Once vertical, the pulley arm 4018 may be secured in position. For example, the pulley arm 4018 may be pinned to the lower post 4004.

Referring to FIG. 42, the third configuration may be an assembled configuration of the docking assembly 4000, such as for nominal use of the docking assembly 4000. In the third configuration, the upper post 4006 may be rotated to a vertical position. For example, the upper post 4006 may be rotated about the hinge 4016 via the winch. Once vertical, the upper post 4006 may be secured in position, such as pinned to the pulley arm 4018, although other configurations are contemplated. Rotation of the upper post 4006 to its vertical position may rotate or otherwise move the catch barrier 4014 into position.

The docking assembly 4000 may be moved back to the second configuration and first configuration in reverse order. For example, the upper post 4006 may be released from the pulley arm 4018, and the winch may be used to lower the upper post 4006 to a horizontal position, such as to perform maintenance on the catch barrier 4014, the dock, or other portions of the docking assembly 4000. The pulley arm 4018 may then be released from the lower post 4004, and the winch may be used further to lower the pulley arm 4018 to a horizontal position, such as to prepare the docking assembly 4000 for shipment.

Although a winch line 4020 is shown to raise/lower the upper post 4006 and pulley arm 4018, other configurations are contemplated. For example, the pulley arm 4018 may be spring-loaded to the vertical position (e.g., via a gas shock, a spring, etc.). In such examples, winching out the winch line 4020 may raise the pulley arm 4018 until the pulley arm 4018 is pinned in place, and winching in the winch line 4020 may lower the pulley arm 4018 when free to rotate. In other examples, the pulley arm 4018 may be manually lifted and lowered.

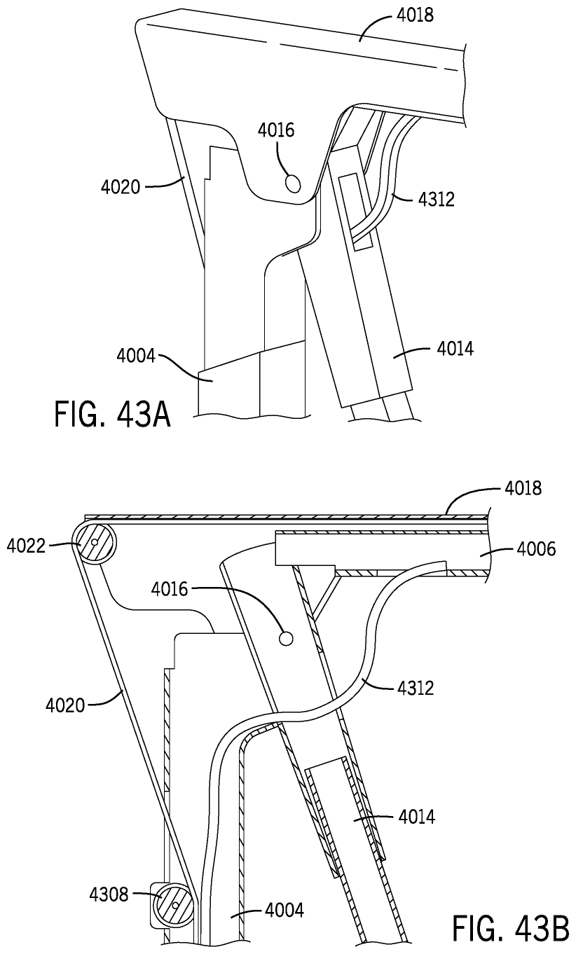

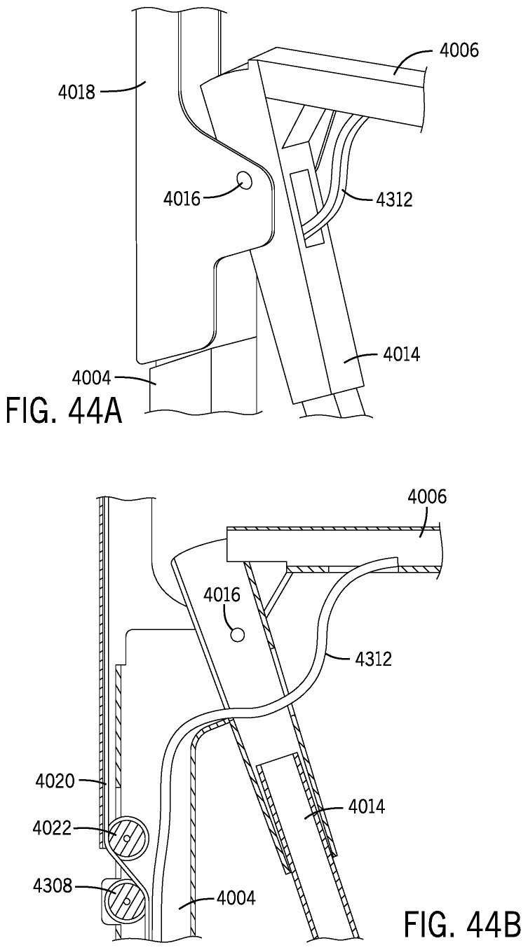

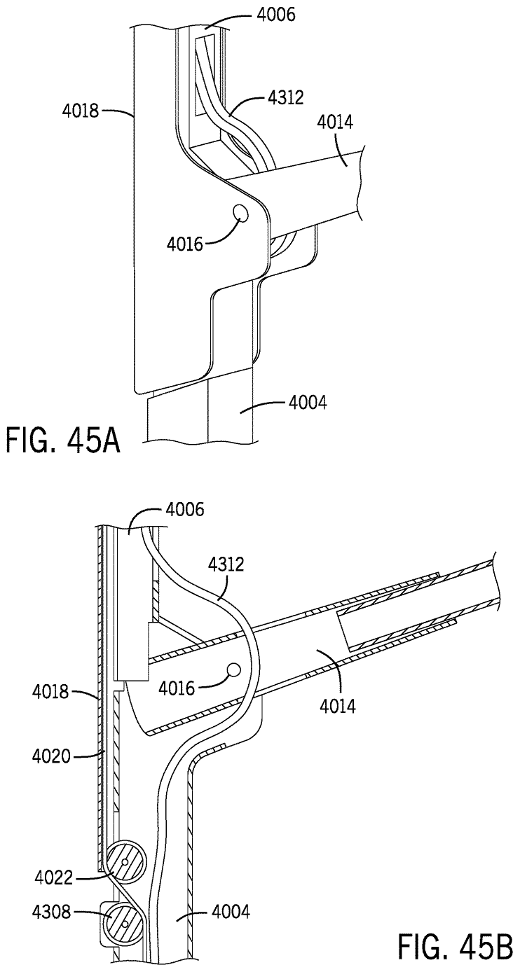

FIGS. 43A-43B are perspective and cross-sectional views of the hinge 4016 and a cable routing layout of the docking assembly 4000 in the first configuration. FIGS. 44A-44B are perspective and cross-sectional views of the hinge 4016 and cable routing layout of the docking assembly 4000 in the second configuration. FIGS. 45A-45B are perspective and cross-sectional views of the hinge 4016 and cable routing layout of the docking assembly 4000 in the third configuration. The hinge 4016 may be defined on the lower post 4004, such that both the upper post 4006 and the pulley arm 4018 rotate about the lower post 4004. The winch line 4020 may be routed through the lower post 4004 and the pulley arm 4018, such as between the pulley arm 4018 and the upper post 4006. The lower post 4004 may include a lower pulley 4308. As shown, the winch line 4020 may be routed on the inside of the lower pulley 4308 and around the pulley 4022 of the pulley arm 4018. Additional cables 4312 (e.g., power and/or data cables) may be routed around the hinge 4016 in a manner allowing the docking assembly 4000 to fold. For example, the cables 4312 may be routed through the lower post 4004, under the hinge 4016, and through the upper post 4006. In examples, the cables 4312 may be routed through the catch barrier 4014 support. Such examples may allow the docking assembly 4000 to fold without binding the cables 4312.

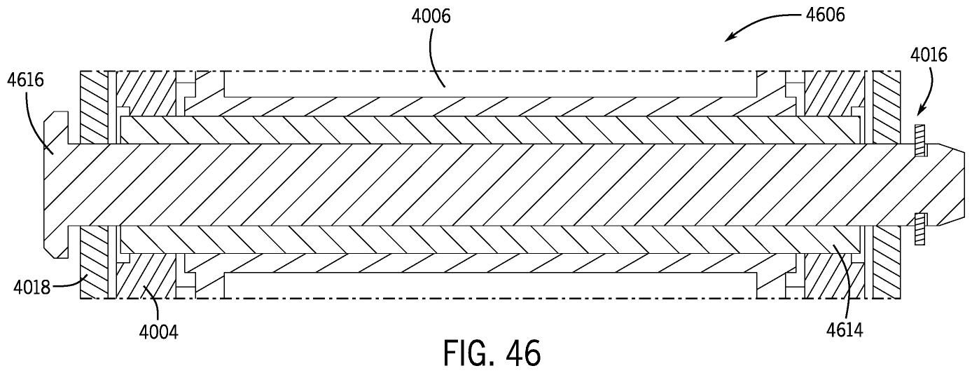

FIG. 46 is a cross-sectional view of a hinge pin 4606. The hinge pin 4606 may be used to connect the upper post 4006 and pulley arm 4018 to the lower post 4004 at the hinge 4016. To allow the upper post 4006 and pulley arm 4018 to rotate about the same hinge 4016, the hinge pin 4606 may be a two-part pin, including a first portion 4614 (e.g., outer pin) and a second portion 4616 (e.g. inner pin). The first portion 4614 may secure the upper post 4006 to the lower post 4004. For example, the lower post 4004 may surround the upper post 4006, and the first portion 4614 may rotatably couple the upper post 4006 to the lower post 4004, at the hinge 4016. The pulley arm 4018 may secure the first portion 4614 in place. For example, the pulley arm 4018 may surround the first portion 4614 at the hinge 4016 to keep the first portion 4614 in place. The second portion 4616 may secure the pulley arm 4018 to the lower post 4004. For example, the pulley arm 4018 may surround the lower post 4004, and the second portion 4616 may rotatably couple the pulley arm 4018 to the lower post 4004, at the hinge 4016. The second portion 4616 may be inserted through a hollow section of the first portion 4614. The second portion 4616 may be secured in place, such as via a cotter pin or other retainer.

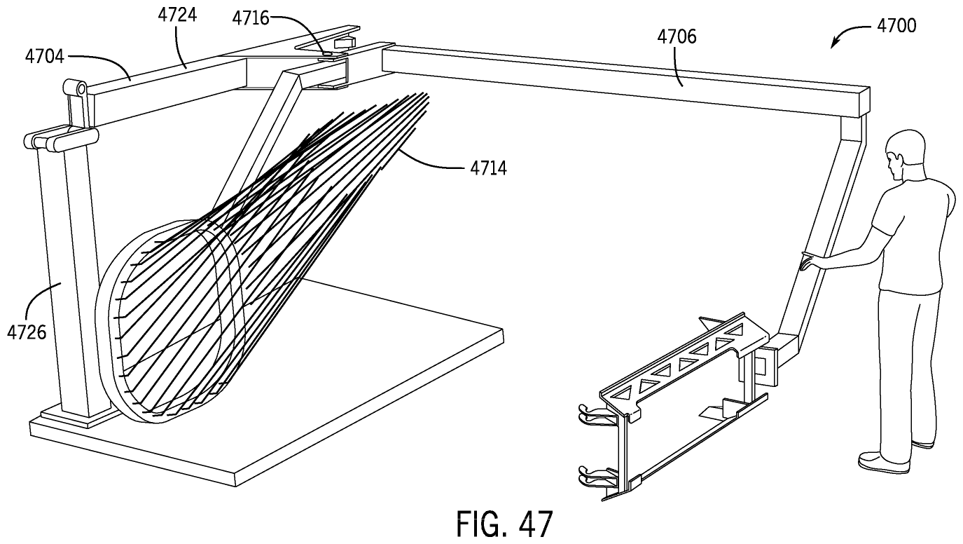

FIG. 47 is a perspective view of a docking assembly 4700 in a folded configuration. The docking assembly 4700 may be similar to any of the docking assembly 2500, the docking assembly 2700, the docking assembly 2800, or the docking assembly 4000, discussed above. For example, the docking assembly 4700 includes a lower post 4704, an upper post 4706 rotatable relative to the lower post 4704 about a hinge 4716, and a catch barrier 4714, among other similar features. Similar components may be the same as or similar to those described above.

To allow further compaction and/or a differing folded configuration compared to those described above, the docking assembly 4700 may include one or more additional hinges. For example, the lower post 4704 may include an upper portion 4724 hinged to a lower portion 4726. In such examples, the upper portion 4724 (e.g., in combination with the upper post 4706 and catch barrier 4714) may be rotated to align the upper portion 4724 with the lower portion 4726, such as vertically. Once aligned, the upper portion 4724 may be secured (e.g., pinned) in place. The upper portion 4724 may fold in a direction different than the upper post 4706 relative to the lower post 4704 (e.g., lateral vs. in line, etc.).

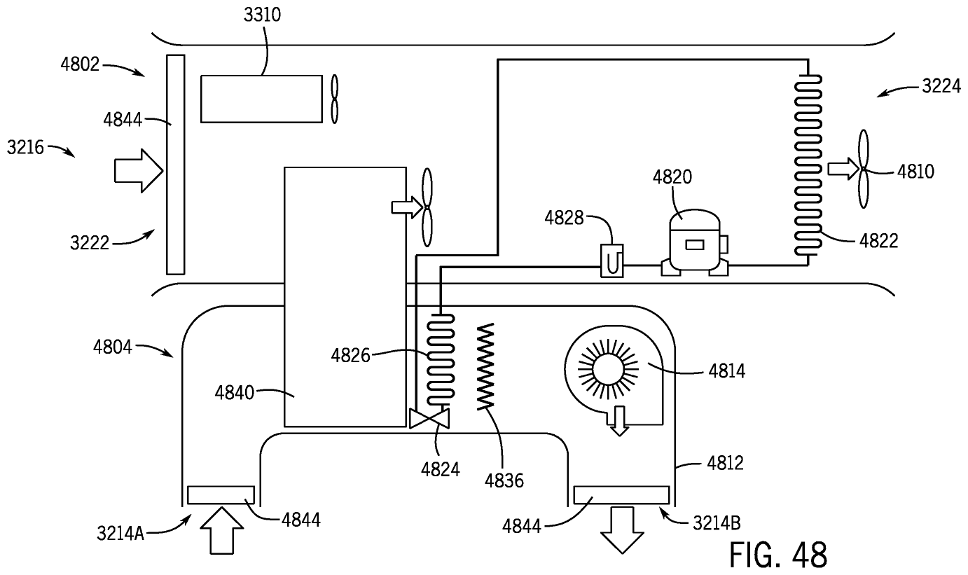

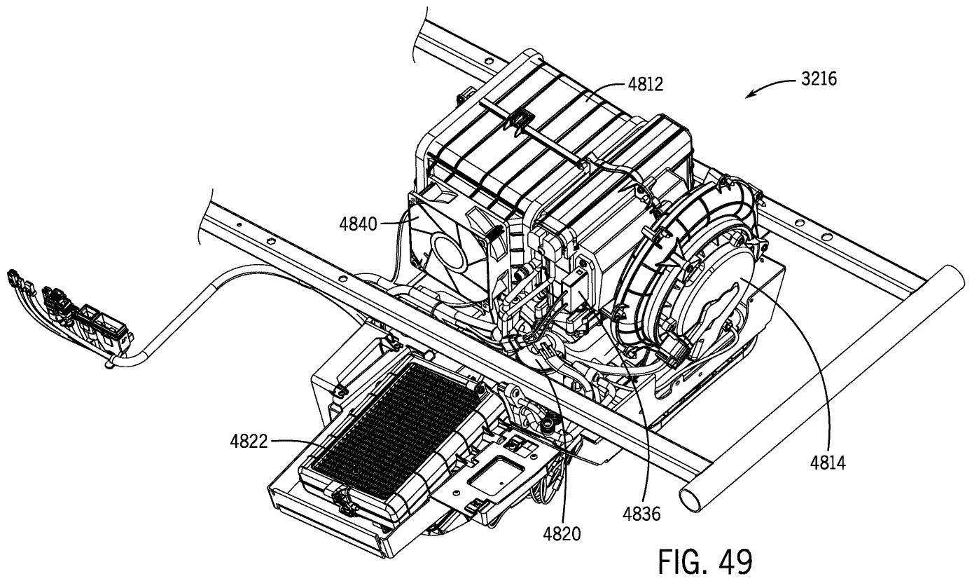

FIG. 48 is a schematic drawing of the thermal system 3216. FIG. 49 is a perspective view of an implementation of the thermal system 3216. The thermal system 3216 may include a dock subsystem 4802 and a vehicle subsystem 4804. The dock subsystem 4802 may be configured to heat, cool, or otherwise provide airflow through the dock 102. The vehicle subsystem 4804 may be configured to heat, cool, or otherwise provide airflow through an aerial vehicle docked to the dock 102, such as to heat or cool the battery or other components of the docked aerial vehicle. The dock subsystem 4802 may draw air through the dock 102 from the intake port 3222 to the exhaust port 3224, such as via a first fan 4810. Similarly, the vehicle subsystem 4804 may draw air through a duct 4812 via a second fan 4814, with the duct 4812 extending between the inlet 3214A and the outlet 3214B of the dock 102.

The thermal system 3216 may include a closed coolant system having a compressor 4820, a condenser 4822, an expansion valve 4824, an evaporator 4826, and an accumulator 4828. Coolant or other refrigerant fluid (hereinafter “fluid” for sake of convenience) may be compressed by the compressor 4820, heating the fluid before passing through the condenser 4822. The first fan 4810 may draw air across the condenser 4822. Passing the fluid through the expansion valve 4824 may cool the fluid, and the cooled fluid may be directed through the evaporator 4826. After passing through the evaporator 4826, fluid may be directed to the accumulator 4828 for recirculation through the system.

Air drawn across the evaporator 4826 by the second fan 4814 may be cooled, such as to cool the battery of a docked aerial vehicle. In examples, the thermal system 3216 (e.g., the vehicle subsystem 4804) may include a heater 4836 (e.g., a positive temperature coefficient (PTC) heater), and air drawn across the heater 4836 by the second fan 4814 may be heated, such as to heat the battery of a docked aerial vehicle. In examples, the thermal system 3216 may include an air-to-air heat exchanger 4840 (e.g., an air exchanger or heat recovery ventilator). The air-to-air heat exchanger 4840 may facilitate heat transfer between two separate airstreams, such as the airstreams in the dock subsystem 4802 and the vehicle subsystem 4804. In this manner, the air-to-air heat exchanger 4840 may pre-condition the incoming air, such as to reduce the heating and cooling loads on the thermal system 3216.

The thermal system 3216 may service the internal components 3310 of the dock 102. For example, the internal components 3310 may be positioned within the airstream path of the dock subsystem 4802, such as to take facilitate heat transfer between the internal components 3310 and the airstream through the dock subsystem 4802. In examples, the thermal system 3216 may include one or more screens or filters 4844 to filter the air and/or limit ingress of water, debris, insects, or animals.

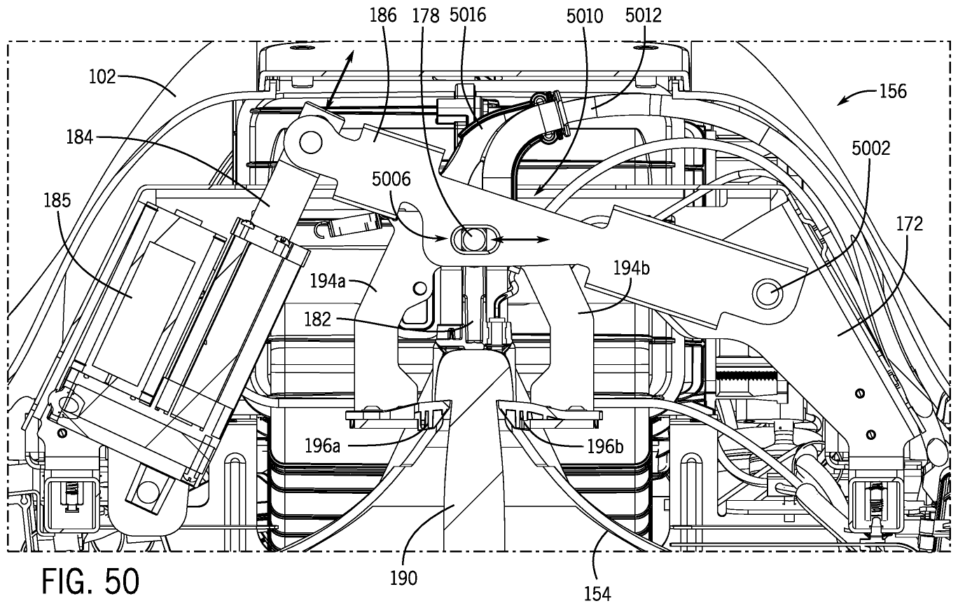

FIG. 50 is a cross-sectional view of an additional implementation of the retention assembly 156. In examples, the arm 186 may be pivotably coupled to the support 172, such as at a hinge 5002. The hinge 5002 may be defined by a pinned connection of the arm 186 to the support 172, although other configurations are contemplated. In such examples, the arm 186 may rotate about a pivot axis defined by the hinge 5002 as the hydraulic assembly 185 (e.g., piston 184) is actuated, such as to move the pin 178 and socket 182 as described herein (e.g., along the slot 176).

In examples, the arm may 186 include a slot 5006 to receive the pin 178. The slot 5006 may allow movement of the pin 178 relative to the arm 186 (e.g., with movement of the pin 178 along the slot 176) as the arm 186 is rotated about the hinge 5002. The slot 5006 may allow movement of the pin 178 in the slot 176, described above. For example, the pin 178 may slide or otherwise move along the slot 5006 as the arm 186 rotates about the hinge 5002 to pull the fin 190 upward into the dock 102. In this manner, the slot 5006 may limit binding of the retention assembly 156, such as binding of the pin 178 within the slot 176 as the fin 190 is secured and released.

In examples, the arm 186 may accommodate a cable routing to the socket 182. For example, the arm 186 may include an aperture or cutout 5010 that allows one or more cables 5012 to be routed through the arm 186 and to the socket 182. A cable guide 5016 may be secured to the arm 186 to facilitate the cable routing. In some examples, the cable guide 5016 may be defined at least partially by the arm 186 itself.

The term aerial vehicle as used herein includes various types of aerial vehicles, such as, but not limited to, aircraft such as fixed wing, rotorcraft (e.g., helicopters, quadrotors, and so on) or combinations thereof. In other cases, at least one of the primary or secondary vehicles may be configured to transport or move an object. For example, at least one of the primary aerial vehicle and the secondary aerial vehicle may include a payload bay and/or include wheels, legs, tracks or the like to facilitate movement relative to a ground surface or landing surface. In some cases, the primary or secondary vehicles may be capable of both aerial and ground movement. As such, while the various vehicles and components described herein are shown in the context of an aerial vehicle system, this is for purposes of illustration, and other configurations are possible without departing from the disclosure.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred to or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1.-73. (canceled)

74. A dock for an aerial vehicle comprising:
a body comprising an angled surface configured to passively align the aerial vehicle to a docking location; and
a retention assembly to retain the aerial vehicle when the aerial vehicle is in the docking location;
wherein
the angled surface forms a bottom surface of the body and the angled surface extends upwards towards a top surface of the body, and
the angled surface further extends upward towards the retention assembly.

75. The dock of claim 74, wherein the body comprises one or more identifiers positioned on the body to communicate a location of the dock to the aerial vehicle.

76. The dock of claim 75, wherein
the one or more identifiers comprising a first plurality of fiducials positioned on a top surface of the body and a second plurality of fiducials positioned on a mount structure below the bottom surface of the body,
the first plurality of fiducials provide information to the aerial vehicle for identifying the dock,
the second plurality of fiducials provide information to the aerial vehicle for maneuvering relative to the dock.

77. The dock of claim 74, wherein
the body defines an opening for receiving a portion of the aerial vehicle; and
the dock comprises a clamp coupled to the body at or adjacent the opening and configured to clamp around the portion of the aerial vehicle.

78. The retention assembly of claim 74, further comprising a position sensor, wherein the position sensor detects that the clamp is in an open state or a closed state.

79. The dock of claim 74, further comprising:
a portal coupled to a payload storage area, wherein the portal and the body are arranged adjacent to the payload storage area, wherein the body is positioned above the portal.

80. The dock of claim 79, wherein the portal further comprises a door for selectively enabling access to the payload storage area.

81. The dock of claim 74, further comprising:
a thermal system thermally coupled to a battery of the aerial vehicle, wherein the thermal system is configured to regulate an environmental temperature around the battery when the aerial vehicle is coupled to the body.

82. The dock of claim 81, wherein
the thermal system comprises a dock subsystem and a vehicle subsystem,
the dock subsystem is configured to regulate an environmental temperature within the housing, and
the vehicle subsystem configured to regulate the environmental temperature around the battery.

83. The dock of claim 82, wherein the thermal system comprises an air-to-air heat exchanger to facilitate heat transfer between the dock subsystem and the vehicle subsystem.

84. A dock assembly for an aerial vehicle comprising:
a housing; and
a securing assembly coupled to the housing and to selectively secure the aerial vehicle thereto, wherein the securing assembly secures the aerial vehicle such that propellers of the aerial vehicle do not contact the housing.

85. The dock assembly of claim 84, wherein the housing comprises
a top surface; and
a bottom surface shaped such that, when the aerial vehicle is secured in the securing assembly, the propellers of the aerial vehicle are spaced apart from the bottom surface of the dock.

86. The dock assembly of claim 84, comprising:
a ballast;
a post attached to the ballast; and
a collapsible catch barrier attached to the post;
wherein the housing is coupled to the post.

87. The collapsible catch barrier of claim 86, comprising:
a central hub;
a plurality of spokes rotatably coupled to the central hub;
a tension line configured to rotate the plurality of spokes to a deployed configuration; and
a draw line configured to rotate the plurality of spokes to a collapsed configuration.

88. The dock assembly of claim 84, wherein
the housing defines an opening for receiving a portion of an aerial vehicle; and
the securing assembly is coupled to the housing and configured to clamp around the portion of the aerial vehicle

89. A docking assembly for an aerial vehicle having a primary vehicle and a secondary vehicle, the docking assembly comprising:
a dock to securely couple to the aerial vehicle comprising:
a top surface, and
a bottom surface including a securing assembly, wherein the bottom surface is shaped such that, when the aerial vehicle is secured in the securing assembly, rotors of the aerial vehicle are spaced apart from the bottom surface of the dock;
a catch barrier positioned below the dock; and
a loading portal positioned below the catch barrier to receive the secondary vehicle when lowered from the primary vehicle.

90. The docking assembly of claim 89, wherein the loading portal is coupled below an opening in the catch barrier to receive the secondary vehicle through the opening.

91. The docking assembly of claim 89, wherein the dock comprises one or more identifiers positioned on the dock to communicate a location of the dock to the aerial vehicle.

92. The docking assembly of claim 91, wherein the identifiers are a fiducial including a static pattern defined by a series of dots with differently filled in portions to represent a different pattern per fiducial.

93. The docking assembly of claim 89, further comprising a charging assembly configured to provide power to the aerial vehicle when the aerial vehicle is coupled thereto, wherein the body at least partially encloses the charging assembly, and wherein the aerial vehicle is electrically connected to the charging assembly when in the docking location.
